(19) United States
(12) Patent Application Publication
(10) Pub. No.: US 2008/0314269 A1
(43) Pub. Date: Dec. 25, 2008

(54) Printing quality control method and apparatus for printing press

(75) Inventors: Norihiro Kumagai, Noda-shi (JP); Hiromitsu Numauchi, Tsukuba-shi (JP); Akehiro Kusaka, Noda-shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 12/213,481

(22) Filed: Jun. 19, 2008

(30) Foreign Application Priority Data
Jun. 21, 2007 (JP) 2007-163380

(51) Int. Cl. B41F 31/02

(52) U.S. Cl. 101/365

(57) ABSTRACT

A printing quality control method and apparatus are disclosed for a printing press including an ink fountain for storing ink, and a motor for driving an ink fountain roller which adjusts the amount of ink supplied from the ink fountain. According to the method and apparatus, a face side distance measuring instrument measures the ink film thickness of a printing product of printing by the printing press, and control means controls the motor for driving the ink fountain roller based on the ink film thickness measured.

### BACKGROUND OF THE INVENTION

1. Field of the Invention

This invention relates to a printing quality control method and apparatus for an intaglio printing press or a relief printing press.

2. Description of the Related Art

Generally, intaglio printing is often used in expectation of the effect of imparting thickness to ink. By so doing, the resulting printing product often becomes pleasing to the touch, giving a feeling of a high grade. With the intaglio printing, an embossing effect by a high printing pressure, or thick application of ink can provide the printing product with a feeling of irregularities. The application of a thick layer of ink also enables varying densities of ink to be expressed.

To inspect the above feeling of irregularities, the use of the existing ink densitometer is conceivable. With intaglio printing, however, even when the density of a deep color such as black is measured with a densitometer, it shows nearly the highest value, because of a thick ink film. This means that the measurement of the density is substantially impossible. If a color patch of a certain size for density measurement is provided, ink of this portion is scraped off by wiping, thereby producing a difference in density between the color patch and an actual image portion. This has presented the drawback that the density of the actual image portion cannot be measured.

It has been customary practice, therefore, that an operator visually confirms the ink density (ink film thickness) of the image portion of the resulting printing product, or confirms an embossed portion of the printing product by touch. Based on the operator's subjective evaluation, the operator adjusts the amount of ink to be supplied (hereinafter referred to as the ink supply amount) from an inking device, or the printing pressure between an intaglio cylinder and an impression cylinder, in the case of Orloff printing or direct printing.

In relief printing, an ink film is so thin that the density of its color, if measured with a densitometer, shows a nearly minimum value, meaning that the measurement of the density is substantially impossible. Thus, an operator visually confirms the ink density (ink film thickness) of the resulting printing product. Based on the operator's subjective evaluation, the operator adjusts the ink supply amount of an inking device.

JP-UM-A-3-124838 is an example of a document on the above-mentioned related art.

As stated above, the operator visually confirms the ink density (ink film thickness), or confirms the embossed portion by touch. Based on the operator's subjective evaluation, the operator adjusts the ink supply amount or the printing pressure. Thus, the problems have been posed that the operator is burdened, and misadjustment occurs, causing a defective printing product.

The present invention has been accomplished in light of the above-described problems. It is an object of the invention to provide a printing quality control method and apparatus for a printing press which measure the emboss amount or the ink film thickness of a printing product, and can automatically adjust the ink supply amount of an inking device in accordance with the emboss amount or the ink film thickness.

### SUMMARY OF THE INVENTION

A first aspect of the present invention is a printing quality control method for a printing press including,

an ink storage portion for storing ink, and

ink supply amount adjusting means for adjusting an amount of ink supplied from the ink storage portion,

the printing quality control method, comprising:

providing ink film thickness measuring means for measuring an ink film thickness of a printing product of printing by the printing press;

measuring the ink film thickness of the printing product of printing by the printing press; and

controlling the ink supply amount adjusting means based on the ink film thickness measured.

A second aspect of the present invention is a printing quality control apparatus for a printing press including,

an ink storage portion for storing ink, and

ink supply amount adjusting means for adjusting an amount of ink supplied from the ink storage portion,

the printing quality control apparatus, comprising:

ink film thickness measuring means for measuring an ink film thickness of a printing product of printing by the printing press; and

control means for controlling the ink supply amount adjusting means based on the ink film thickness measured by the ink film thickness measuring means.

The above-described printing quality control method and apparatus for a printing press according to the present invention measure the emboss amount or the ink film thickness of a printing product, and automatically adjust the ink supply amount of the inking device in accordance with the emboss amount or ink film thickness measured. Thus, printing troubles due to misadjustment of the ink supply amount can be avoided. Consequently, burden on the operator can be lessened, and the emboss amount and the ink film thickness can be controlled with high accuracy to decrease defective printing products (wasted sheets).

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1(a) is a control block diagram of an emboss amount and ink supply amount control device showing Embodiment 1 of the present invention;

FIG. 1(b) is a control block diagram of the emboss amount and ink supply amount control device;

FIG. 1(c) is a control block diagram of the emboss amount and ink supply amount control device;

FIG. 2 is a control block diagram of an ink fountain roller control device;

FIG. 3 is a control block diagram of an ink fountain key control device;

FIG. 4(a) is a motion flow chart of the emboss amount and ink supply amount control device;

FIG. 4(b) is a motion flow chart of the emboss amount and ink supply amount control device;

FIG. 4(c) is a motion flow chart of the emboss amount and ink supply amount control device;

FIG. 5(a) is a motion flow chart of the emboss amount and ink supply amount control device;

FIG. 5(b) is a motion flow chart of the emboss amount and ink supply amount control device;

FIG. 5(c) is a motion flow chart of the emboss amount and ink supply amount control device;

FIG. 5(d) is a motion flow chart of the emboss amount and ink supply amount control device;

FIG. 5(e) is a motion flow chart of the emboss amount and ink supply amount control device;

FIG. 5(f) is a motion flow chart of the emboss amount and ink supply amount control device;

FIG. 6(a) is a motion flow chart of the emboss amount and ink supply amount control device;

FIG. 6(b) is a motion flow chart of the emboss amount and ink supply amount control device;

FIG. 6(c) is a motion flow chart of the emboss amount and ink supply amount control device;

FIG. 7 is a motion flow chart of the ink fountain key control device;

FIG. 8 is a motion flow chart of the ink fountain roller control device;

FIG. 9 is a schematic configurational drawing of an Orloff intaglio printing press;

FIG. 10 is a schematic configurational drawing of an inking device;

FIG. 11 is an explanation drawing of a printing pressure adjusting mechanism for a printing pressure between an intaglio cylinder and an impression cylinder;

FIG. 12(a) is a plan view of a printing product inspection device;

FIG. 12(b) is a side sectional view of the printing product inspection device;

FIG. 13 is a view of the printing condition of an embossed portion;

FIG. 14 is an explanation drawing of a color patch;

FIG. 15(a) is a control block diagram of an emboss amount and ink supply amount control device showing Embodiment 2 of the present invention;

FIG. 15(b) is a control block diagram of the emboss amount and ink supply amount control device;

FIG. 15(c) is a control block diagram of the emboss amount and ink supply amount control device;

FIG. 16 is a control block diagram of an ink fountain roller control device;

FIG. 17 is a control block diagram of an ink fountain key control device;

FIG. 18(a) is a motion flow chart of the emboss amount and ink supply amount control device;

FIG. 18(b) is a motion flow chart of the emboss amount and ink supply amount control device;

FIG. 18(c) is a motion flow chart of the emboss amount and ink supply amount control device;

FIG. 19(a) is a motion flow chart of the emboss amount and ink supply amount control device;

FIG. 19(b) is a motion flow chart of the emboss amount and ink supply amount control device;

FIG. 19(c) is a motion flow chart of the emboss amount and ink supply amount control device;

FIG. 19(d) is a motion flow chart of the emboss amount and ink supply amount control device;

FIG. 19(e) is a motion flow chart of the emboss amount and ink supply amount control device;

FIG. 19(f) is a motion flow chart of the emboss amount and ink supply amount control device;

FIG. 20(a) is a motion flow chart of the emboss amount and ink supply amount control device;

FIG. 20(b) is a motion flow chart of the emboss amount and ink supply amount control device;

FIG. 20(c) is a motion flow chart of the emboss amount and ink supply amount control device;

FIG. 20(d) is a motion flow chart of the emboss amount and ink supply amount control device;

FIG. 21 is a motion flow chart of the ink fountain key control device;

FIG. 22 is a motion flow chart of the ink fountain roller control device;

FIG. 23 is an explanation drawing of a color patch;

FIG. 24(a) is a control block diagram of an ink supply amount control device showing Embodiment 3 of the present invention;

FIG. 24(b) is a control block diagram of the ink supply amount control device;

FIG. 25 is a control block diagram of an ink fountain roller control device;

FIG. 26 is a control block diagram of an ink fountain key control device;

FIG. 27(a) is a motion flow chart of the ink supply amount control device;

FIG. 27(b) is a motion flow chart of the ink supply amount control device;

FIG. 28(a) is a motion flow chart of the ink supply amount control device;

FIG. 28(b) is a motion flow chart of the ink supply amount control device;

FIG. 28(c) is a motion flow chart of the ink supply amount control device;

FIG. 28(d) is a motion flow chart of the ink supply amount control device;

FIG. 29 is a motion flow chart of the ink supply amount control device;

FIG. 30 is a motion flow chart of the ink fountain key control device;

FIG. 31 is a motion flow chart of the ink fountain roller control device;

FIG. 32 is a schematic configurational drawing of a relief printing press;

FIG. 33(a) is a control block diagram of an ink supply amount control device showing Embodiment 4 of the present invention;

FIG. 33(b) is a control block diagram of the ink supply amount control device;

FIG. 34 is a control block diagram of an ink fountain roller control device;

FIG. 35 is a control block diagram of an ink fountain key control device;

FIG. 36 (a) is a motion flow chart of the ink supply amount control device;

FIG. 36(b) is a motion flow chart of the ink supply amount control device;

FIG. 37(a) is a motion flow chart of the ink supply amount control device;

FIG. 37(b) is a motion flow chart of the ink supply amount control device;

FIG. 37(c) is a motion flow chart of the ink supply amount control device;

FIG. 37(d) is a motion flow chart of the ink supply amount control device;

FIG. 38(a) is a motion flow chart of the ink supply amount control device;

FIG. 38(b) is a motion flow chart of the ink supply amount control device;

FIG. 39 is a motion flow chart of the ink fountain key control device; and

FIG. 40 is a motion flow chart of the ink fountain roller control device.

### DETAILED DESCRIPTION OF THE INVENTION

The printing quality control method and apparatus for a printing press according to the present invention will be described in detail by preferred embodiments of the invention by reference to the accompanying drawings.

### Embodiment 1

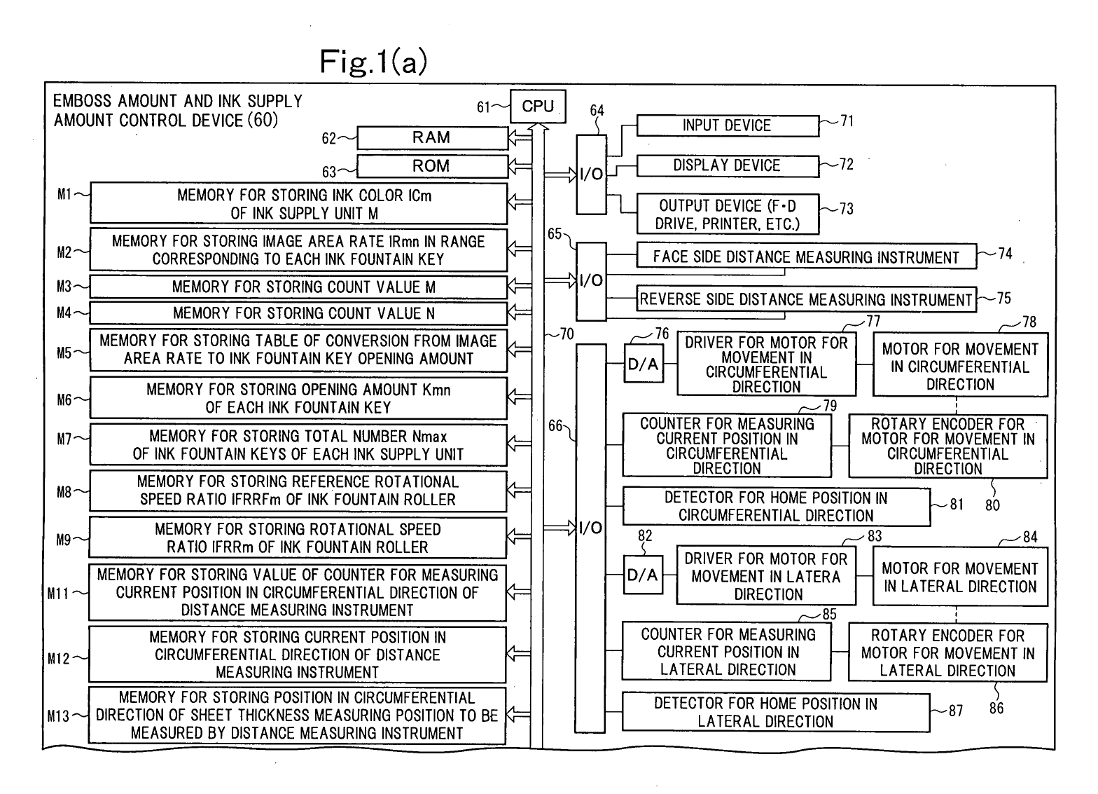

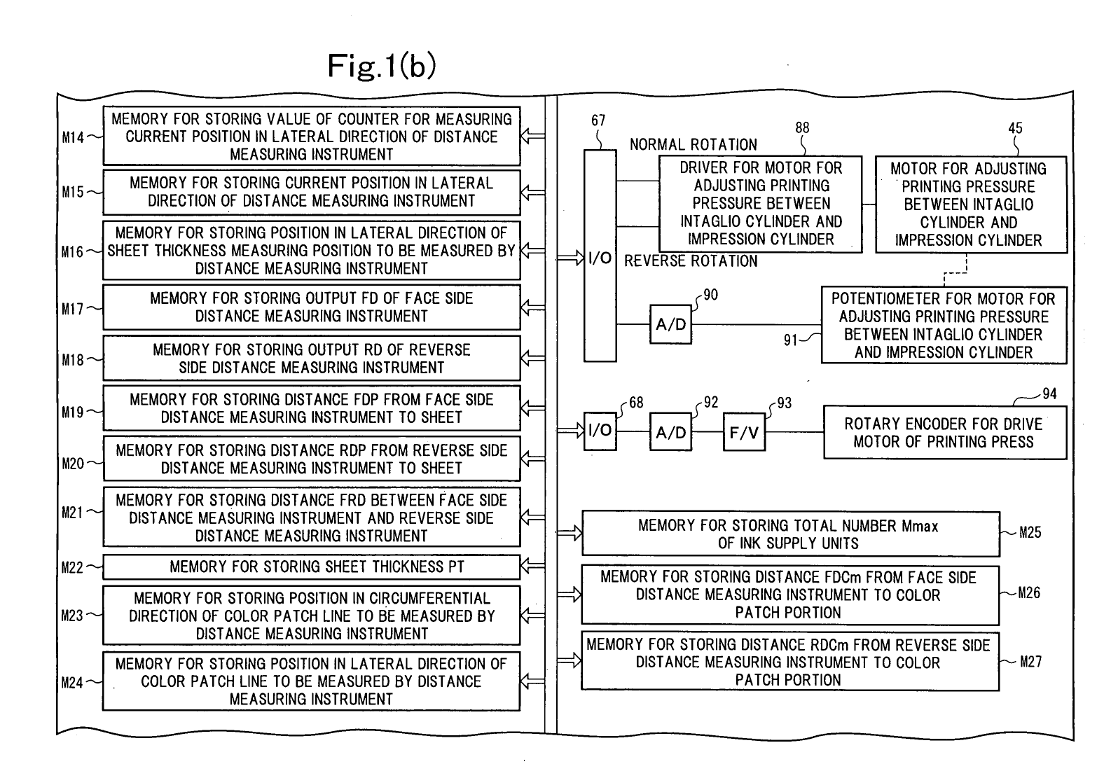

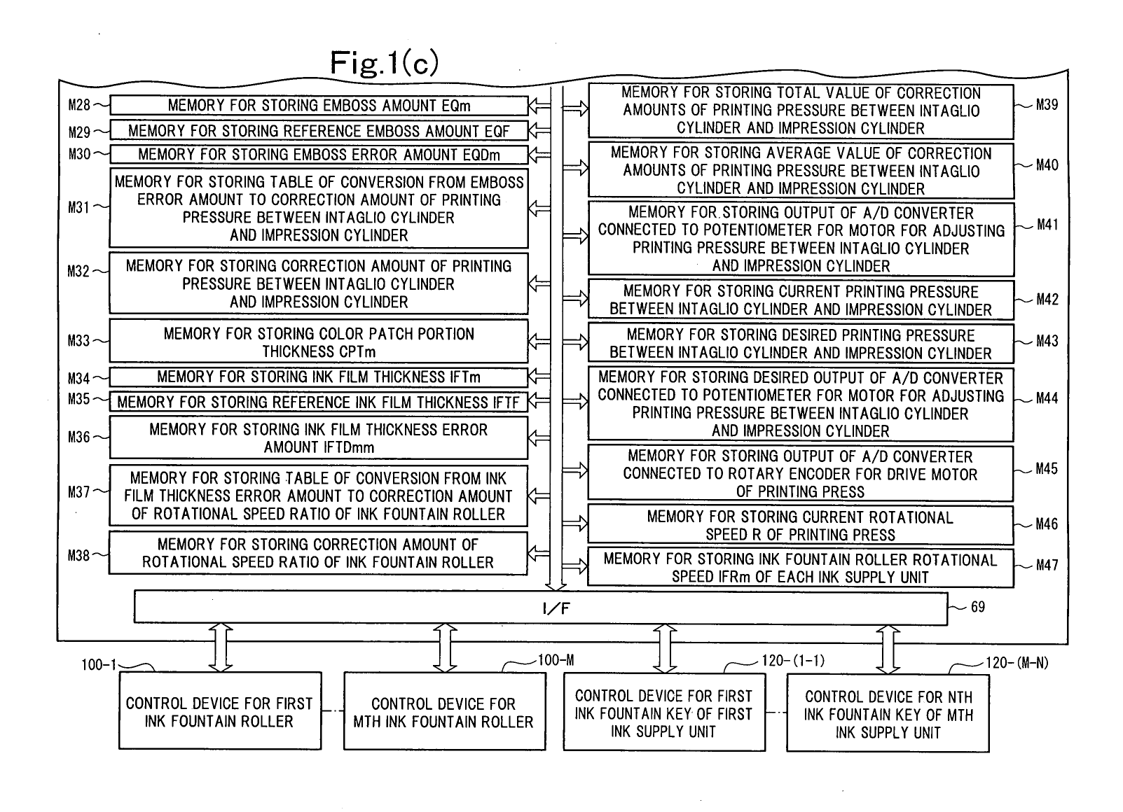

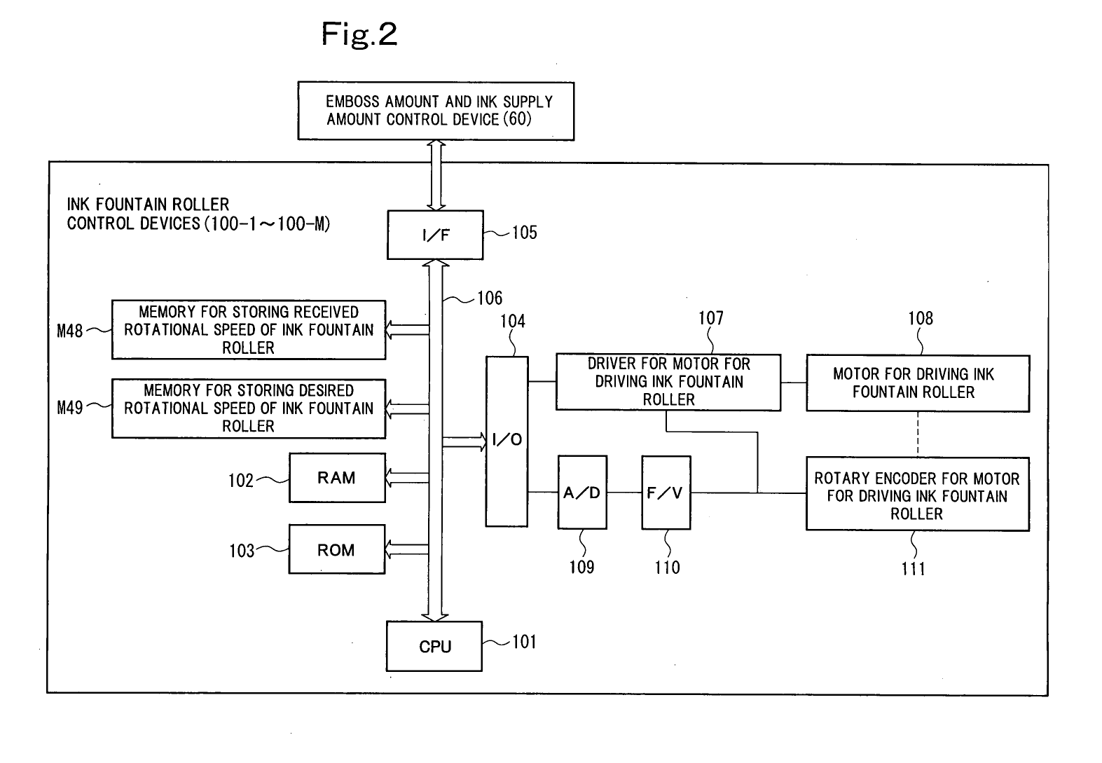

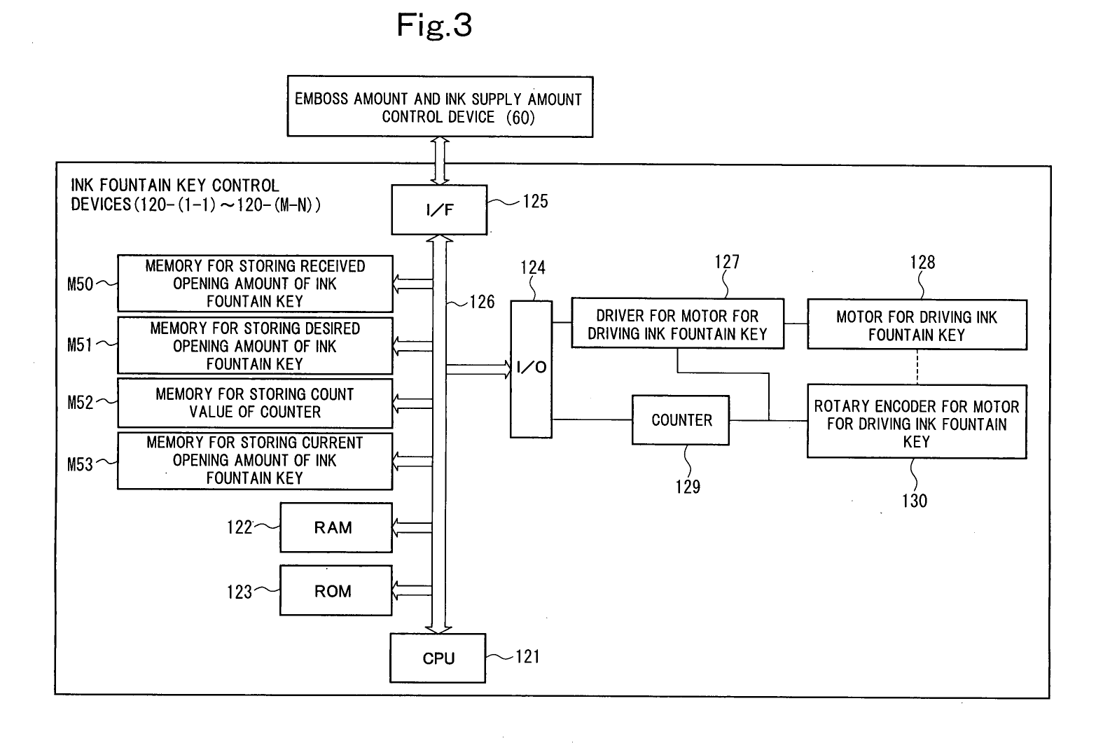

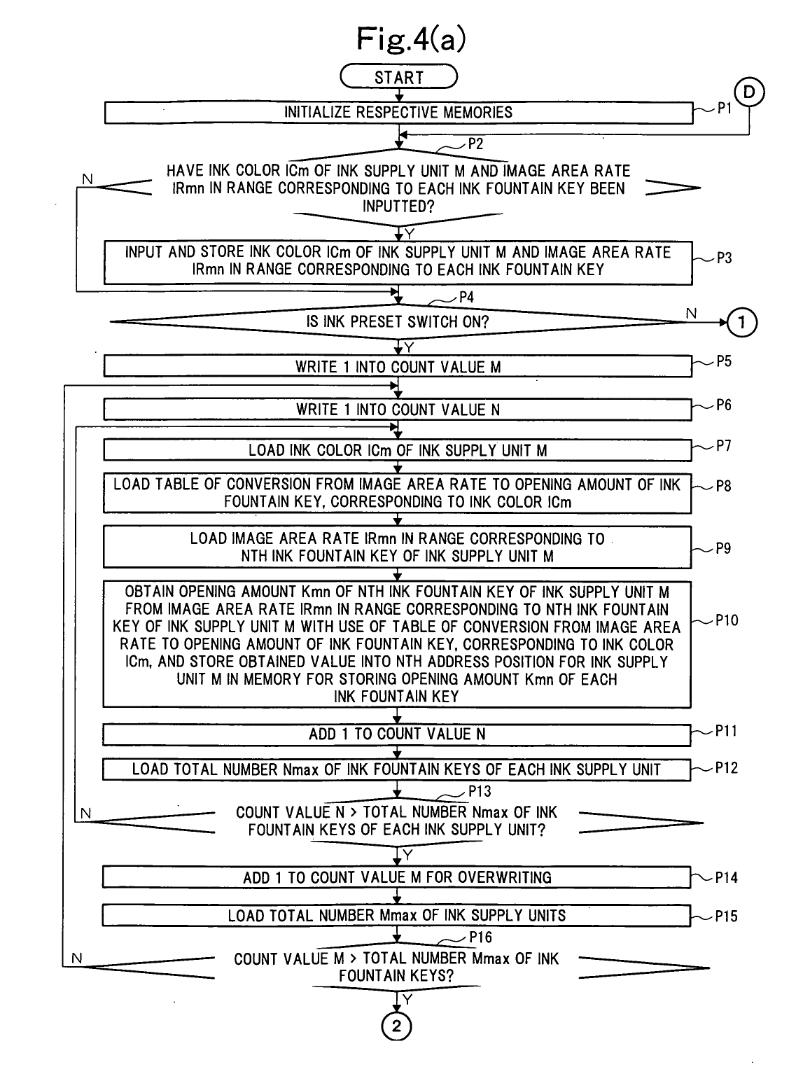

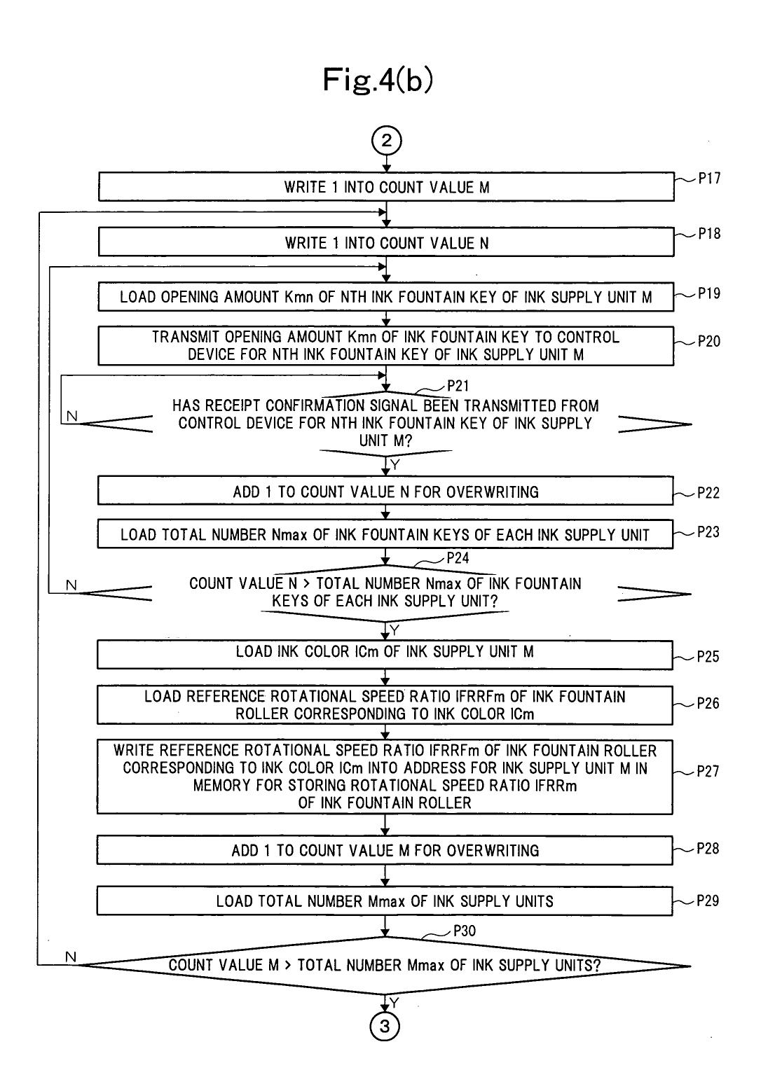

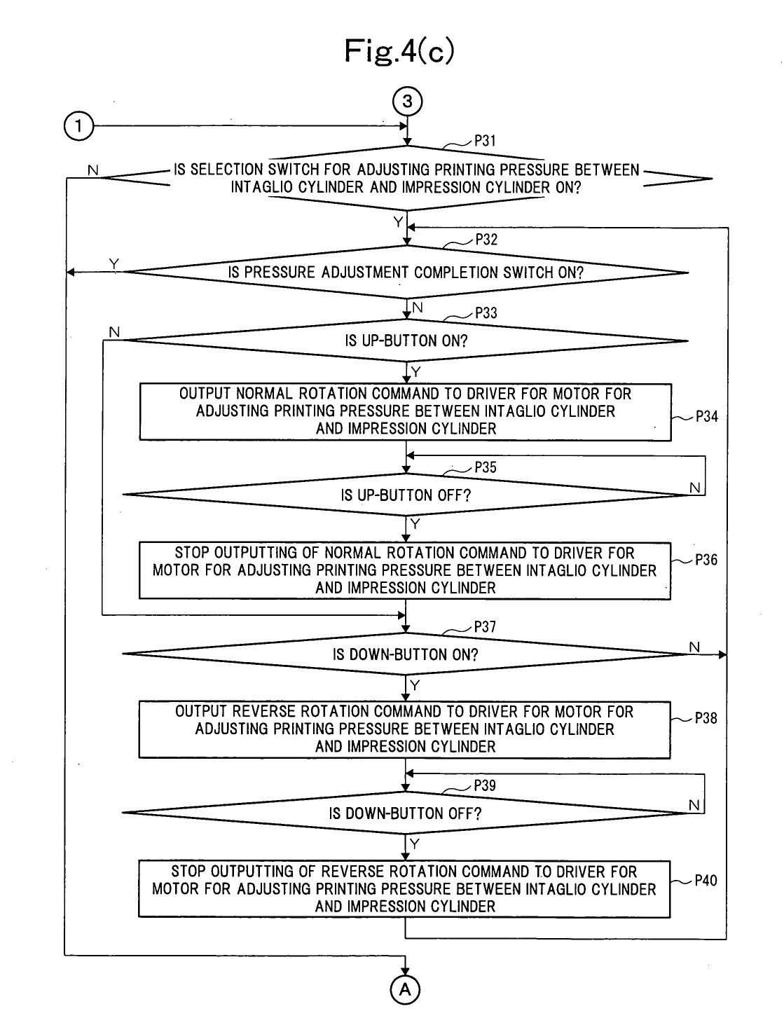

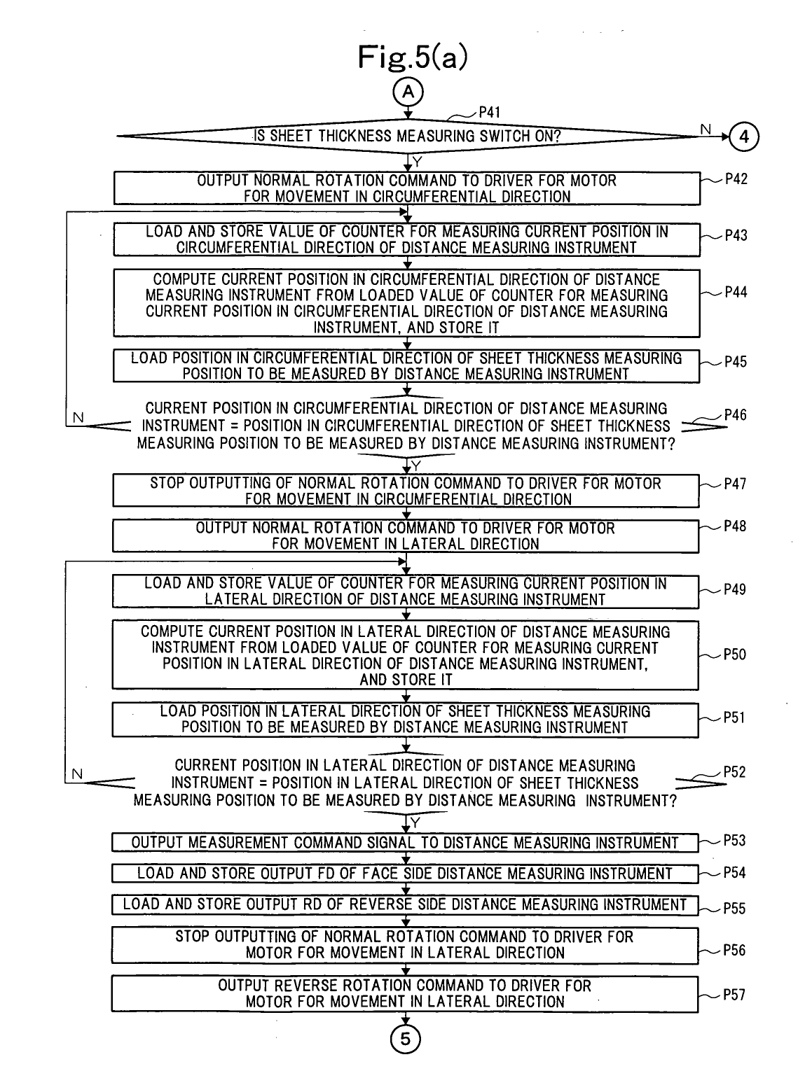

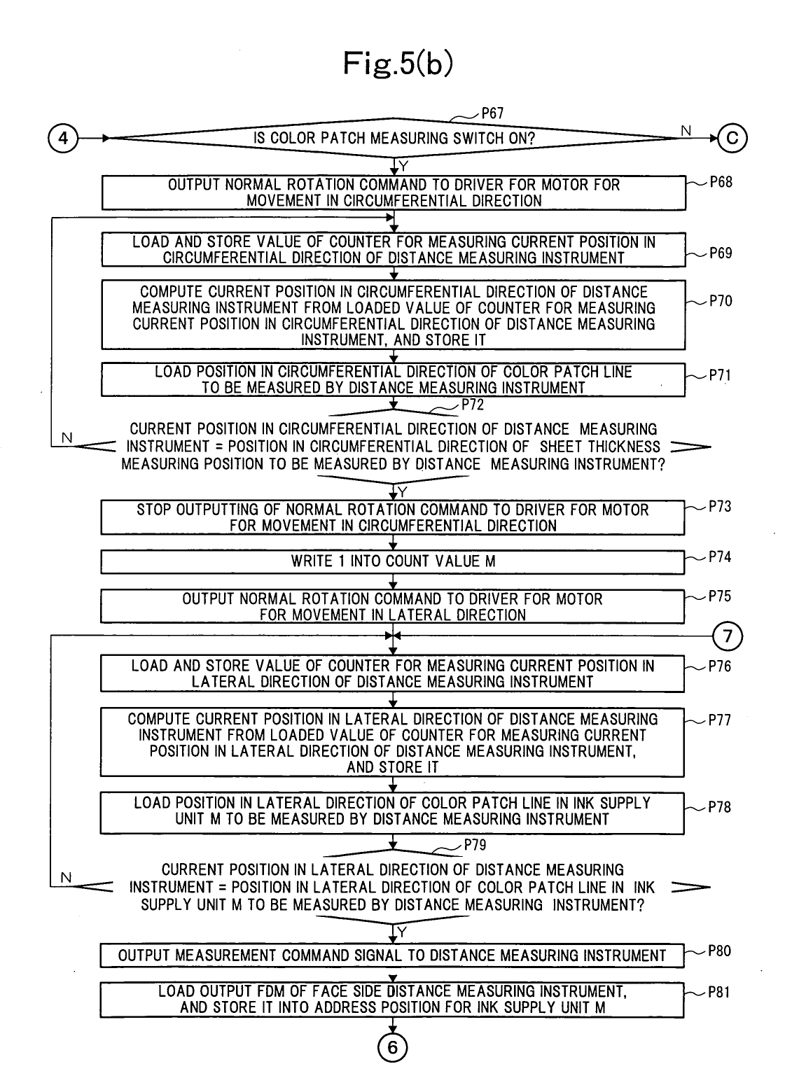

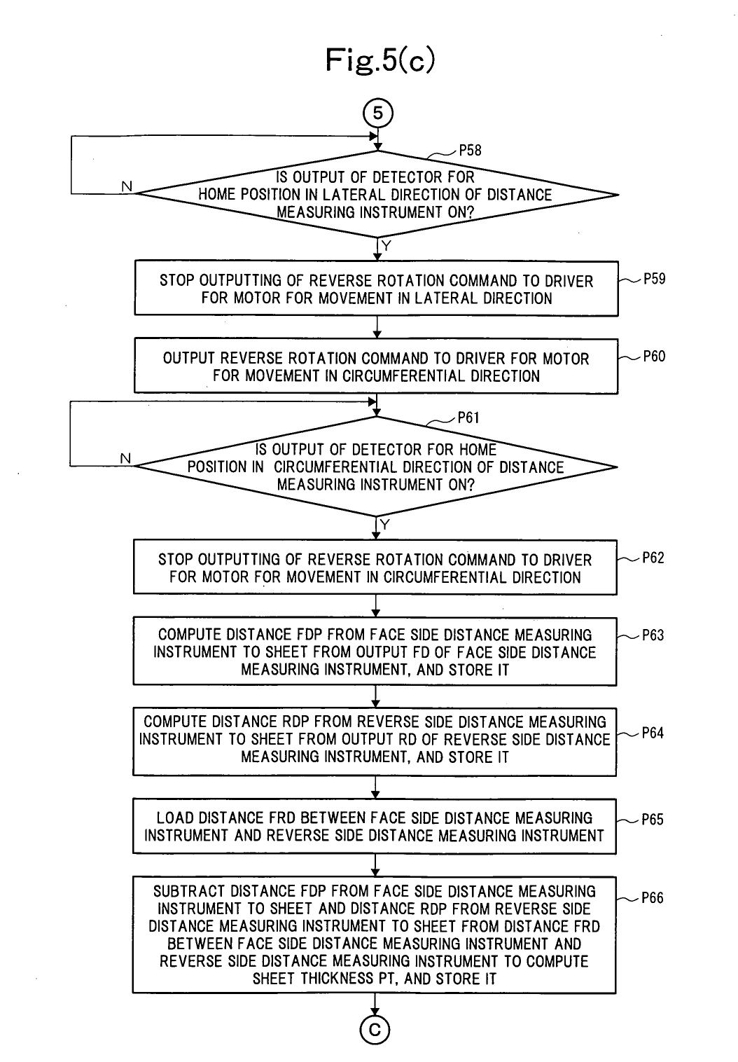

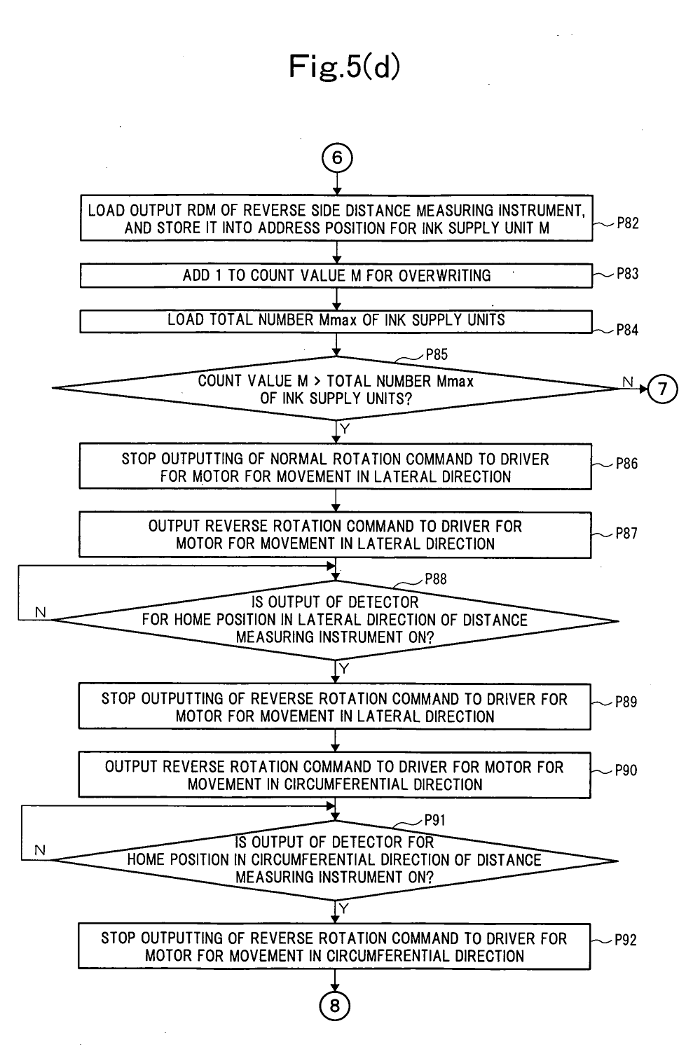

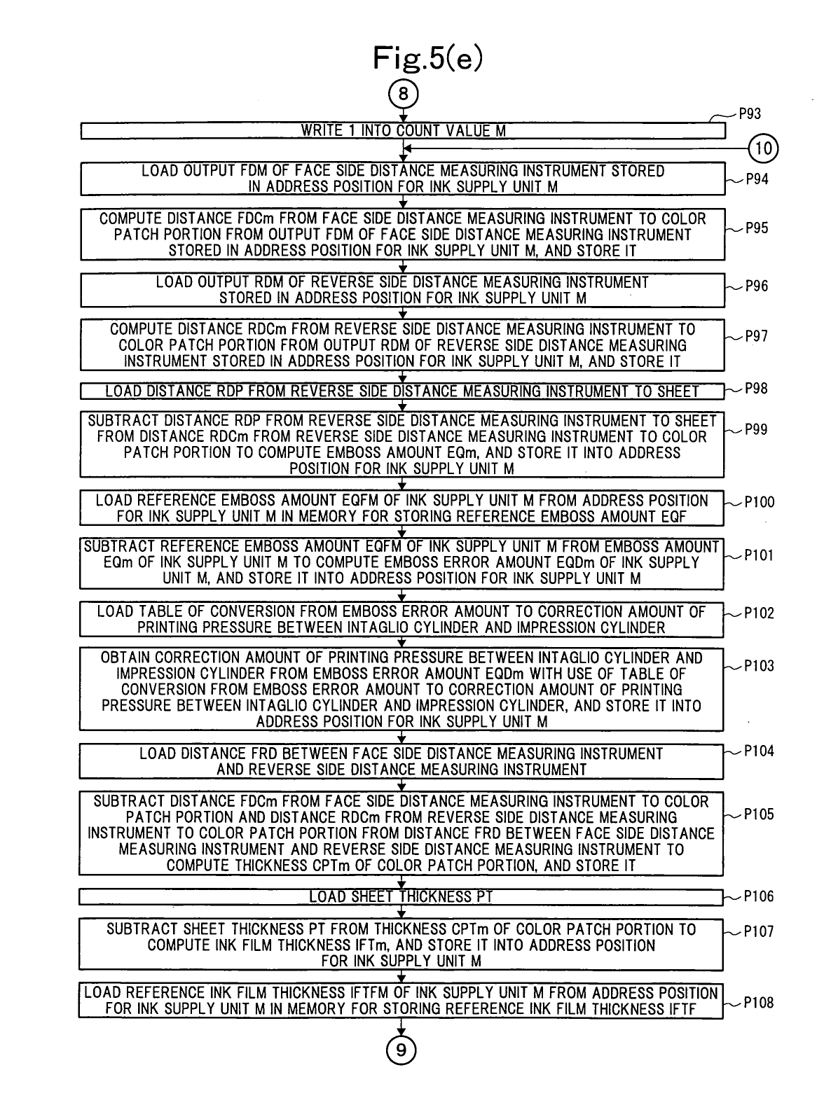

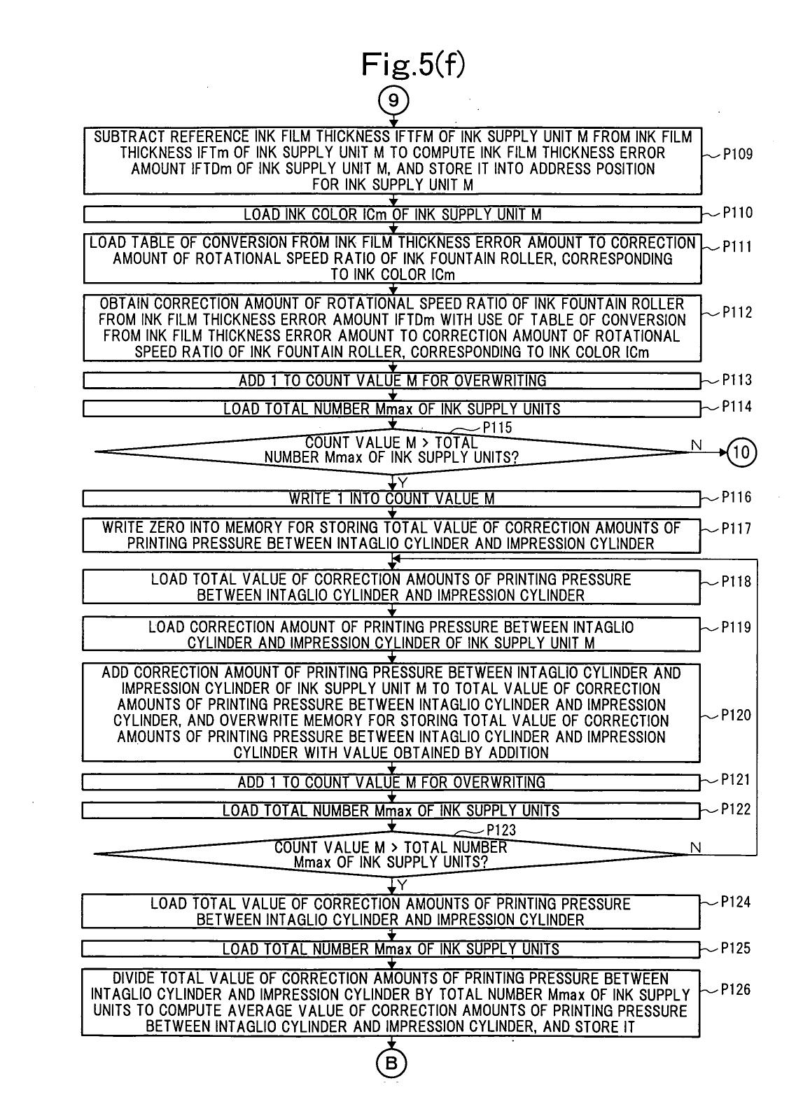

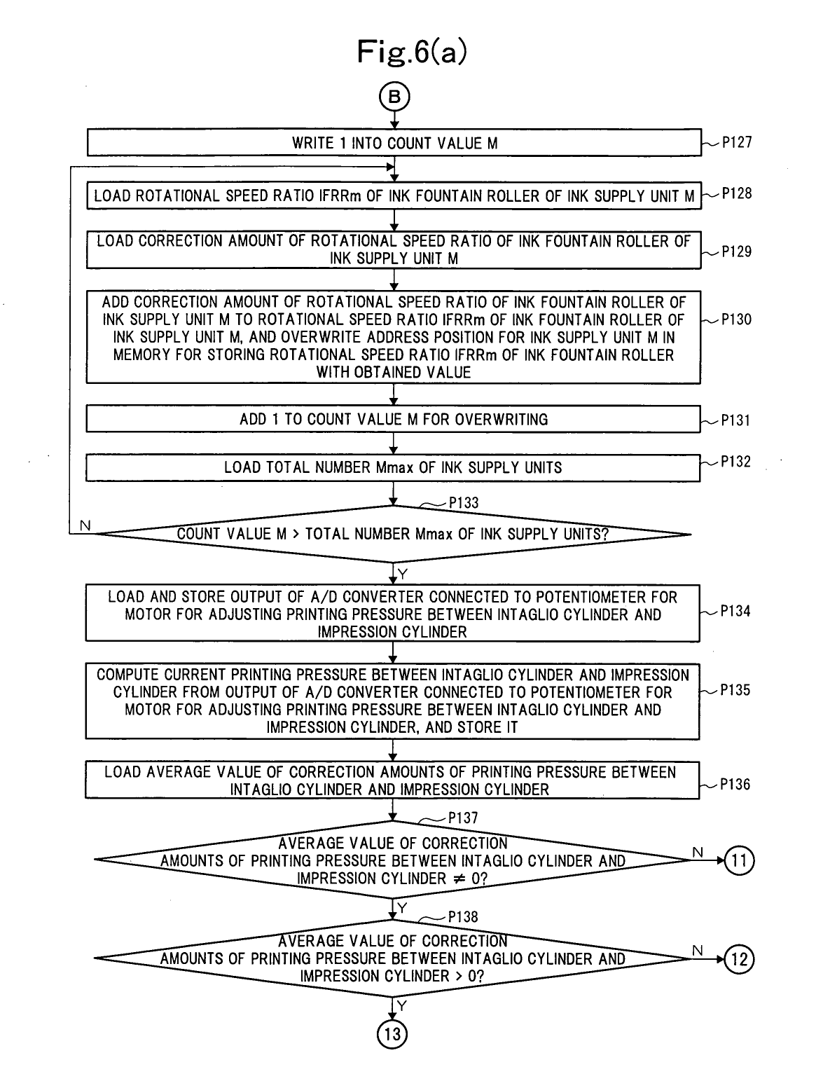

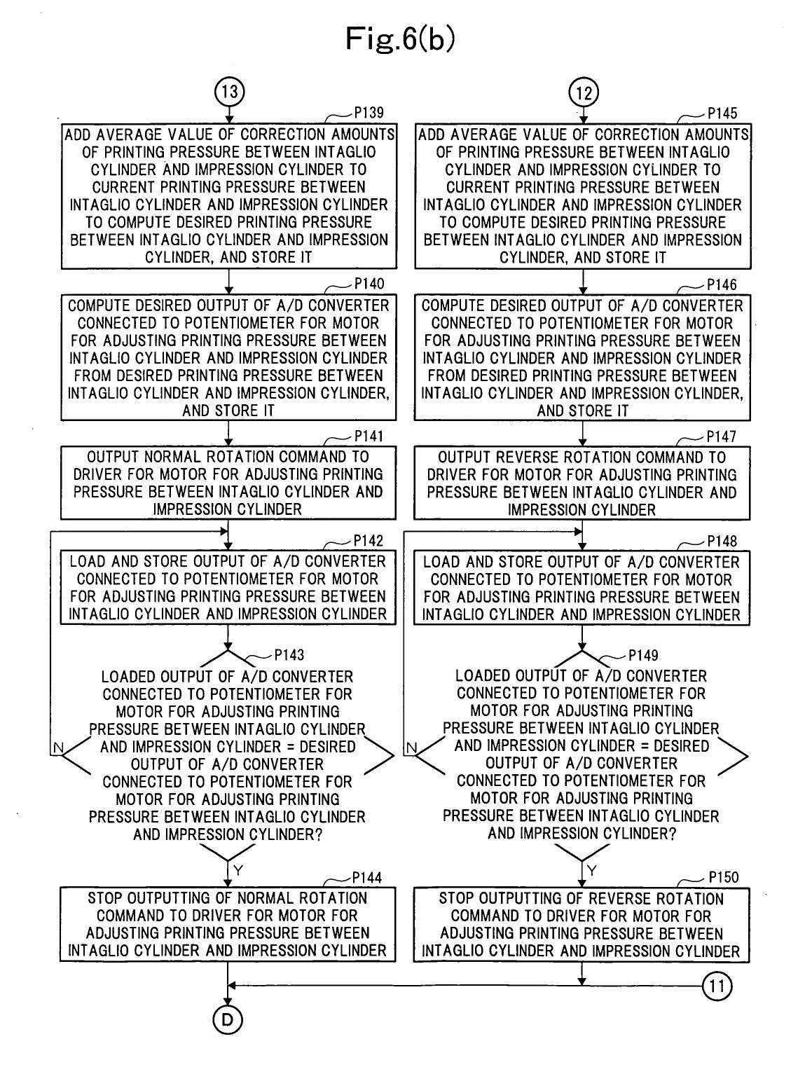

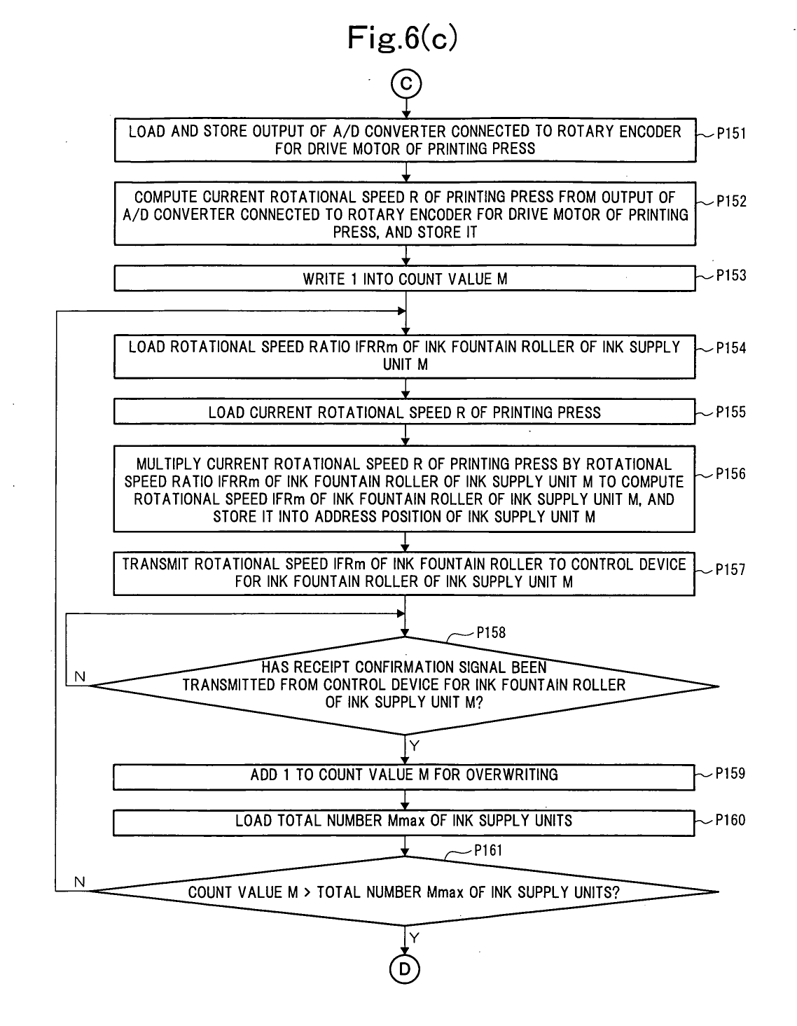

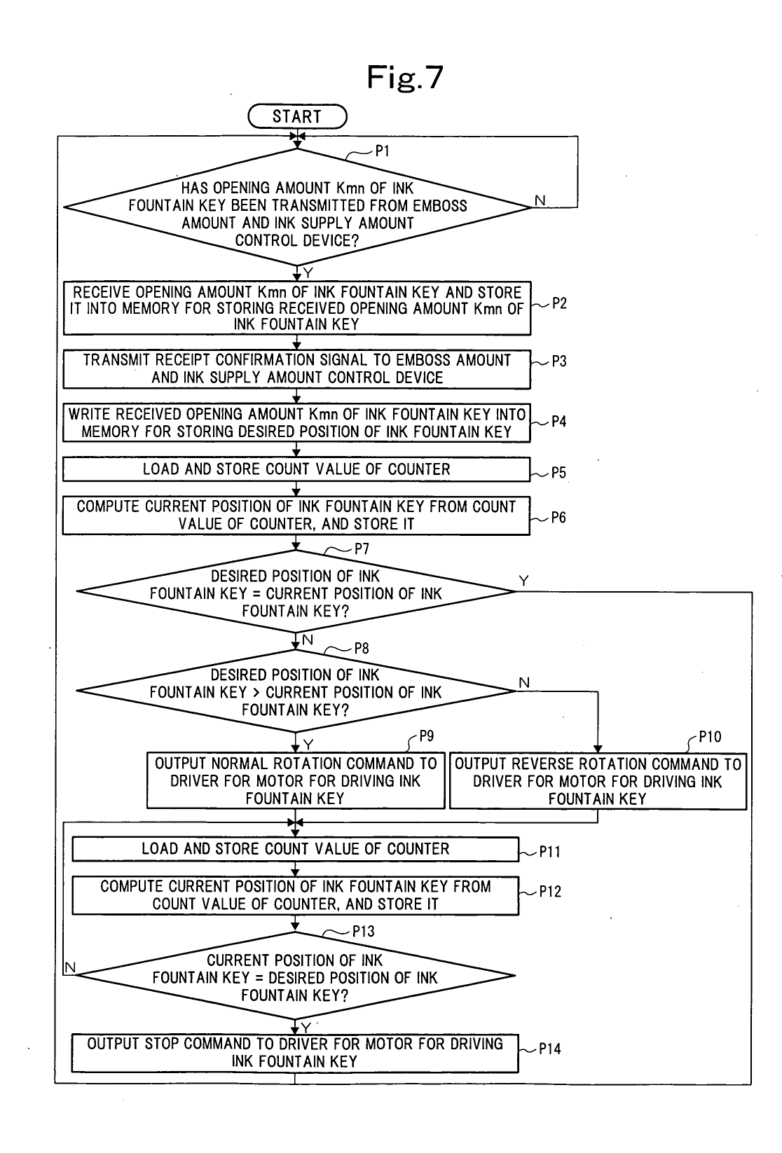

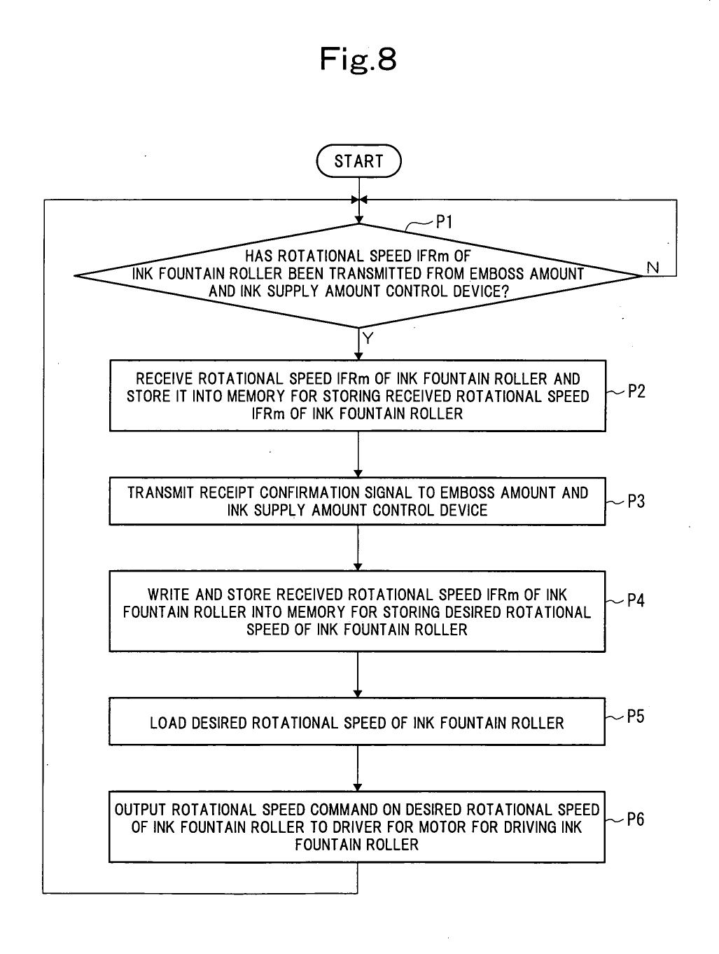

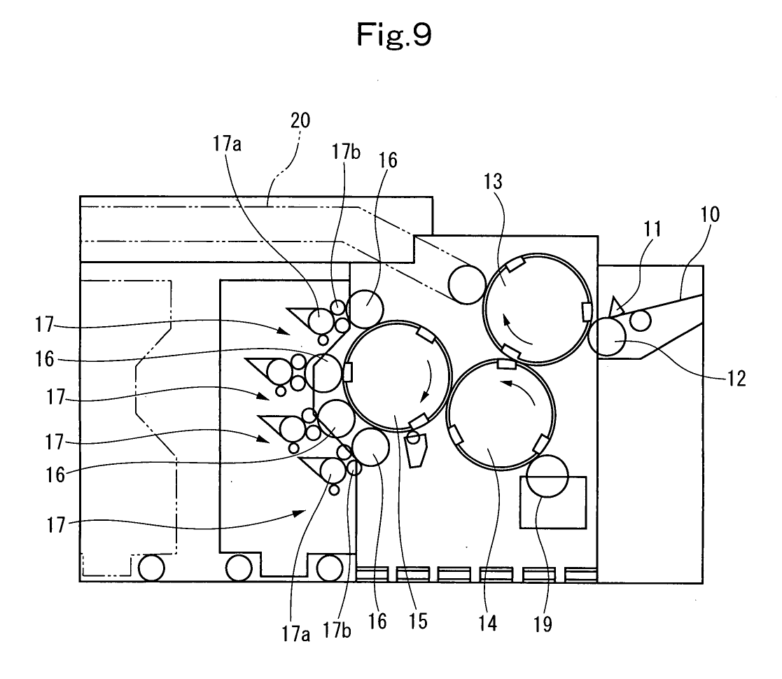

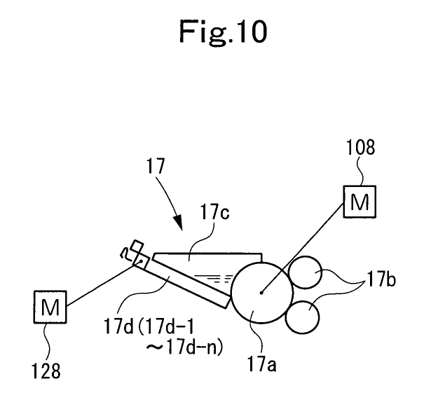

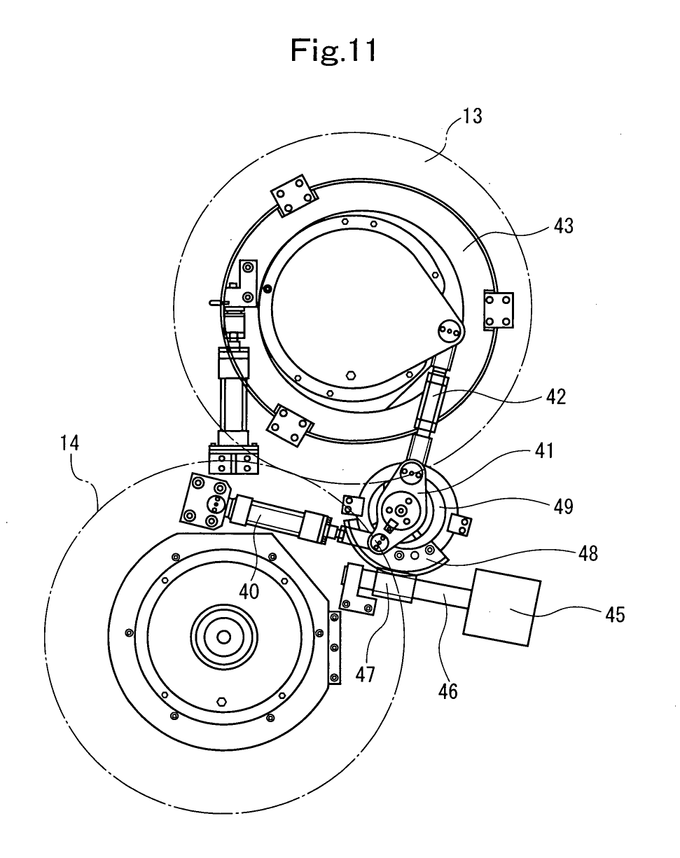

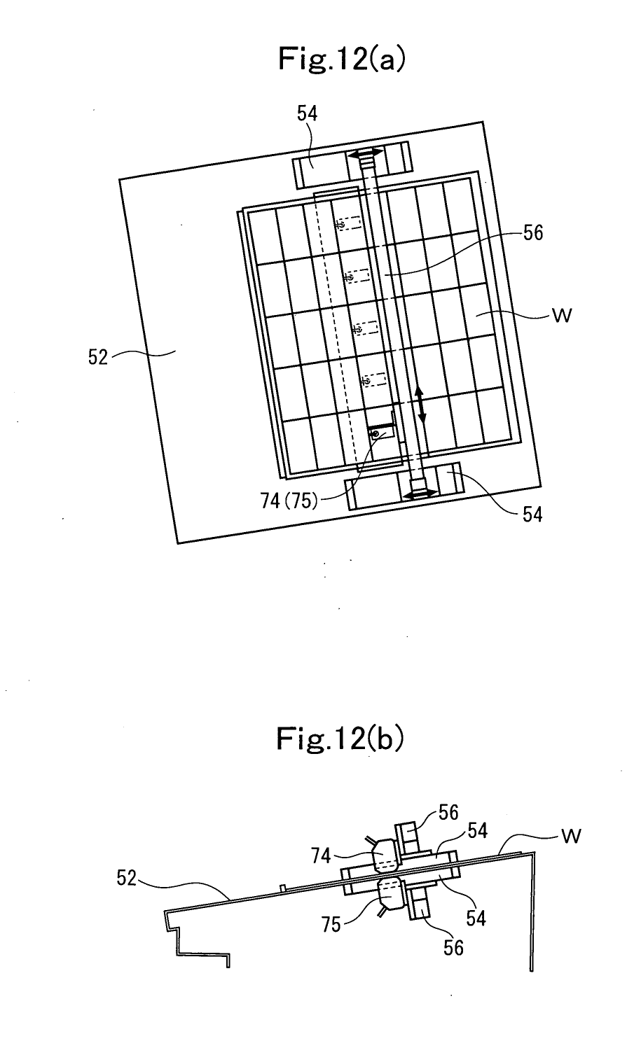

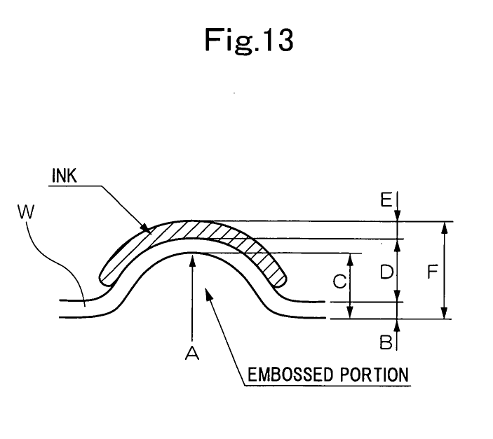

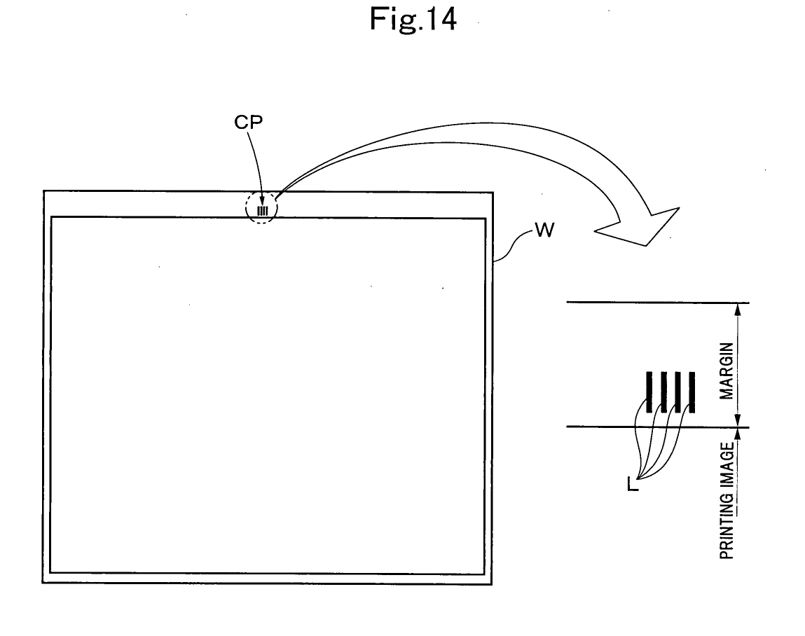

FIGS. 1(a) to 1(c) are control block diagrams of an emboss amount and ink supply amount control device showing Embodiment 1 of the present invention. FIG. 2 is a control block diagram of an ink fountain roller control device. FIG. 3 is a control block diagram of an ink fountain key control device. FIGS. 4(a) to 4(c) are motion flow charts of the emboss amount and ink supply amount control device. FIGS. 5(a) to FIG. 5(f) are motion flow charts of the emboss amount and ink supply amount control device. FIGS. 6(a) to FIG. 6(c) are motion flow charts of the emboss amount and ink supply amount control device. FIG. 7 is a motion flow chart of the ink fountain key control device. FIG. 8 is a motion flow chart of the ink fountain roller control device. FIG. 9 is a schematic configurational drawing of an Orloff intaglio printing press. FIG. 10 is a schematic configurational drawing of an inking device. FIG. 11 is an explanation drawing of a printing pressure adjusting mechanism for a printing pressure between an intaglio cylinder and an impression cylinder. FIG. 12(a) is a plan view of a printing product inspection device. FIG. 12(b) is a side sectional view of the printing product inspection device. FIG. 13 is a view of the printing condition of an embossed portion. FIG. 14 is an explanation drawing of a color patch.

In an Orloff (type) intaglio printing press, as shown in FIG. 9, a sheet (a member to be printed, or a printing product after printing) fed from a feeding device (outside the drawing) onto a feedboard 10 is passed from a swing arm shaft pregripper 11 on to a gripper of an impression cylinder 13 via a transfer cylinder 12, and gripped by the gripper for transport. Simultaneously, ink of each inking device 17 is transferred to a blanket cylinder (ink collecting cylinder) 15 via a pattern roller 16, and supplied onto the plate surface of an intaglio cylinder 14. A surplus of the supplied ink is removed by a wiping roller 19.

Thus, the sheet gripped and transported by the gripper of the impression cylinder 13 is printed when it passes between the impression cylinder 13 and the intaglio cylinder 14. Then, the sheet is passed on to and gripped by the delivery gripper of a delivery chain 20, transported by the travel of the delivery chain 20, and dropped and piled on a delivery pile board (outside the drawing).

In the inking device 17 of each ink supply unit, as shown in FIG. 10, an ink fountain roller 17a is driven by a motor (ink supply amount adjusting means) 108 for driving the ink fountain roller separately from a drive motor of the printing press, and an ink fountain key 17d (17d-1 to 17d-n) is driven by a motor (ink supply amount adjusting means) 128 for driving the ink fountain key. In the present embodiment, the amount of ink supply from an ink fountain (ink storage portion) 17c can be automatically adjusted by the control of the rotational speed of the ink fountain roller by the motor 108 for driving the ink fountain roller.

Also, as shown in FIG. 11, the printing pressure between the intaglio cylinder 14 and the impression cylinder 13 can be adjusted automatically by drivingly controlling a motor 45 for adjusting the printing pressure between the intaglio cylinder and the impression cylinder (the motor 45 will be described later).

As a printing pressure adjusting mechanism for the printing pressure between the intaglio cylinder 14 and the impression cylinder 13, it is preferred to adopt, for example, the mechanism of a configuration as shown in FIG. 11. In the illustrated mechanism, at the time of printing, a hydraulic cylinder 40 is extended, whereby a first jogger bearing 43 is pivoted counterclockwise in the drawing via a lever 41 and a turnbuckle 42. By the eccentric action of the first jogger bearing 43, the great printing pressure of the impression cylinder 13 acts on the intaglio cylinder 14. If the printing pressure is adjusted during printing preparation (i.e., make-ready) or during printing, an operating shaft 46 is pivoted by the motor 45 to pivot a second jogger bearing 49 upon meshing between a worm gear 47 and a sector gear 48. Thus, the first jogger bearing 43 is also pivoted (in this case, the first jogger bearing 43 is pivoted in the direction opposite to the direction of pivoting of the second jogger bearing 49), so that the printing pressure is adjusted. Manually rotating the operating shaft 46 in such a configuration is made publicly known by JP-UM-A-3-124838, etc.

In the present embodiment, the ink film thickness or the emboss amount in the printing image of the printed sheet is measured using a printing product inspection device (ink film thickness measuring means, emboss amount measuring means) placed outside the printing press or machine, and the above-mentioned ink supply amount or printing pressure between the intaglio cylinder and the impression cylinder is automatically adjusted in accordance with the measured ink film thickness or emboss amount.

The above printing product inspection device, as shown in FIGS. 12(a) and 12(b), has a face side distance measuring instrument 74 and a reverse side distance measuring instrument 75, each of which comprises a laser displacement meter or the like. The face side distance measuring instrument 74 and the reverse side distance measuring instrument 75 are provided on an inspection device body 52 to be movable in a circumferential direction and a lateral direction, respectively, by a pair of (i.e., right and left) electrically operated slide cylinders 54 which are driven by a motor 78 for movement in the circumferential direction (see FIG. 1(a)) and a single electrically operated slide cylinder 56 which is driven by a motor 84 for movement in a lateral direction (see FIG. 1(a)). Thus, the face side distance measuring instrument 74 and the reverse side distance measuring instrument 75 can measure an ink film thickness (IFTm) or an emboss amount (EQm) in the printing image of a sheet W placed on the inspection device body 52. The pair of (i.e., right and left) electrically operated slide cylinders 54 and the single electrically operated slide cylinder 56 are provided separately on each of an upper side and a lower side (face side and reverse side), whereas the motor 84 for movement in the lateral direction and the motor 78 for movement in the circumferential direction are provided for one of the upper side and the lower side (face side and reverse side), or may be provided separately for each of the upper side and the lower side (face side and reverse side).

That is, as shown in FIG. 13, the emboss amount (EQm) C is determined by a measurement (A-B) made by the reverse side distance measuring instrument 75. A height (D+E) can be measured by the face side distance measuring instrument 74. If it is assumed that the thickness of the sheet W does not change because of the emboss effect, it holds that C=D. This means that a value obtained by subtracting the measured value on the reverse side and the thickness of the sheet W from the measured value on the face side is the ink film thickness (IFTm) E.

At the time of measurement, the printing image of the sheet W is not directly measured, but instead, it is efficient to measure color patch lines L, corresponding to the number of colors, i.e., India ink, indigo, red, and yellow, at a color patch portion CP provided in a margin part in the circumferential direction of the sheet W, as shown in FIG. 14. The color patch lines L printed by respective ink supply units are printed at the same position in the circumferential direction so as to be arranged in the sequence of the first color, the second color, the third color, and the fourth color, with the same spacing provided in the lateral direction.

As shown in FIGS. 1-3, the motor 45 for adjusting the printing pressure between the intaglio cylinder and the impression cylinder is drivingly controlled by an emboss amount and ink supply amount control device (control means) 60 to be described later, the motor 108 for driving the ink fountain roller is drivingly controlled by an ink fountain roller control device (control means) 100-1 to 100-M, and the motor 128 for driving the ink fountain key is drivingly controlled by an ink fountain key control device (control means) 120-(1-1) to 120-(M-N).

The emboss amount and ink supply amount control device 60 comprises CPU 61, RAM 62, ROM 63, input/output devices 64 to 68, and an interface 69 connected together by a BUS line 70, as shown in FIGS. 1(a) to 1(c). To the BUS line 70, the following memories are connected: A memory Ml for storing the ink color ICm of an ink supply unit M, a memory M2 for storing an image area rate IRmn in a range corresponding to each ink fountain key, a memory M3 for storing a count value M, a memory M4 for storing a count value N, a memory M5 for storing a table of conversion from the image area rate to an ink fountain key opening amount, a memory M6 for storing the opening amount Kmn of each ink fountain key, and a memory M7 for storing the total number Nmax of the ink fountain keys of each ink supply unit.

To the BUS line 70, the following memories are further connected: A memory M8 for storing the reference rotational speed ratio IFRRFm of the ink fountain roller, a memory M9 for storing the rotational speed ratio IFRRm of the ink fountain roller, a memory M11 for storing the value of a counter for measuring the current position in the circumferential direction of the distance measuring instrument, a memory M12 for storing the current position in the circumferential direction of the distance measuring instrument, a memory M13 for storing the position in the circumferential direction of a sheet thickness measuring position to be measured by the distance measuring instrument, a memory M14 for storing the value of a counter for measuring the current position in the lateral direction of the distance measuring instrument, a memory M15 for storing the current position in the lateral direction of the distance measuring instrument, a memory M16 for storing the position in the lateral direction of the sheet thickness measuring position to be measured by the distance measuring instrument, and a memory M17 for storing the output FD of the face side distance measuring instrument.

To the BUS line 70, the following memories are further connected: A memory M18 for storing the output RD of the reverse side distance measuring instrument, a memory M19 for storing the distance FDP from the face side distance measuring instrument to the sheet, a memory M20 for storing the distance RDP from the reverse side distance measuring instrument to the sheet, a memory M21 for storing the distance FRD between the face side distance measuring instrument and the reverse side distance measuring instrument, a memory M22 for storing the sheet thickness PT, a memory M23 for storing the position in the circumferential direction of the color patch line to be measured by the distance measuring instrument, a memory M24 for storing the position in the lateral direction of the color patch line to be measured by the distance measuring instrument, a memory M25 for storing the total number Mmax of the ink supply units, a memory M26 for storing the distance FDCm from the face side distance measuring instrument to the color patch portion, and a memory M27 for storing the distance RDCm from the reverse side distance measuring instrument to the color patch portion.

To the BUS line 70, the following memories are further connected: A memory M28 for storing the emboss amount EQm, a memory M29 for storing a reference emboss amount EQF, a memory M30 for storing an emboss error amount EQDm, a memory M31 for storing a table of conversion from the emboss error amount to the correction amount of the printing pressure between the intaglio cylinder and the impression cylinder, a memory M32 for storing the correction amount of the printing pressure between the intaglio cylinder and the impression cylinder, a memory M33 for storing a color patch portion thickness CPTm, a memory M34 for storing the ink film thickness IFTm, a memory M35 for storing a reference ink film thickness IFTF, a memory M36 for storing an ink film thickness error amount IFTDm, and a memory M37 for storing a table of conversion from the ink film thickness error amount to the correction amount of the rotational speed ratio of the ink fountain roller.

To the BUS line 70, the following memories are further connected: A memory M38 for storing the correction amount of the rotational speed ratio of the ink fountain roller, a memory M39 for storing the total value of the correction amounts of the printing pressure between the intaglio cylinder and the impression cylinder, a memory M40 for storing the average value of the correction amounts of the printing pressure between the intaglio cylinder and the impression cylinder, a memory M41 for storing the output of an A/D converter connected to a potentiometer for a motor for adjusting the printing pressure between the intaglio cylinder and the impression cylinder, a memory M42 for storing the current printing pressure between the intaglio cylinder and the impression cylinder, a memory M43 for storing the desired printing pressure between the intaglio cylinder and the impression cylinder, a memory M44 for storing the desired output of the A/D converter connected to the potentiometer for the motor for adjusting the printing pressure between the intaglio cylinder and the impression cylinder, a memory M45 for storing the output of an A/D converter connected to a rotary encoder for the drive motor of the printing press, a memory M46 for storing the current rotational speed R of the printing press, and a memory M47 for storing the ink fountain roller rotational speed IFRm of each ink supply unit.

To the input/output device 64, the following are connected: An input device 71 such as a keyboard, a display device 72 such as CRT or a display, and an output device 73 such as a printer or a floppy disk (registered trademark) drive. The aforementioned face side distance measuring instrument 74 and reverse side distance measuring instrument 75 are connected to the input/output device 65.

To the input/output device 66, the aforementioned motor 78 for movement in the circumferential direction is connected via a D/A converter 76 and a driver 77 for the motor for movement in the circumferential direction, and a rotary encoder 80 for the motor for movement in the circumferential direction, which is drivingly coupled to the motor 78, is connected via a counter 79 for measuring the current position in the circumferential direction. A detector 81 for a home position in the circumferential direction is also connected to the input/output device 66.

To the input/output device 66, the aforementioned motor 84 for movement in the lateral direction is connected via a D/A converter 82 and a driver 83 for the motor for movement in the lateral direction, and a rotary encoder 86 for the motor for movement in the lateral direction, which is drivingly coupled to the motor 84, is connected via a counter 85 for measuring the current position in the lateral direction. A detector 87 for a home position in the lateral direction is also connected to the input/output device 66.

To the input/output device 67, the aforementioned motor 45 for adjusting the printing pressure between the intaglio cylinder and the impression cylinder is connected via a driver 88 for the motor for adjusting the printing pressure between the intaglio cylinder and the impression cylinder, and a potentiometer 91 for the motor for adjusting the printing pressure between the intaglio cylinder and the impression cylinder, which is drivingly coupled to the motor 45, is connected via an A/D converter 90.

To the input/output device 68, a rotary encoder 94 for the drive motor of the printing press is connected via an A/D converter 92 and an F/V converter 93.

To the interface 69, there are connected a control device 100-1 for the first ink fountain roller to a control device 100-M for the Mth ink fountain roller, and a control device 120-(1-1) for the first ink fountain key of the first ink supply unit to a control device 120-(M-N) for the Nth ink fountain key of the Mth ink supply unit.

The ink fountain roller control devices 100-1 to 100-M comprise CPU 101, RAM 102, ROM 103, and besides, a memory M48 for storing the received rotational speed of the ink fountain roller, a memory M49 for storing the desired rotational speed of the ink fountain roller, an input/output device 104, and an interface 105, which are connected together by a BUS line 106, as shown in FIG. 2.

To the input/output device 104, a motor 108 for driving the ink fountain roller is connected via a driver 107 for the motor for driving the ink fountain roller, and a rotary encoder 111 for the motor for driving the ink fountain roller, which is drivingly connected to the motor 108 for driving the ink fountain roller, is connected via an F/V converter 110 and an A/D converter 109. A detection signal from the rotary encoder 111 for the motor for driving the ink fountain roller is also inputted into the driver 107 for the motor for driving the ink fountain roller. The aforementioned emboss amount and ink supply amount control device 60 is connected to the interface 105.

The ink fountain key control devices 120-(1-1) to 120-(M-N) comprise CPU 121, RAM 122, ROM 123, and besides, a memory M50 for storing the received opening amount of the ink fountain key, a memory M51 for storing the desired opening amount of the ink fountain key, a memory M52 for storing the count value of the counter, a memory M53 for storing the current opening amount of the ink fountain key, an input/output device 124, and an interface 125, which are connected together by a BUS line 126, as shown in FIG. 3.

To the input/output device 124, a motor 128 for driving the ink fountain key is connected via a driver 127 for the motor for driving the ink fountain key, and a rotary encoder 130 for the motor for driving the ink fountain key, which is drivingly connected to the motor 128 for driving the ink fountain key, is connected via a counter 129. A detection signal from the rotary encoder 130 for the motor for driving the ink fountain key is also inputted into the driver 127 for the motor for driving the ink fountain key. The aforementioned emboss amount and ink supply amount control device 60 is connected to the interface 125.

In the present embodiment, the aforementioned emboss amount and ink supply amount control device 60 (strictly, including the ink fountain roller control devices 100-1 to 100-M and the ink fountain key control devices 120-(1-1) to 120-(M-N)) can automatically adjust (correct) the rotational speed of the ink fountain roller 17a and the printing pressure between the intaglio cylinder 14 and the impression cylinder 13 in accordance with the results of measurements by the face side distance measuring instrument 74 and the reverse side distance measuring instrument 75 which measure the emboss amount or the ink film thickness of the printed sheet W.

The control actions or motions of the emboss amount and ink supply amount control device 60 configured as above will be described in detail based on the motion flow charts of FIGS. 4(a) to 4(c), FIGS. 5(a) to 5(f), and FIGS. 6(a) to 6(c).

In Step P1, the memories M1 to M9 and M11 to M47 are initialized. Then, in Step P2, it is determined whether the ink color ICm of the ink supply unit M and the image area rate IRmn in the range corresponding to each ink fountain key have been inputted. If the answer is Y (yes), in Step P3, the ink color ICm of the ink supply unit M and the image area rate IRmn in the range corresponding to each ink fountain key are inputted, and stored into the memories M1 and M2. If the answer is N (no), the program shifts to Step P4.

Then, in Step P4, it is determined whether an ink preset switch is ON. If the answer is Y, in Step P5, 1 is written into the count value M of the memory M3. If the answer is N, the program shifts to Step P31.

Then, in Step P6, 1 is written into the count value N of the memory M4. Then, in Step P7, the ink color ICm of the ink supply unit M is loaded from the memory M1. Then, in Step P8, the table of conversion from the image area rate to the opening amount of the ink fountain key, corresponding to the ink color ICm, is loaded from the memory M5.

Then, in Step P9, the image area rate IRmn in the range corresponding to the Nth ink fountain key of the ink supply unit M is loaded from the memory M2. Then, in Step P10, the opening amount Kmn of the Nth ink fountain key of the ink supply unit M is obtained from the image area rate IRmn in the range corresponding to the Nth ink fountain key of the ink supply unit M with the use of the table of conversion from the image area rate to the opening amount of the ink fountain key, corresponding to the ink color ICm, and the obtained value is stored into the Nth address position for the ink supply unit M in the memory M6 for storing the opening amount Kmn of each ink fountain key.

Then, in Step P11, 1 is added to the count value N of the memory M4 for overwriting. Then, in Step P12, the total number Nmax of the ink fountain keys of each ink supply unit is loaded from the memory M7. Then, in Step P13, it is determined whether the count value N is larger than the total number Nmax of the ink fountain keys of each ink supply unit.

Then, if the answer is Y in Step P13, Step P14 is executed to add 1 to the count value M of the memory M3 for overwriting. If the answer is N, the program returns to Step P7. Then, in Step P15, the total number Mmax of the ink supply units is loaded from the memory M25. Then, in Step P16, it is determined whether the count value M is larger than the total number Mmax of the ink supply units.

Then, if the answer is Y in Step P16, Step P17 is executed to write 1 into the count value M of the memory M3. If the answer is N, the program returns to Step P6. Then, in Step P18, 1 is written into the count value N of the memory M4. Then, in Step P19, the opening amount Kmn of the Nth ink fountain key of the ink supply unit M is loaded from the memory M6.

Then, in Step P20, the opening amount Kmn of the ink fountain key is transmitted to the control device for the Nth ink fountain key of the ink supply unit M. Then, if, in Step P21, a receipt confirmation signal has been transmitted from the control device for the Nth ink fountain key of the ink supply unit M, Step P22 is executed to add 1 to the count value N of the memory M4 for overwriting.

Then, in Step P23, the total number Nmax of the ink fountain keys of each ink supply unit is loaded from the memory M7. Then, in Step P24, it is determined whether the count value N is greater than the total number Nmax of the ink fountain keys of each ink supply unit. If the answer is Y, in Step P25, the ink color ICm of the ink supply unit M is loaded from the memory M1. If the answer is N, the program returns to Step P19.

Then, in Step P26, the reference rotational speed ratio IFRRFm of the ink fountain roller corresponding to the ink color ICm is loaded from the memory M8. Then, in Step P27, the reference rotational speed ratio IFRRFm of the ink fountain roller corresponding to the ink color ICm is written into the address for the ink supply unit M in the memory M9 for storing the rotational speed ratio IFRRm of the ink fountain roller.

Then, in Step P28, 1 is added to the count value M of the memory M3 for overwriting. Then, in Step P29, the total number Mmax of the ink supply units is loaded from the memory M25. Then, in Step P30, it is determined whether the count value M is larger than the total number Mmax of the ink supply units. If the answer is Y, the program shifts to Step P31. If the answer is N, the program returns to Step P18.

In accordance with the above steps, presetting of the control means for the ink supply amount of the inking device in conformity with the inputted image area rate is completed.

Then, in Step P31, it is determined whether a selection switch for adjusting the printing pressure between the intaglio cylinder and the impression cylinder is ON. If the answer is Y, it is determined in Step P32 whether a pressure adjustment completion switch is ON. If the answer is N in Step P31, on the other hand, the program shifts to Step P41 to be described later.

Then, if the answer is Y in Step P32, the program shifts to Step P41 to be described later. If the answer is N, it is determined in Step P33 whether an up-button is ON. If the answer is Y in this step, Step P34 is executed to output a normal rotation command to the driver 88 for the motor for adjusting the printing pressure between the intaglio cylinder and the impression cylinder. If the answer is N in Step P33, the program shifts to Step P37 to be described later.

Then, if the up-button is OFF in Step P35, outputting of the normal rotation command to the driver 88 for the motor for adjusting the printing pressure between the intaglio cylinder and the impression cylinder is stopped in Step P36. Then, in Step P37, it is determined whether a down-button is ON.

If the answer is Y in Step P37, Step P38 is executed to output a reverse rotation command to the driver 88 for the motor for adjusting the printing pressure between the intaglio cylinder and the impression cylinder. If the answer is N, the program returns to Step P32. Then, if the down-button is OFF in Step P39, outputting of the reverse rotation command to the driver 88 for the motor for adjusting the printing pressure between the intaglio cylinder and the impression cylinder is stopped in Step P40. Then, the program returns to Step P32.

In accordance with the above-described steps, manual adjustment of the printing pressure by the operator is completed.

Then, in Step P41, it is determined whether a sheet thickness measuring switch is ON. If the answer is Y, in Step P42, a normal rotation command is outputted to the driver 77 for the motor for movement in the circumferential direction. Then, in Step P43, the value of the counter 79 for measuring the current position in the circumferential direction of the distance measuring instrument is loaded, and stored into the memory M11.

Then, in Step P44, the current position in the circumferential direction of the distance measuring instrument is computed from the loaded value of the counter for measuring the current position in the circumferential direction of the distance measuring instrument, and stored into the memory M12. Then, in Step P45, the position in the circumferential direction of the sheet thickness measuring position to be measured by the distance measuring instrument is loaded from the memory M13.

Then, in Step P46, it is determined whether the current position in the circumferential direction of the distance measuring instrument is equal to the position in the circumferential direction of the sheet thickness measuring position to be measured by the distance measuring instrument. If the answer is Y, outputting of the normal rotation command to the driver 77 for the motor for movement in the circumferential direction is stopped in Step P47. If the answer is N, the program returns to Step P43.

Then, in Step P48, a normal rotation command is outputted to the driver 83 for the motor for movement in the lateral direction. Then, in Step P49, the value of the counter 85 for measuring the current position in the lateral direction of the distance measuring instrument is loaded, and stored into the memory M14. Then, in Step P50, the current position in the lateral direction of the distance measuring instrument is computed from the loaded value of the counter for measuring the current position in the lateral direction of the distance measuring instrument, and stored into the memory M15.

Then, in Step P51, the position in the lateral direction of the sheet thickness measuring position to be measured by the distance measuring instrument is loaded from the memory M16. Then, in Step P52, it is determined whether the current position in the lateral direction of the distance measuring instrument is equal to the position in the lateral direction of the sheet thickness measuring position to be measured by the distance measuring instrument. If the answer is Y, in Step P53, a measurement command signal is outputted to the distance measuring instrument. If the answer is N, the program returns to Step P49.

Then, in Step P54, the output FD of the face side distance measuring instrument 74 is loaded, and stored into the memory M17. Then, in Step P55, the output RD of the reverse side distance measuring instrument 75 is loaded, and stored into the memory M18. Then, in Step P56, outputting of the normal rotation command to the driver 83 for the motor for movement in the lateral direction is stopped.

Then, in Step P57, a reverse rotation command is outputted to the driver 83 for the motor for movement in the lateral direction. Then, if the output of the detector 87 for the home position in the lateral direction of the distance measuring instrument is ON in Step P58, outputting of the reverse rotation command to the driver 83 for the motor for movement in the lateral direction is stopped in Step P59.

Then, in Step P60, a reverse rotation command is outputted to the driver 77 for the motor for movement in the circumferential direction. Then, if the output of the detector 81 for the home position in the circumferential direction of the distance measuring instrument is ON in Step P61, outputting of the reverse rotation command to the driver 77 for the motor for movement in the circumferential direction is stopped in Step P62.

Then, in Step P63, the distance FDP from the face side distance measuring instrument to the sheet is computed from the output FD of the face side distance measuring instrument 74, and stored into the memory M19. Then, in Step P64, the distance RDP from the reverse side distance measuring instrument to the sheet is computed from the output RD of the reverse side distance measuring instrument 75, and stored into the memory M20.

Then, in Step P65, the distance FRD between the face side distance measuring instrument and the reverse side distance measuring instrument is loaded from the memory M21. Then, in Step P66, the distance FDP from the face side distance measuring instrument to the sheet and the distance RDP from the reverse side distance measuring instrument to the sheet are subtracted from the distance FRD between the face side distance measuring instrument and the reverse side distance measuring instrument to compute the sheet thickness PT, which is stored into the memory M22. Then, the program shifts to Step P151 to be described later.

In accordance with the above steps, the thickness of the sheet W, which is the object to be measured, is measured. The sheet thickness measuring position is set at a part of the sheet W, where nothing is printed, in other words, a part where neither the emboss nor the ink film is present.

If the answer is N in the aforementioned Step P41, on the other hand, it is determined in Step P67 whether a color patch measuring switch is ON. If the answer is Y, in Step P68, a normal rotation command is outputted to the driver 77 for the motor for movement in the circumferential direction. If the answer is N, the program shifts to Step P151 to be described later.

Then, in Step P69, the value of the counter 79 for measuring the current position in the circumferential direction of the distance measuring instrument is loaded, and stored into the memory M11. Then, in Step P70, the current position in the circumferential direction of the distance measuring instrument is computed from the loaded value of the counter for measuring the current position in the circumferential direction of the distance measuring instrument, and stored into the memory M12. Then, in Step P71, the position in the circumferential direction of the color patch line to be measured by the distance measuring instrument is loaded from the memory M23.

Then, in Step P72, it is determined whether the current position in the circumferential direction of the distance measuring instrument is equal to the position in the circumferential direction of the color patch line to be measured by the distance measuring instrument. If the answer is Y, outputting of the normal rotation command to the driver 77 for the motor for movement in the circumferential direction is stopped in Step P73. If the answer is N, the program returns to Step P69.

Then, in Step P74, 1 is written into the count value M of the memory M3. Then, in Step P75, a normal rotation command is outputted to the driver 83 for the motor for movement in the lateral direction. Then, in Step P76, the value of the counter 85 for measuring the current position in the lateral direction of the distance measuring instrument is loaded, and stored into the memory M14.

Then, in Step P77, the current position in the lateral direction of the distance measuring instrument is computed from the loaded value of the counter for measuring the current position in the lateral direction of the distance measuring instrument, and stored into the memory M15. Then, in Step P78, the position in the lateral direction of the color patch line in the ink supply unit M to be measured by the distance measuring instrument is loaded from the memory M24.

Then, in Step P79, it is determined whether the current position in the lateral direction of the distance measuring instrument is equal to the position in the lateral direction of the color patch line in the ink supply unit M to be measured by the distance measuring instrument. If the answer is Y, in Step P80, a measurement command signal is outputted to the distance measuring instrument. If the answer is N, the program returns to Step P76.

Then, in Step P81, the output FDm of the face side distance measuring instrument 74 is loaded, and stored into the address position for the ink supply unit M in the memory M17. Then, in Step P82, the output RDm of the reverse side distance measuring instrument 75 is loaded, and stored into the address position for the ink supply unit M in the memory M18.

Then, in Step P83, 1 is added to the count value M of the memory M15 for overwriting. Then, in Step P84, the total number Mmax of the ink supply units is loaded from the memory M25. Then, in Step P85, it is determined whether the count value M is larger than the total number Mmax of the ink supply units. If the answer is Y, outputting of the normal rotation command to the driver 83 for the motor for movement in the lateral direction is stopped in Step P86. If the answer is N, the program returns to Step P76.

Then, in Step P87, a reverse rotation command is outputted to the driver 83 for the motor for movement in the lateral direction. Then, if the output of the detector 87 for the home position in the lateral direction of the distance measuring instrument is ON in Step P88, outputting of the reverse rotation command to the driver 83 for the motor for movement in the lateral direction is stopped in Step P89.

Then, in Step P90, a reverse rotation command is outputted to the driver 77 for the motor for movement in the circumferential direction. Then, if the output of the detector 81 for the home position in the circumferential direction of the distance measuring instrument is ON in Step P91, outputting of the reverse rotation command to the driver 77 for the motor for movement in the circumferential direction is stopped in Step P92.

In accordance with the above steps, the distances from the face side distance measuring instrument 74 and the reverse side distance measuring instrument 75 to the color patch line L printed with ink supplied from each ink supply unit are measured.

Then, in Step P93, 1 is written into the count value M of the memory M3. Then, the output FDm of the face side distance measuring instrument 74 stored in the address position for the ink supply unit M in the memory M17 is loaded in Step P94. Then, in Step P95, the distance FDCm from the face side distance measuring instrument to the color patch portion is computed from the output FDm of the face side distance measuring instrument 74 stored in the address position for the ink supply unit M in the memory M17, and the computed distance is stored into the memory M26.

Then, the output RDm of the reverse side distance measuring instrument 75 stored in the address position for the ink supply unit M in the memory M18 is loaded in Step P96. Then, in Step P97, the distance RDCm from the reverse side distance measuring instrument to the color patch portion is computed from the output RDm of the reverse side distance measuring instrument 75 stored in the address position for the ink supply unit M in the memory M18, and the computed distance is stored into the memory M27.

Then, in Step P98, the distance RDP from the reverse side distance measuring instrument to the sheet is loaded from the memory M20. Then, in Step P99, the distance RDP from the reverse side distance measuring instrument to the sheet is subtracted from the distance RDCm from the reverse side distance measuring instrument to the color patch portion to compute the emboss amount EQm, which is stored into the address position for the ink supply unit M in the memory M28.

Then, in Step P100, the reference emboss amount EQFm of the ink supply unit M is loaded from the address position for the ink supply unit M in the memory M29 for storing the reference emboss amount EQF. Then, in Step P101, the reference emboss amount EQFm of the ink supply unit M is subtracted from the emboss amount EQm of the ink supply unit M to compute the emboss error amount EQDm of the ink supply unit M, which is stored into the address position for the ink supply unit M in the memory M30.

Then, in Step P102, the table of conversion from the emboss error amount to the correction amount of the printing pressure between the intaglio cylinder and the impression cylinder is loaded from the memory M31. Then, in Step P103, the correction amount of the printing pressure between the intaglio cylinder and the impression cylinder is obtained from the emboss error amount EQDm with the use of the table of conversion from the emboss error amount to the correction amount of the printing pressure between the intaglio cylinder and the impression cylinder, and the obtained correction amount is stored into the address position for the ink supply unit M in the memory M32.

Then, in Step P104, the distance FRD between the face side distance measuring instrument and the reverse side distance measuring instrument is loaded from the memory M21. Then, in Step P105, the distance FDCm from the face side distance measuring instrument to the color patch portion and the distance RDCm from the reverse side distance measuring instrument to the color patch portion are subtracted from the distance FRD between the face side distance measuring instrument and the reverse side distance measuring instrument to compute the thickness CPTm of the color patch portion, which is stored into the memory M33.

Then, in Step P106, the sheet thickness PT is loaded from the memory M22. Then, in Step P107, the sheet thickness PT is subtracted from the thickness CPTm of the color patch portion to compute the ink film thickness IFTm, which is stored into the address position for the ink supply unit M in the memory M34.

Then, in Step P108, the reference ink film thickness IFTFm of the ink supply unit M is loaded from the address position for the ink supply unit M in the memory M35 for storing the reference ink film thickness IFTF. Then, in Step P109, the reference ink film thickness IFTFm of the ink supply unit M is subtracted from the ink film thickness IFTm of the ink supply unit M to compute the ink film thickness error amount IFTDm of the ink supply unit M, which is stored into the address position for the ink supply unit M in the memory M36.

Then, in Step P110, the ink color ICm of the ink supply unit M is loaded from the memory Ml. Then, in Step P111, the table of conversion from the ink film thickness error amount to the correction amount of the rotational speed ratio of the ink fountain roller, corresponding to the ink color ICm, is loaded from the memory M37.

Then, in Step P112, the correction amount of the rotational speed ratio of the ink fountain roller is obtained from the ink film thickness error amount IFTDm with the use of the table of conversion from the ink film thickness error amount to the correction amount of the rotational speed ratio of the ink fountain roller, corresponding to the ink color ICm, and the obtained value is stored into the address position for the ink supply unit M in the memory M38. Then, in Step P113, 1 is added to the count value M of the memory M3 for overwriting.

Then, in Step P114, the total number Mmax of the ink supply units is loaded from the memory M25. Then, in Step P115, it is determined whether the count value M is larger than the total number Mmax of the ink supply units. If the answer is Y, in Step P116, 1 is written into the count value M of the memory M3. If the answer is N, the program returns to Step P94.

Then, in Step P117, zero is written into the memory M39 for storing the total value of the correction amounts of the printing pressure between the intaglio cylinder and the impression cylinder. Then, in Step P118, the total value of the correction amounts of the printing pressure between the intaglio cylinder and the impression cylinder is loaded from the memory M39. Then, in Step P119, the correction amount of the printing pressure between the intaglio cylinder and the impression cylinder in the ink supply unit M is loaded from the memory M32.

Then, in Step P120, the correction amount of the printing pressure between the intaglio cylinder and the impression cylinder in the ink supply unit M is added to the total value of the correction amounts of the printing pressure between the intaglio cylinder and the impression cylinder, and the memory M39 for storing the total value of the correction amounts of the printing pressure between the intaglio cylinder and the impression cylinder is overwritten with the value obtained by addition. Then, in Step P121, 1 is added to the count value M of the memory M3 for overwriting.

Then, in Step P122, the total number Mmax of the ink supply units is loaded from the memory M25. Then, in Step P123, it is determined whether the count value M is larger than the total number Mmax of the ink supply units. If the answer is Y, in Step P124, the total value of the correction amounts of the printing pressure between the intaglio cylinder and the impression cylinder is loaded from the memory M39. If the answer is N, the program returns to Step P118.

Then, in Step P125, the total number Mmax of the ink supply units is loaded from the memory M25. Then, in Step P126, the total value of the correction amounts of the printing pressure between the intaglio cylinder and the impression cylinder is divided by the total number Mmax of the ink supply units to compute the average value of the correction amounts of the printing pressure between the intaglio cylinder and the impression cylinder, followed by storing the average value into the memory M40.

In accordance with the above steps, the correction amount of the rotational speed ratio of the ink fountain roller of each inking device, and the average value of the correction amounts of the printing pressure between the intaglio cylinder and the impression cylinder are obtained from the ink film thickness and the emboss amount of the color patch line L which have been measured.

Then, in Step P127, 1 is written into the count value M of the memory M3. Then, in Step P128, the rotational speed ratio IFRRm of the ink fountain roller of the ink supply unit M is loaded from the memory M9. Then, in Step P129, the correction amount of the rotational speed ratio of the ink fountain roller of the ink supply unit M is loaded from the memory M38.

Then, in Step P130, the correction amount of the rotational speed ratio of the ink fountain roller of the ink supply unit M is added to the rotational speed ratio IFRRm of the ink fountain roller of the ink supply unit M, and the address position for the ink supply unit M in the memory M9 for storing the rotational speed ratio IFRRm of the ink fountain roller is overwritten with the obtained value. Then, in Step P131, 1 is added to the count value M of the memory M3 for overwriting.

Then, in Step P132, the total number Mmax of the ink supply units is loaded from the memory M25. Then, in Step P133, it is determined whether the count value M is greater than the total number Mmax of the ink supply units. If the answer is Y, in Step P134, the output of the A/D converter 90 connected to the potentiometer 91 for the motor for adjusting the printing pressure between the intaglio cylinder and the impression cylinder is loaded, and stored into the memory M41. If the answer is N, the program returns to Step P128.

In accordance with the above steps, the rotational speed ratio of the ink fountain roller corrected with the obtained correction amount is obtained.

Then, in Step P135, the current printing pressure between the intaglio cylinder and the impression cylinder is computed from the output of the A/D converter 99 connected to the potentiometer 91 for the motor for adjusting the printing pressure between the intaglio cylinder and the impression cylinder, and the computed value is stored into the memory M42. Then, in Step P136, the average value of the correction amounts of the printing pressure between the intaglio cylinder and the impression cylinder is loaded from the memory M40.

Then, in Step P137, it is determined whether the average value of the correction amounts of the printing pressure between the intaglio cylinder and the impression cylinder is unequal to zero. If the answer is Y, in Step P138, it is determined whether the average value of the correction amounts of the printing pressure between the intaglio cylinder and the impression cylinder is larger than zero. If the answer is N in Step P137, the program returns to Step P2.

If the answer is Yin the above Step P138, Step P139 is executed to add the average value of the correction amounts of the printing pressure between the intaglio cylinder and the impression cylinder to the current printing pressure between the intaglio cylinder and the impression cylinder to compute the desired printing pressure between the intaglio cylinder and the impression cylinder, and store the desired printing pressure into the memory M43. Then, in Step P140, the desired output of the A/D converter connected to the potentiometer for the motor for adjusting the printing pressure between the intaglio cylinder and the impression cylinder is computed from the desired printing pressure between the intaglio cylinder and the impression cylinder, and stored into the memory M44.

Then, in Step P141, a normal rotation command is outputted to the driver 88 for the motor for adjusting the printing pressure between the intaglio cylinder and the impression cylinder. Then, in Step P142, the output of the A/D converter 90 connected to the potentiometer 91 for the motor for adjusting the printing pressure between the intaglio cylinder and the impression cylinder is loaded, and stored into the memory M41.

Then, in Step P143, it is determined whether the loaded output of the A/D converter connected to the potentiometer for the motor for adjusting the printing pressure between the intaglio cylinder and the impression cylinder is equal to the desired output of the A/D converter connected to the potentiometer for the motor for adjusting the printing pressure between the intaglio cylinder and the impression cylinder. If the answer is Y, the outputting of the normal rotation command to the driver 88 for the motor for adjusting the printing pressure between the intaglio cylinder and the impression cylinder is stopped in Step P144. Then, the program returns to Step P2. If the answer is N, the program returns to Step P142.

If the answer is N in the aforementioned Step P138, on the other hand, Step P145 is executed to add the average value of the correction amounts of the printing pressure between the intaglio cylinder and the impression cylinder to the current printing pressure between the intaglio cylinder and the impression cylinder to compute the desired printing pressure between the intaglio cylinder and the impression cylinder, and store the desired printing pressure into the memory M43. Then, in Step P146, the desired output of the A/D converter connected to the potentiometer for the motor for adjusting the printing pressure between the intaglio cylinder and the impression cylinder is computed from the desired printing pressure between the intaglio cylinder and the impression cylinder, and stored into the memory M44.

Then, in Step P147, a reverse rotation command is outputted to the driver 88 for the motor for adjusting the printing pressure between the intaglio cylinder and the impression cylinder. Then, in Step P148, the output of the A/D converter 90 connected to the potentiometer 91 for the motor for adjusting the printing pressure between the intaglio cylinder and the impression cylinder is loaded, and stored into the memory M41.

Then, in Step P149, it is determined whether the loaded output of the A/D converter connected to the potentiometer for the motor for adjusting the printing pressure between the intaglio cylinder and the impression cylinder is equal to the desired output of the A/D converter connected to the potentiometer for the motor for adjusting the printing pressure between the intaglio cylinder and the impression cylinder. If the answer is Y, the outputting of the reverse rotation command to the driver 88 for the motor for adjusting the printing pressure between the intaglio cylinder and the impression cylinder is stopped in Step P150. Then, the program returns to Step P2. If the answer is N, the program returns to Step P148.

In accordance with the above steps, the printing pressure is corrected in response to the obtained average value of the correction amounts of the printing pressure between the intaglio cylinder and the impression cylinder.

In Step P151 shifted from the aforementioned Step P66 or Step P67, the output of the A/D converter 92 connected to the rotary encoder 94 for the drive motor of the printing press is loaded, and stored into the memory M45. Then, in Step P152, the current rotational speed R of the printing press is computed from the output of the A/D converter connected to the rotary encoder for the drive motor of the printing press, and the computed value is stored into the memory M46.

Then, in Step P153, 1 is written into the count value M of the memory M3. Then, in Step P154, the rotational speed ratio IFRRm of the ink fountain roller of the ink supply unit M is loaded from the memory M9. Then, in Step P155, the current rotational speed R of the printing press is loaded from the memory M46.

Then, in Step P156, the current rotational speed R of the printing press is multiplied by the rotational speed ratio IFRRm of the ink fountain roller of the ink supply unit M to compute the rotational speed IFRm of the ink fountain roller of the ink supply unit M, and the computed value is stored into the memory M47. Then, in Step P157, the rotational speed IFRm of the ink fountain roller is transmitted to the control device for the ink fountain roller of the ink supply unit M.

Then, upon transmission of a receipt confirmation signal from the control device for the ink fountain roller of the ink supply unit M in Step P158, 1 is added to the count value M of the memory M3 in Step P159 for overwriting.

Then, in Step P160, the total number Mmax of the ink supply units is loaded from the memory M25. Then, in Step P161, it is determined whether the count value M is greater than the total number Mmax of the ink supply units. If the answer is Y, the program returns to Step P2. If the answer is N, the program returns to Step P154. Then, this procedure is repeated.

In accordance with the above steps, the ink fountain roller is rotated with the corrected rotational speed ratio of the ink fountain roller.

The control device 120-(1-1) for the first ink fountain key of the first ink supply unit to the control device 120-(M-N) for the Nth ink fountain key of the Mth ink supply unit act in accordance with the motion or action flow shown in FIG. 7.

If, in Step P1, the opening amount Kmn of the ink fountain key is transmitted from the emboss amount and ink supply amount control device 60, Step P2 is executed to receive the opening amount Kmn of the ink fountain key and store the received opening amount Kmn of the ink fountain key into the memory M50 for storing the received opening amount Kmn of the ink fountain key. Then, in Step P3, a receipt confirmation signal is transmitted to the emboss amount and ink supply amount control device 60.

Then, in Step P4, the received opening amount Kmn of the ink fountain key is written into the memory M51 for storing the desired opening amount (position) of the ink fountain key. Then, in Step P5, the count value of the counter 129 is loaded and stored into the memory M52. Then, in Step P6, the current opening amount (position) of the ink fountain key is computed from the count value of the counter 129, and stored into the memory M53.

Then, in Step P7, it is determined whether the desired position of the ink fountain key is equal to the current position of the ink fountain key. If the answer is Y, the program returns to Step P1. If the answer is N, it is determined in Step P8 whether the desired position of the ink fountain key is greater than the current position of the ink fountain key.

If the answer is Y in Step P8, Step P9 is executed to output a normal rotation command to the driver 127 for the motor for driving the ink fountain key. If the answer is N in Step P8, Step P10 is executed to output a reverse rotation command to the driver 127 for the motor for driving the ink fountain key.

Then, in Step P11, the count value of the counter 129 is loaded, and stored into the memory M52. Then, in Step P12, the current position of the ink fountain key is computed from the count value of the counter 129, and stored into the memory M53.

Then, in Step P13, it is determined whether the current position of the ink fountain key is equal to the desired position of the ink fountain key. If the answer is Y, in Step P14, a stop command is outputted to the driver 127 for the motor for driving the ink fountain key. Then, the program returns to Step P1. If the answer is N, the program returns to Step P11. Then, this procedure is repeated.

The control device 100-1 for the first ink fountain roller to the control device 100-M for the Mth ink fountain roller act in accordance with the motion flow shown in FIG. 8.

If, in Step P1, the rotational speed IFRm of the ink fountain roller is transmitted from the emboss amount and ink supply amount control device 60, Step P2 is executed to receive the rotational speed IFRm of the ink fountain roller and store the received rotational speed IFRm of the ink fountain roller into the memory M48 for storing the received rotational speed IFRm of the ink fountain roller. Then, in Step P3, a receipt confirmation signal is transmitted to the emboss amount and ink supply amount control device 60.

Then, in Step P4, the received rotational speed IFRm of the ink fountain roller is written and stored into the memory M49 for storing the desired rotational speed of the ink fountain roller. Then, in Step P5, the desired rotational speed of the ink fountain roller is loaded from the memory M49.

Then, in Step P6, a rotational speed command on the desired rotational speed of the ink fountain roller is outputted to the driver 107 for the motor for driving the ink fountain roller. Then, the program returns to Step P1. Afterwards, this procedure is repeated.

According to the present embodiment described above, in the Orloff (type) intaglio printing press, the ink film thickness and emboss amount of the printed sheet W are measured using the face side distance measuring instrument 74 and the reverse side distance measuring instrument 75. In accordance with the measured emboss amount, the aforementioned motor 45 is drivingly controlled to adjust the printing pressure between the intaglio cylinder 14 and the impression cylinder 13 automatically. Similarly, in accordance with the measured ink film thickness, the aforementioned motor 108 is drivingly controlled, whereby the rotational speed (i.e., ink supply amount) of the ink fountain roller 17a in each ink supply unit is automatically adjusted.

Thus, printing troubles due to misadjustment of the ink supply amount or the printing pressure owing to the operator's manual operation can be avoided. Consequently, burden on the operator can be lessened, and the emboss amount and the ink film thickness can be controlled with high accuracy to decrease defective printing products (wasted sheets).

In the present embodiment, it is acceptable to measure only the ink film thickness of the printed sheet W, and automatically adjust only the rotational speed (i.e., ink supply amount) of the ink fountain roller 17a in accordance with the measured ink film thickness.

### Embodiment 2

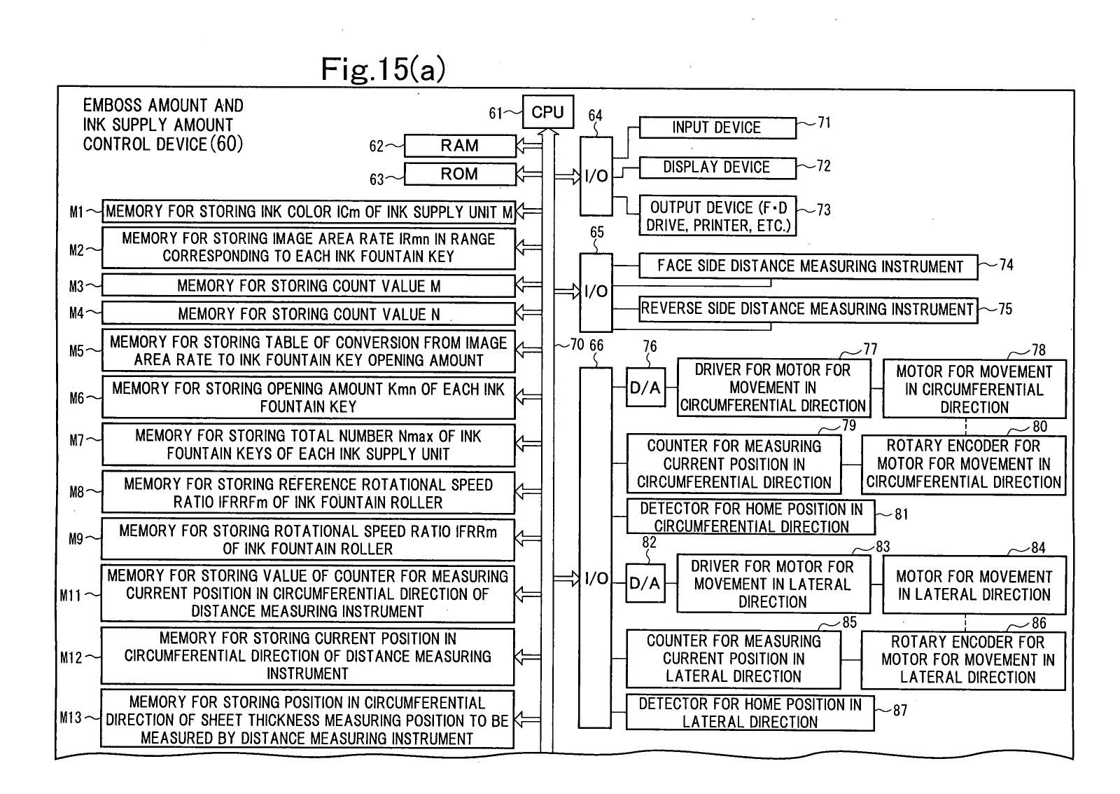

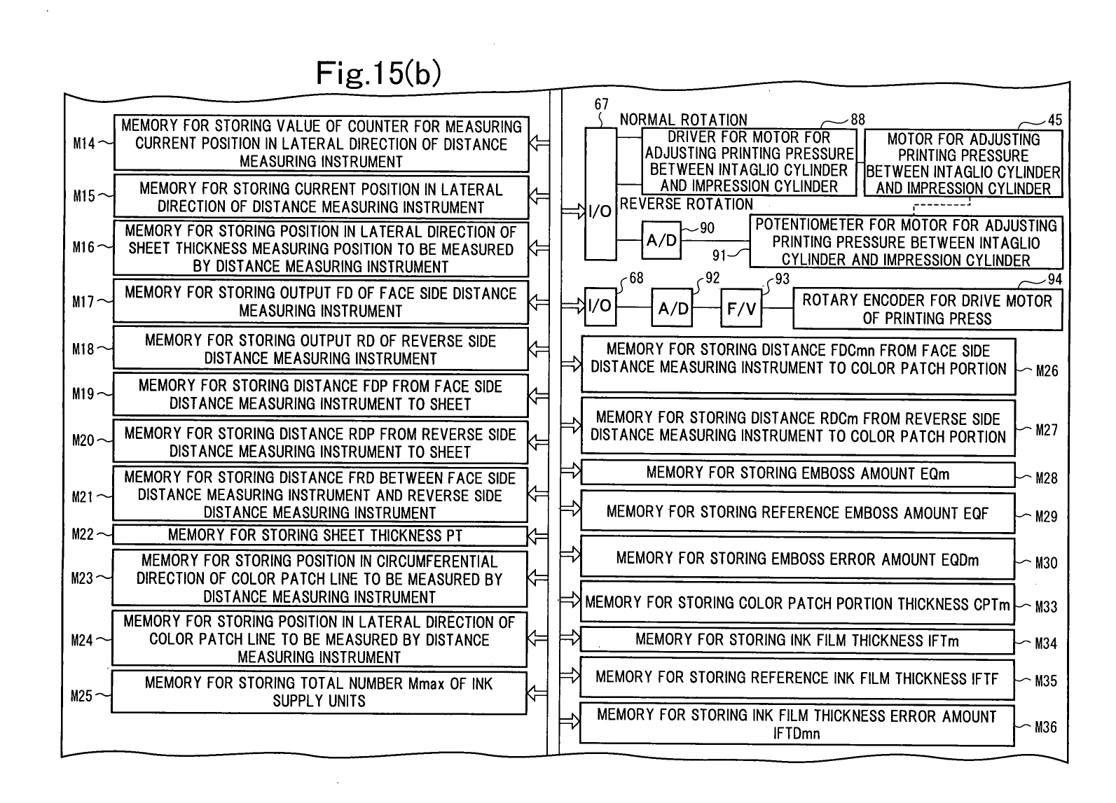

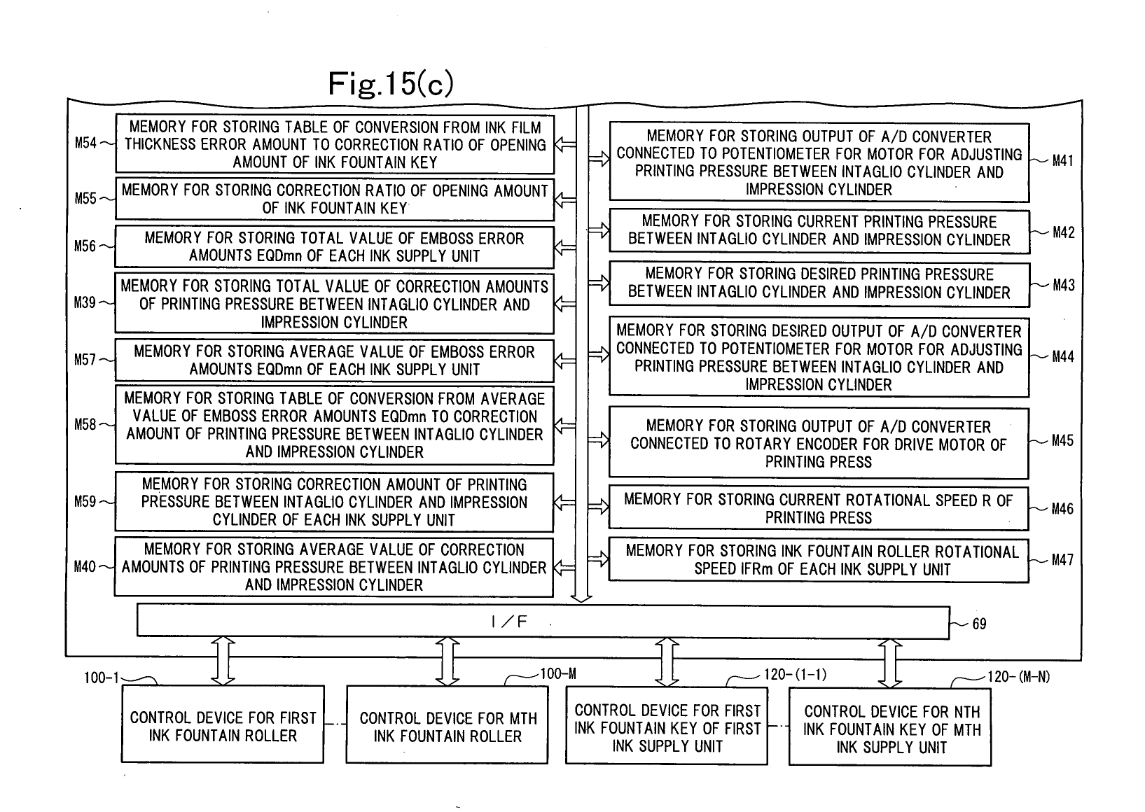

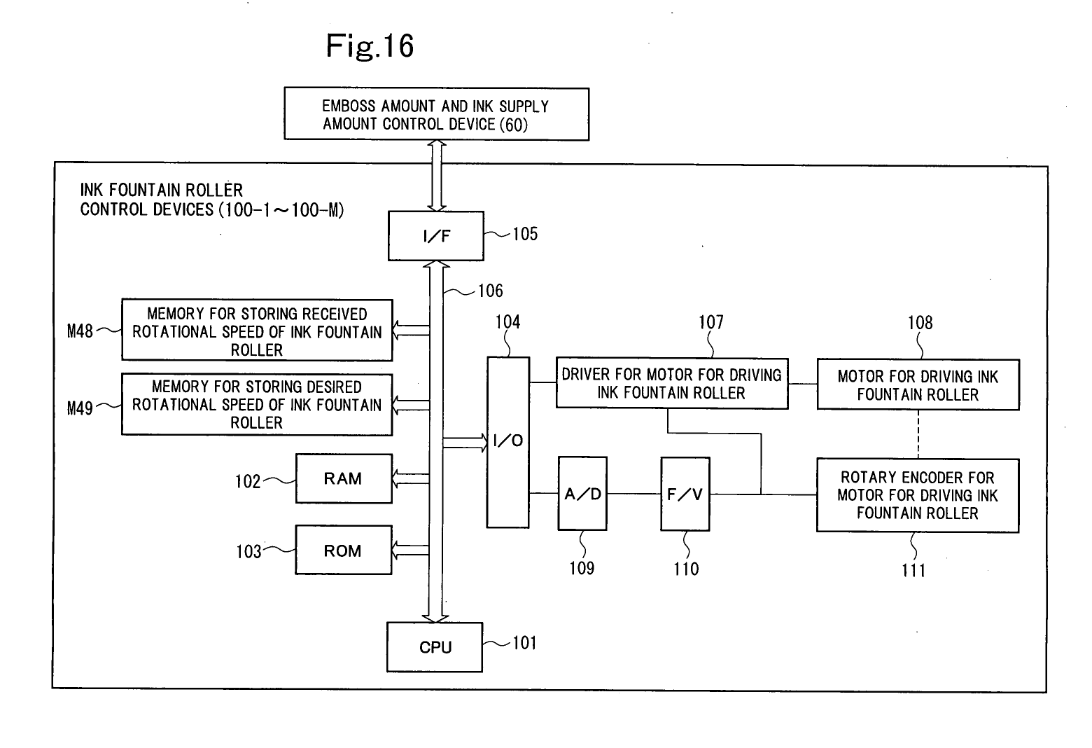

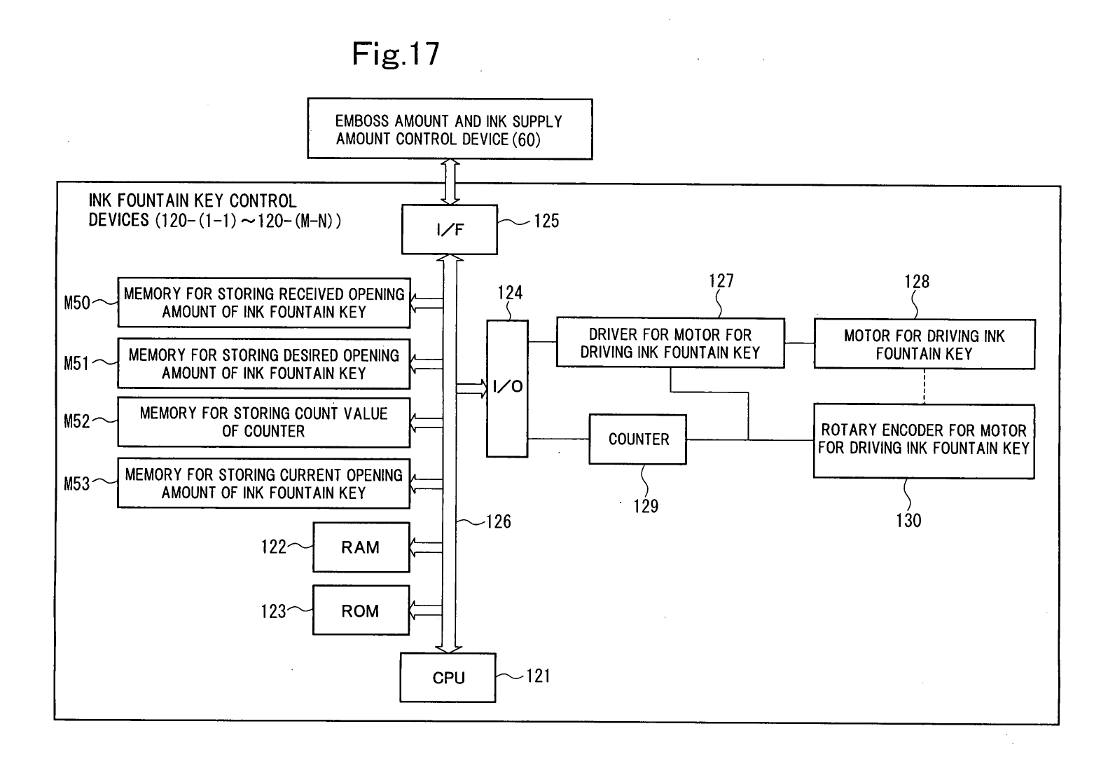

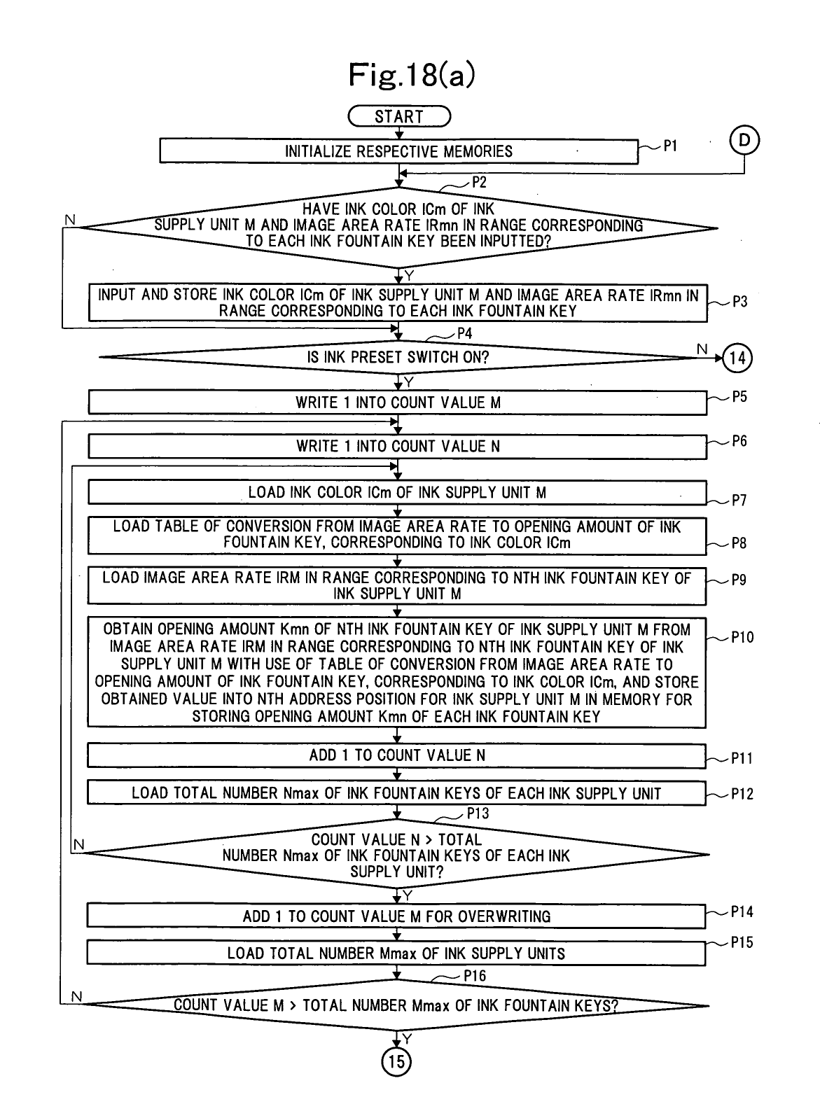

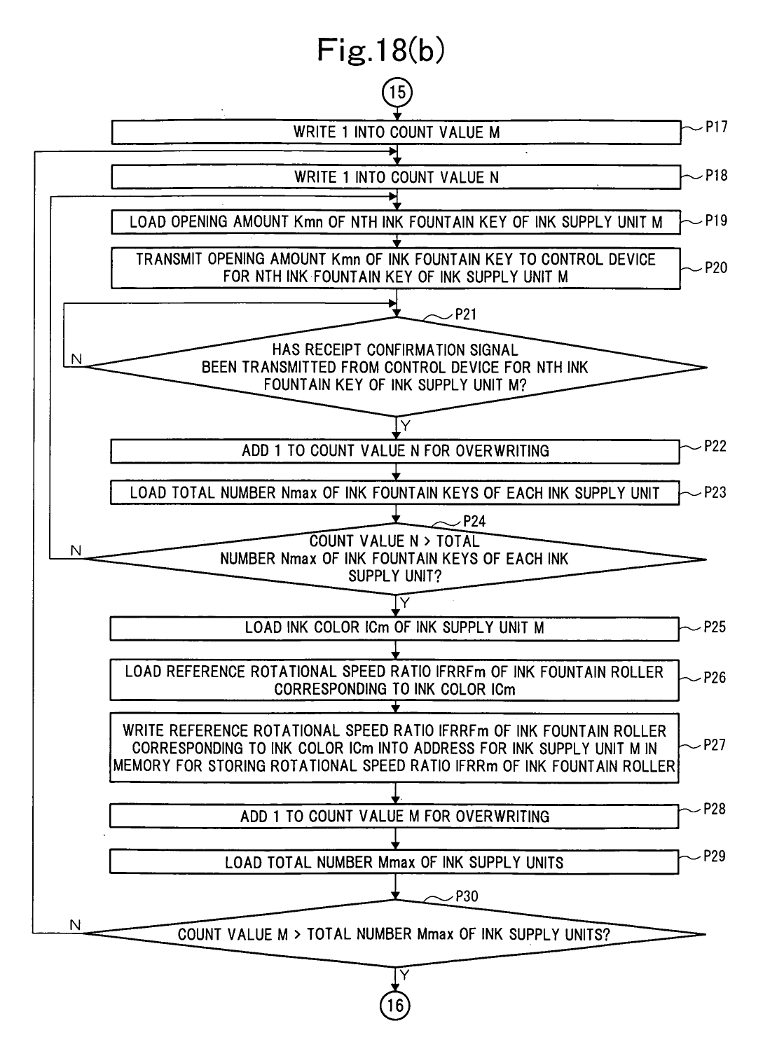

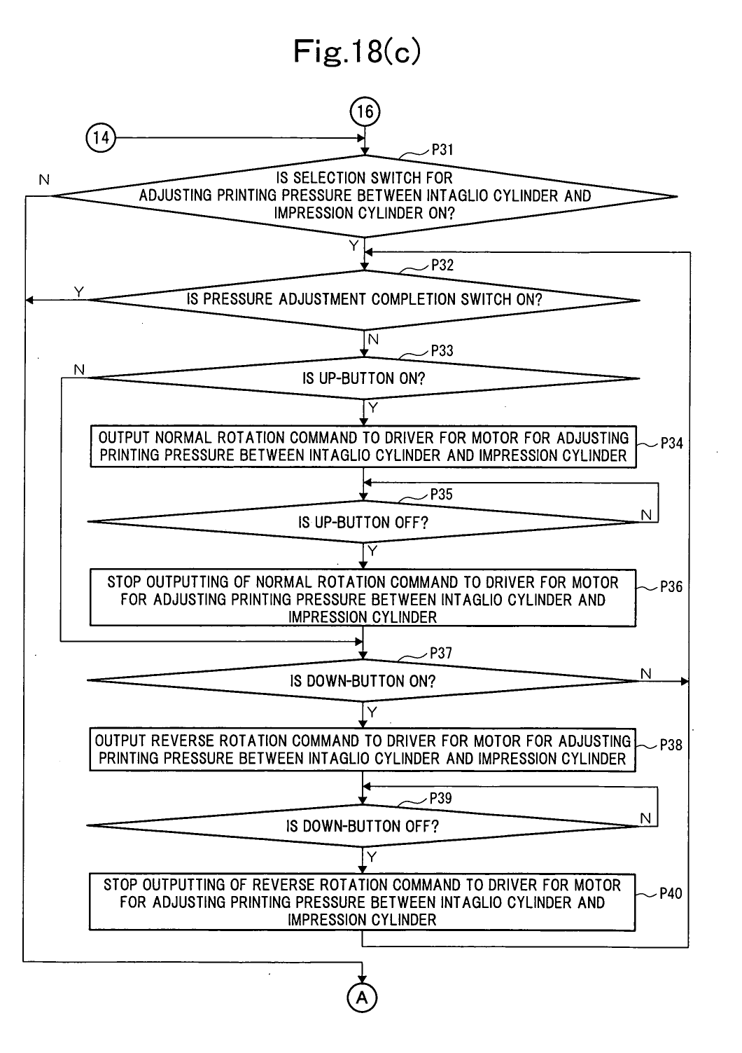

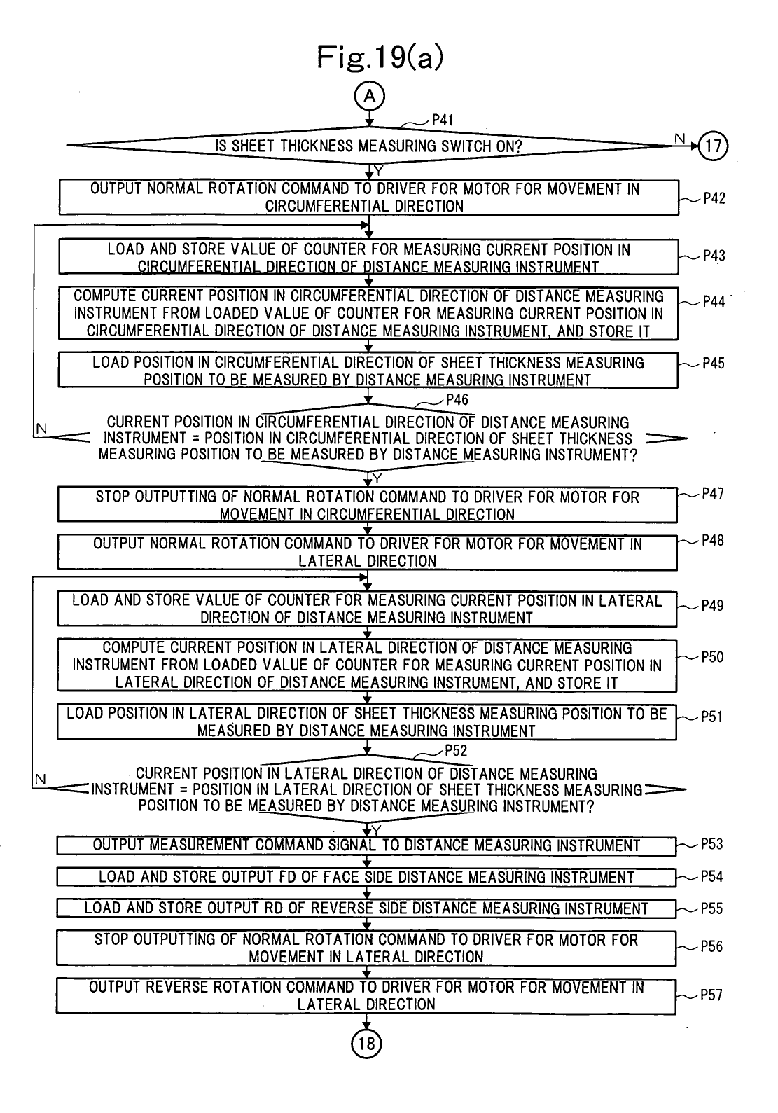

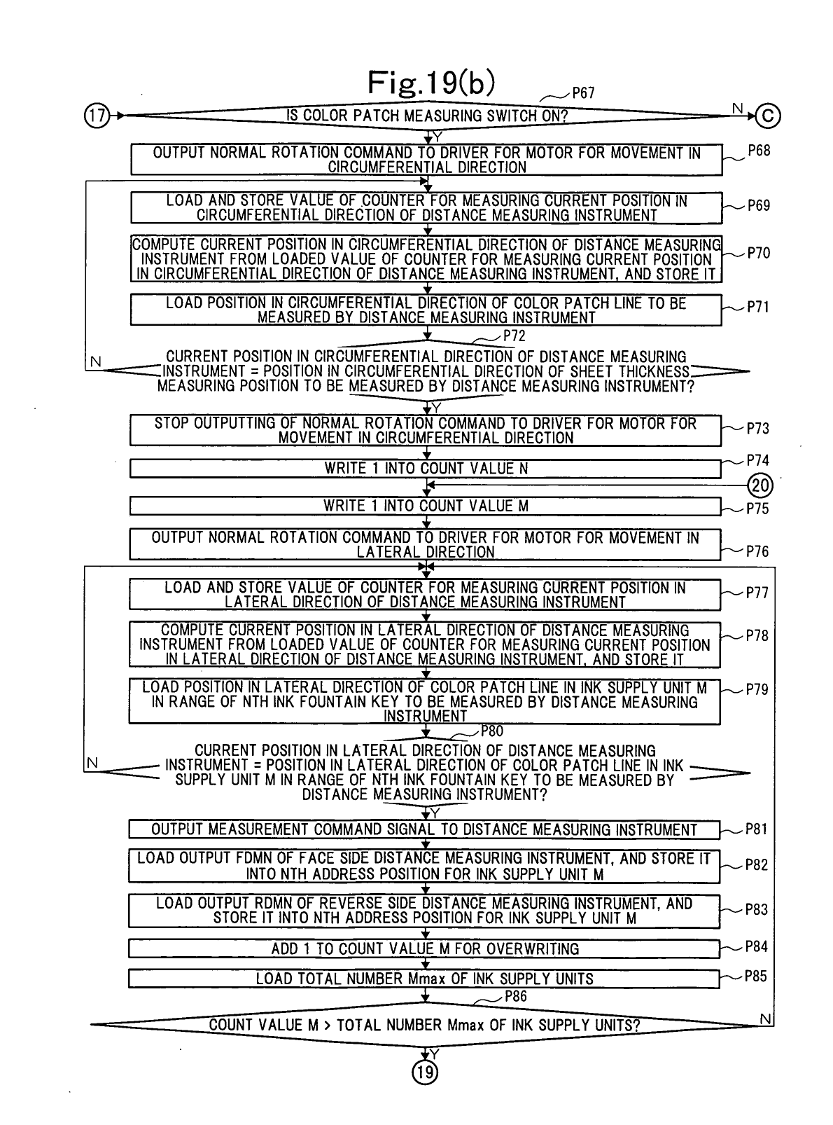

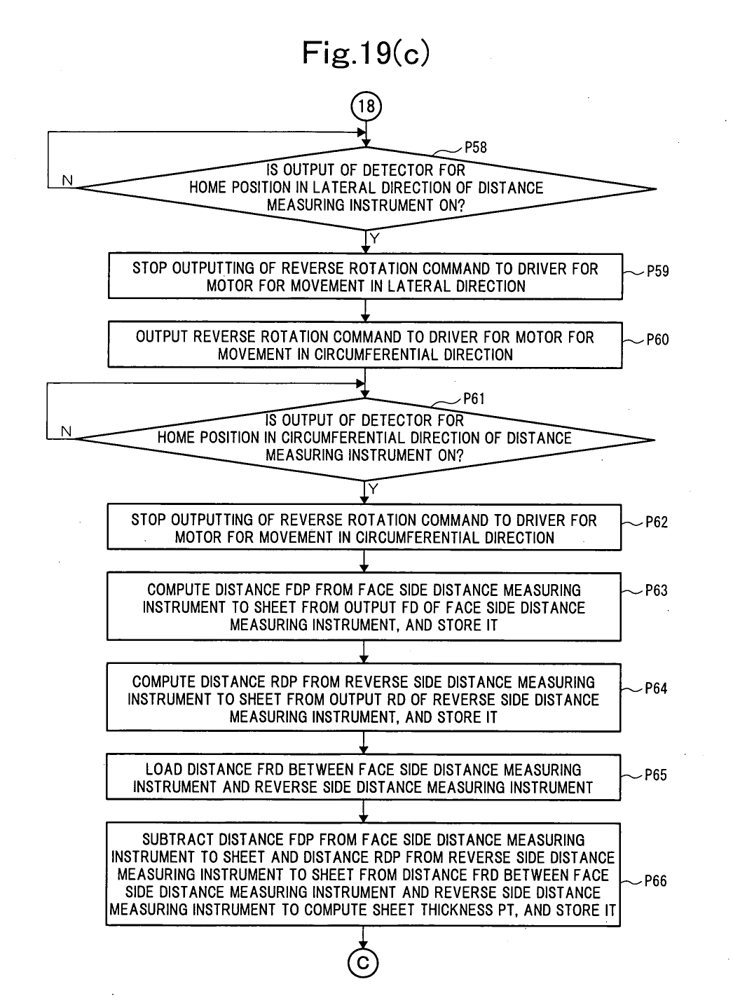

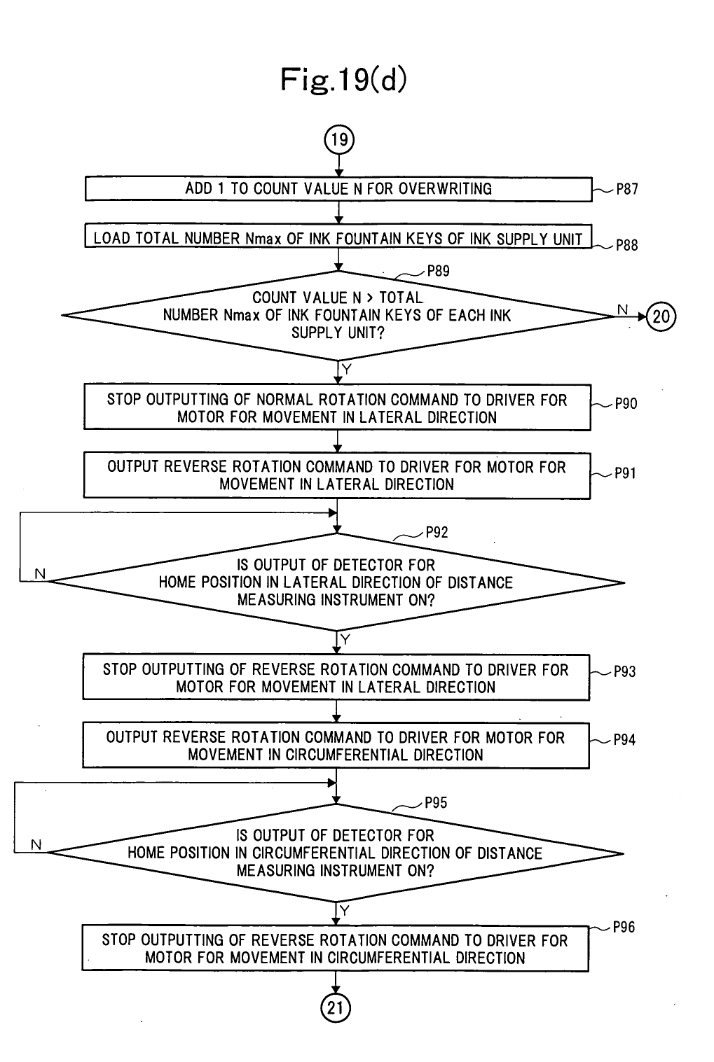

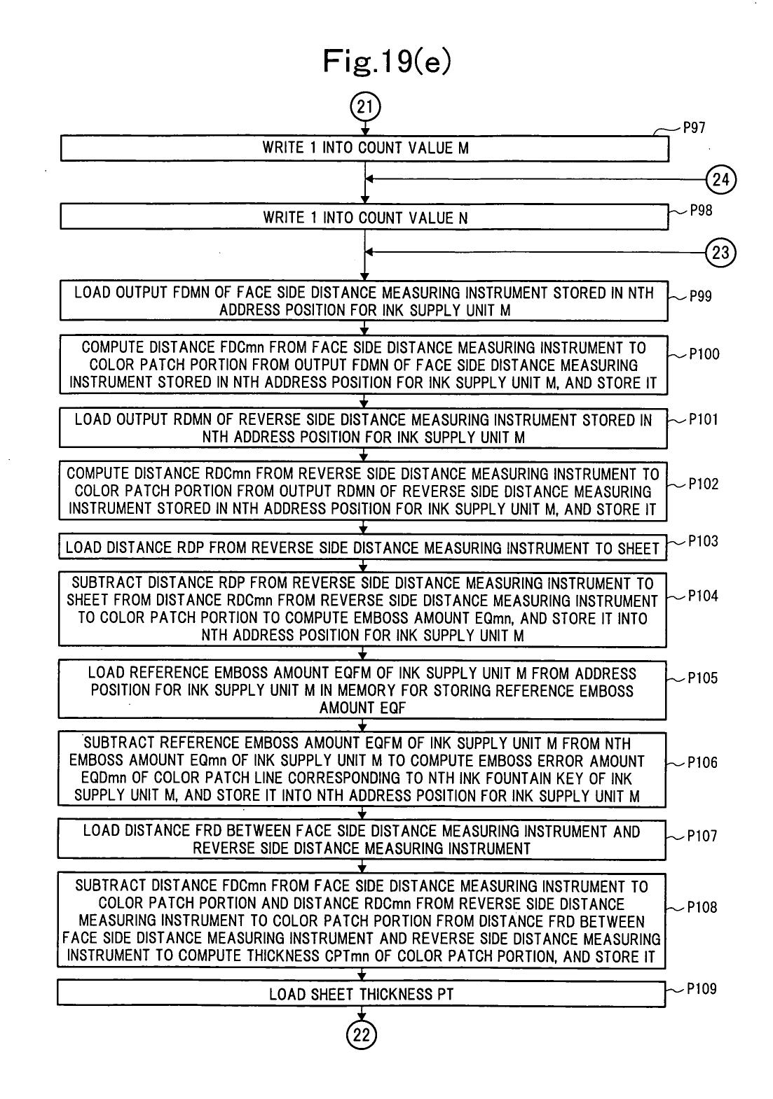

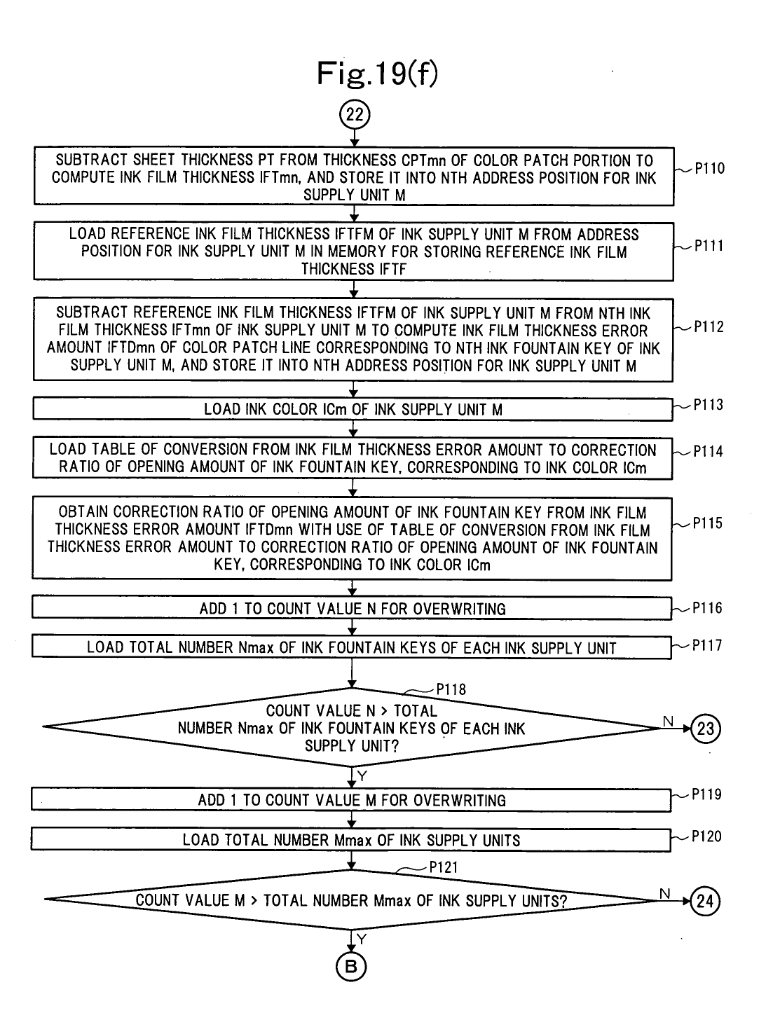

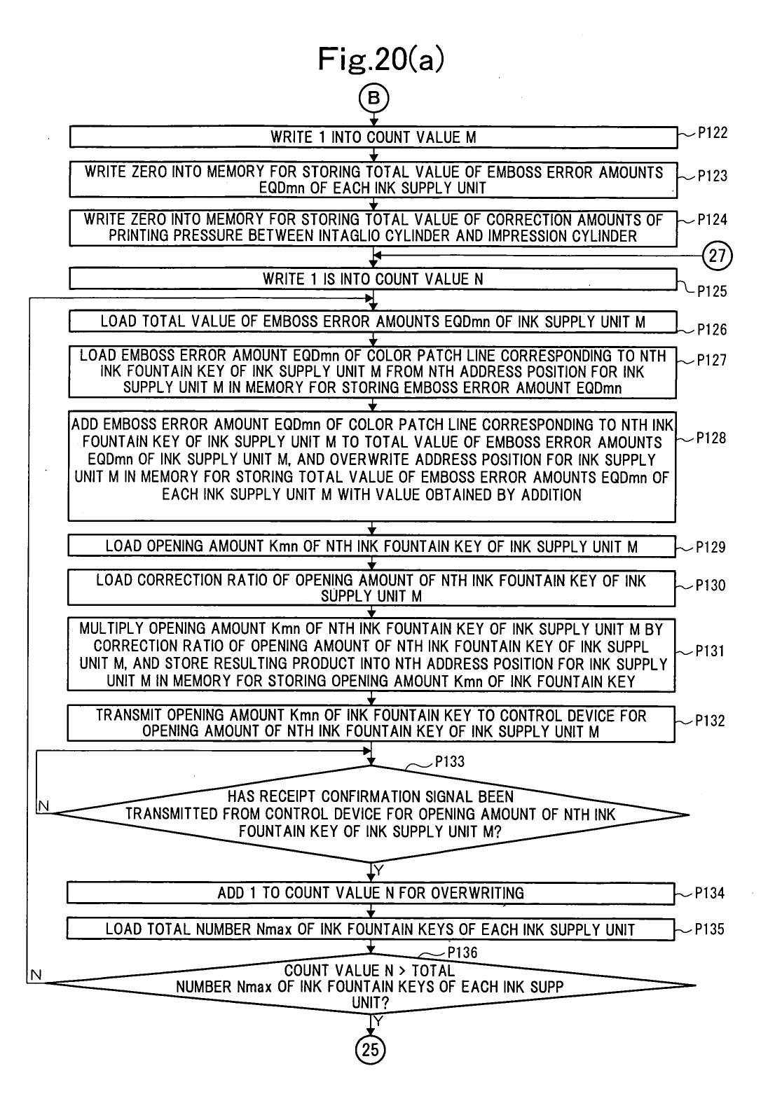

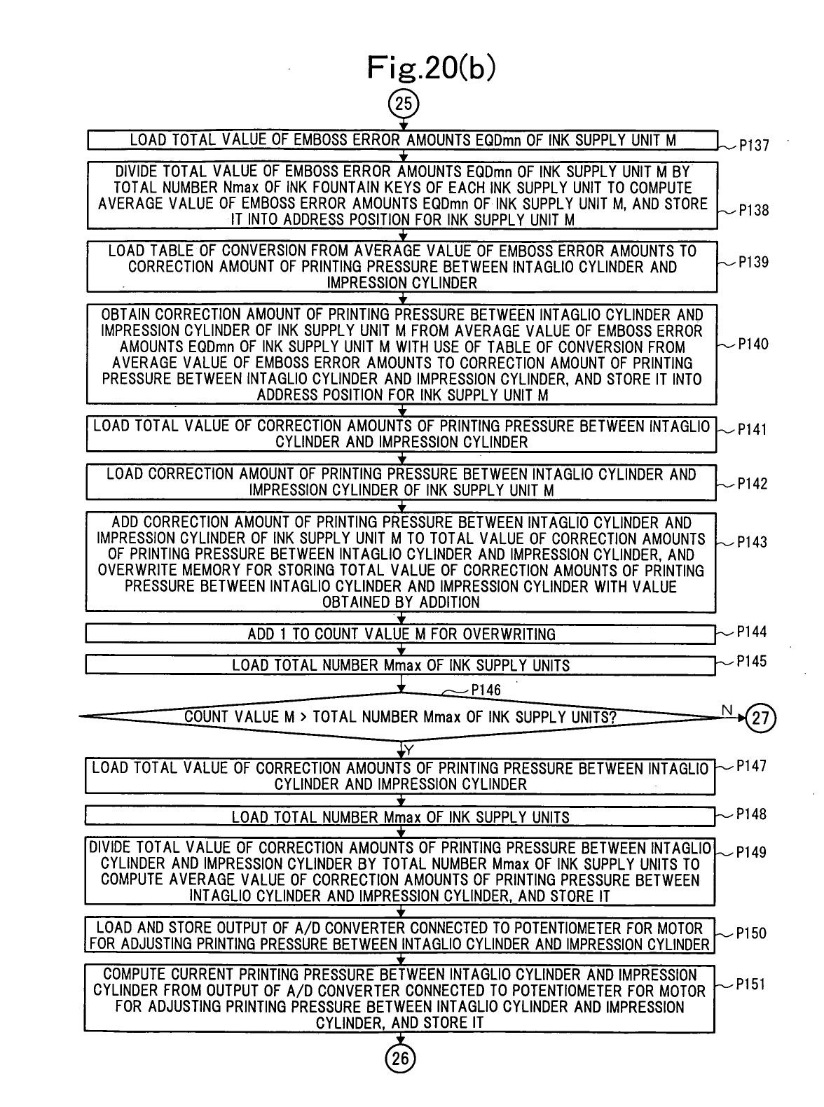

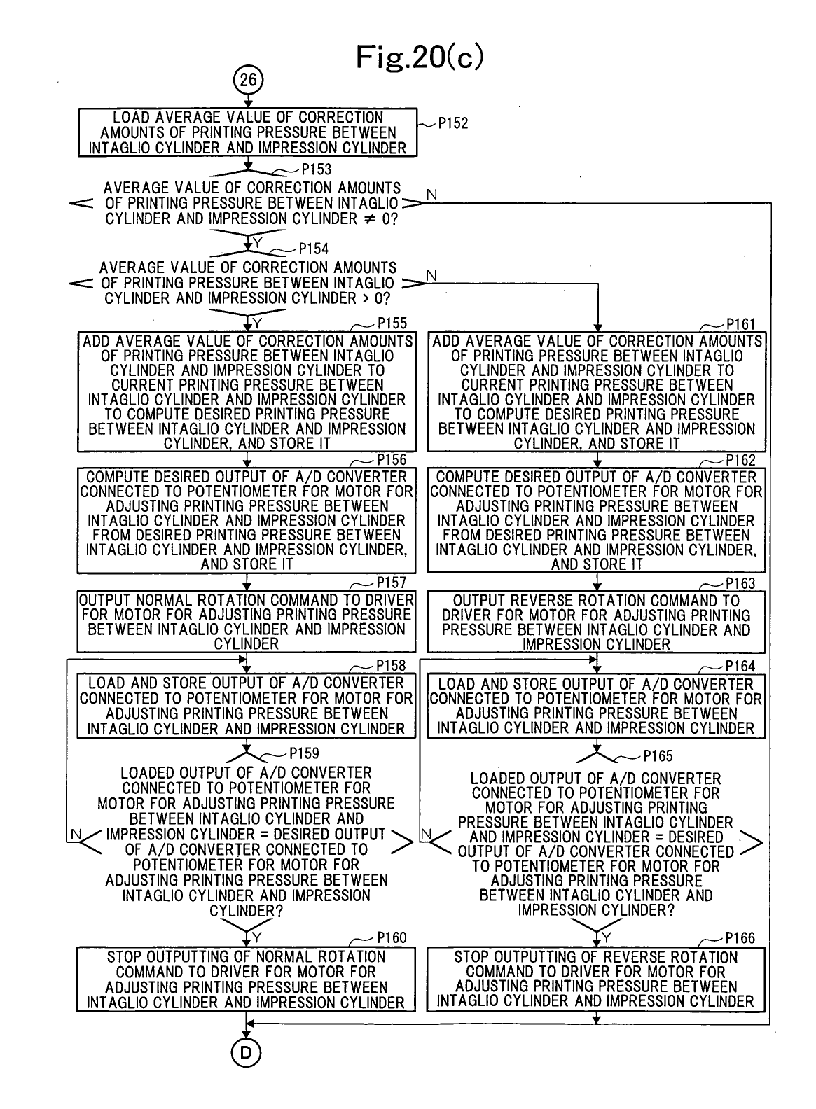

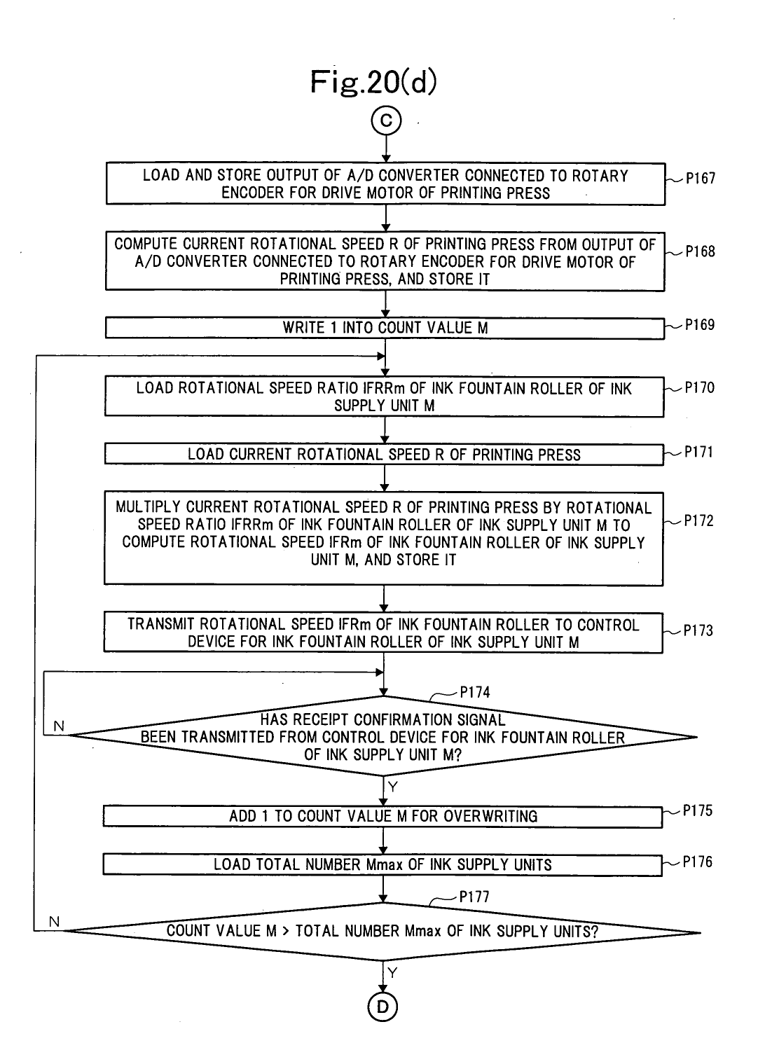

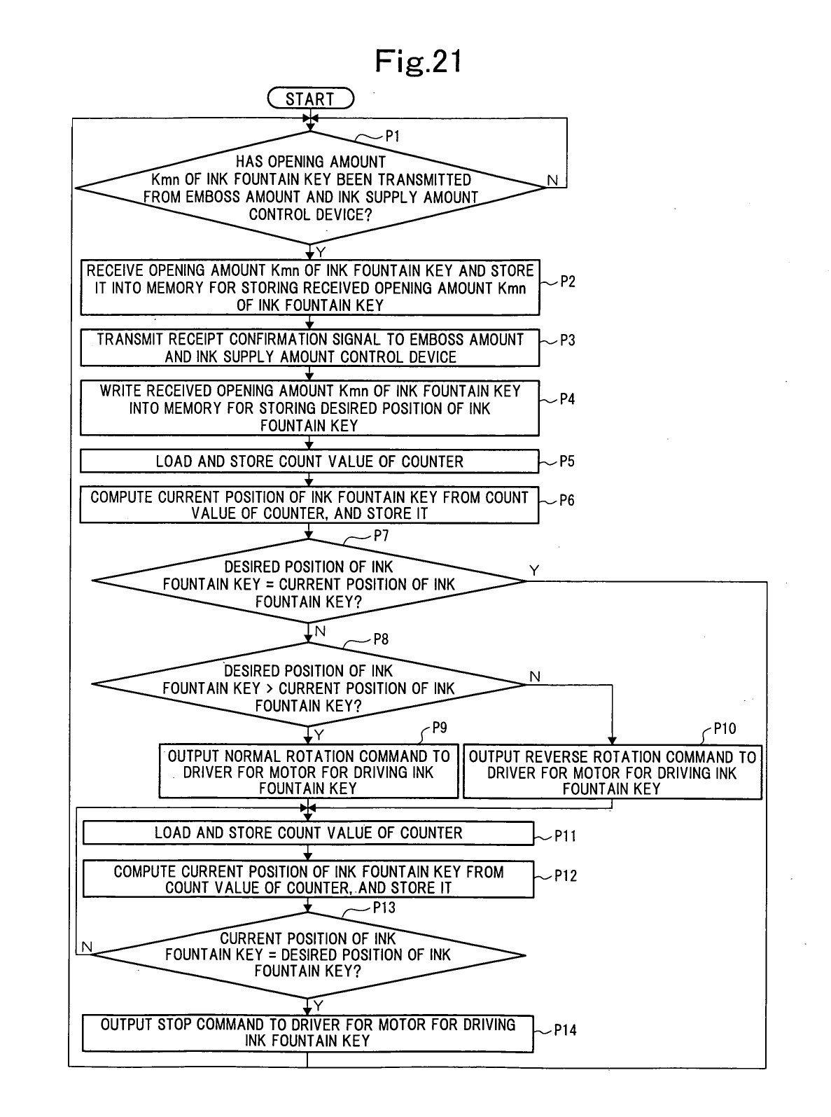

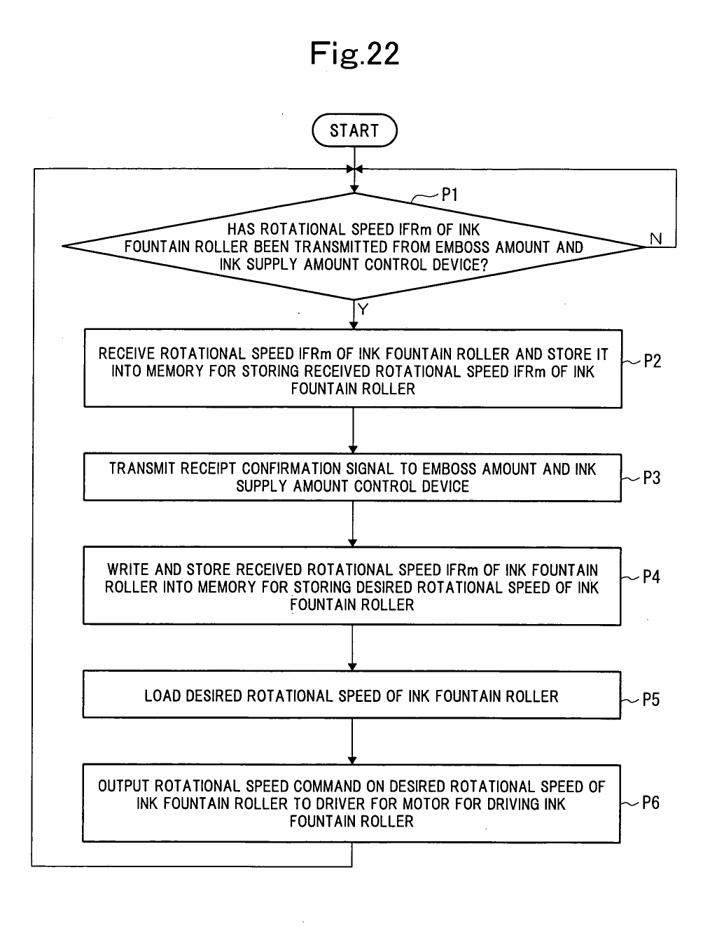

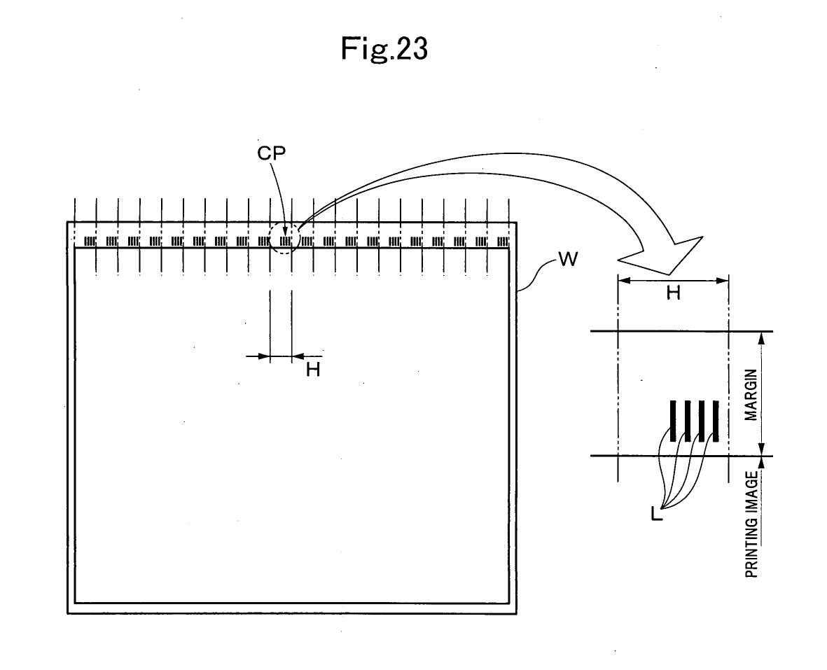

FIGS. 15(a) to 15(c) are control block diagrams of an emboss amount and ink supply amount control device showing Embodiment 2 of the present invention. FIG. 16 is a control block diagram of an ink fountain roller control device. FIG. 17 is a control block diagram of an ink fountain key control device. FIGS. 18(a) to 18(c) are motion flow charts of the emboss amount and ink supply amount control device. FIGS. 19(a) to 19(f) are motion flow charts of the emboss amount and ink supply amount control device. FIGS. 20 (a) to 20(d) are motion flow charts of the emboss amount and ink supply amount control device. FIG. 21 is a motion flow chart of the ink fountain key control device. FIG. 22 is a motion flow chart of the ink fountain roller control device. FIG. 23 is an explanation drawing of a color patch.

This is an embodiment in which the opening amount of the ink fountain key 17d (17d-1 to 17d-n) can be automatically adjusted, instead of the rotational speed of the ink fountain roller 17a in Embodiment 1, by drivingly controlling the motor 128 for driving the ink fountain key (see FIG. 17). Other features excepting those on control to be described later are the same as in Embodiment 1, and duplicate explanations will be omitted by reference to FIGS. 9 to 13.

At the time of measuring the emboss amount or the ink film thickness, the printing image of the sheet W is not directly measured, but instead, it is efficient to measure color patch lines L, corresponding to the number of colors, i.e., India ink, indigo, red, and yellow, at a color patch portion CP provided in a margin part in the circumferential direction of the sheet W, as shown in FIG. 23. A number of the color patch portions CP, corresponding to the number of the ink fountain keys, are provided, with each color patch portion CP being located within the width H of the ink fountain key. By this measure, feedbacks on each color and each ink fountain key become possible. The color patch lines L printed by each ink supply unit are printed at the same position in the circumferential direction so as to be arranged in the sequence of India ink, indigo, red, and yellow within the width of the ink fountain key with the same spacing provided in the lateral direction.

An emboss amount and ink supply amount control device 60 comprises CPU 61, RAM 62, ROM 63, input/output devices 64 to 68, and an interface 69 connected together by a BUS line 70, as shown in FIGS. 15 (a) to 15(c). To the BUS line 70, the following memories are connected: A memory M1 for storing the ink color ICm of an ink supply unit M, a memory M2 for storing an image area rate IRmn in a range corresponding to each ink fountain key, a memory M3 for storing a count value M, a memory M4 for storing a count value N, a memory MS for storing a table of conversion from the image area rate to an ink fountain key opening amount, a memory M6 for storing the opening amount Kmn of each ink fountain key, and a memory M7 for storing the total number Nmax of the ink fountain keys of each ink supply unit.

To the BUS line 70, the following memories are further connected: A memory M8 for storing the reference rotational speed ratio IFRRFm of the ink fountain roller, a memory M9 for storing the rotational speed ratio IFRRm of the ink fountain roller, a memory M11 for storing the value of a counter for measuring the current position in the circumferential direction of the distance measuring instrument, a memory M12 for storing the current position in the circumferential direction of the distance measuring instrument, a memory M13 for storing the position in the circumferential direction of a sheet thickness measuring position to be measured by the distance measuring instrument, a memory M14 for storing the value of a counter for measuring the current position in the lateral direction of the distance measuring instrument, a memory M15 for storing the current position in the lateral direction of the distance measuring instrument, a memory M16 for storing the position in the lateral direction of the sheet thickness measuring position to be measured by the distance measuring instrument, and a memory M17 for storing the output FD of the face side distance measuring instrument.

To the BUS line 70, the following memories are further connected: A memory M18 for storing the output RD of the reverse side distance measuring instrument, a memory M19 for storing the distance FDP from the face side distance measuring instrument to the sheet, a memory M20 for storing the distance RDP from the reverse side distance measuring instrument to the sheet, a memory M21 for storing the distance FRD between the face side distance measuring instrument and the reverse side distance measuring instrument, a memory M22 for storing the sheet thickness PT, a memory M23 for storing the position in the circumferential direction of the color patch line to be measured by the distance measuring instrument, a memory M24 for storing the position in the lateral direction of the color patch line to be measured by the distance measuring instrument, a memory M25 for storing the total number Mmax of the ink supply units, a memory M26 for storing the distance FDCmn from the face side distance measuring instrument to the color patch portion, and a memory M27 for storing the distance RDCmn from the reverse side distance measuring instrument to the color patch portion.

To the BUS line 70, the following memories are further connected: A memory M28 for storing the emboss amount EQmn, a memory M29 for storing a reference emboss amount EQF, a memory M30 for storing an emboss error amount EQDmn, a memory M33 for storing a color patch portion thickness CPTmn, a memory M34 for storing the ink film thickness IFTmn, a memory M35 for storing a reference ink film thickness IFTF, a memory M36 for storing an ink film thickness error amount IFTDmn, a memory M39 for storing the total value of the correction amounts of the printing pressure between the intaglio cylinder and the impression cylinder, a memory M54 for storing a table of conversion from the ink film thickness error amount to the correction ratio of the opening amount of the ink fountain key, a memory M55 for storing the correction ratio of the opening amount of the ink fountain key, a memory M56 for storing the total value of the emboss error amounts EQDmn of each ink supply unit, and a memory M57 for storing the average value of the emboss error amounts EQDmn of each ink supply unit.

To the BUS line 70, the following memories are further connected: A memory M58 for storing a table of conversion from the average value of the emboss error amounts EQDmn to the correction amount of the printing pressure between the intaglio cylinder and the impression cylinder, a memory M59 for storing the correction amount of the printing pressure between the intaglio cylinder and the impression cylinder of each ink supply unit, a memory M40 for storing the average value of the correction amounts of the printing pressure between the intaglio cylinder and the impression cylinder, a memory M41 for storing the output of an A/D converter connected to a potentiometer for a motor for adjusting the printing pressure between the intaglio cylinder and the impression cylinder, a memory M42 for storing the current printing pressure between the intaglio cylinder and the impression cylinder, a memory M43 for storing the desired printing pressure between the intaglio cylinder and the impression cylinder, a memory M44 for storing the desired output of the A/D converter connected to the potentiometer for the motor for adjusting the printing pressure between the intaglio cylinder and the impression cylinder, a memory M45 for storing the output of an A/D converter connected to a rotary encoder for the drive motor of the printing press, a memory M46 for storing the current rotational speed R of the printing press, and a memory M47 for storing the ink fountain roller rotational speed IFRm of each ink supply unit.

To the input/output device 64, the following are connected: An input device 71 such as a keyboard, a display device 72 such as CRT or a display, and an output device 73 such as a printer or a floppy disk (registered trademark) drive. The aforementioned face side distance measuring instrument 74 and reverse side distance measuring instrument 75 are connected to the input/output device 65.

To the input/output device 66, the aforementioned motor 78 for movement in the circumferential direction is connected via a D/A converter 76 and a driver 77 for the motor for movement in the circumferential direction, and a rotary encoder 80 for the motor for movement in the circumferential direction, which is drivingly coupled to the motor 78, is connected via a counter 79 for measuring the current position in the circumferential direction. A detector 81 for a home position in the circumferential direction is also connected to the input/output device 66.

To the input/output device 66, the aforementioned motor 84 for movement in the lateral direction is connected via a D/A converter 82 and a driver 83 for the motor for movement in the lateral direction, and a rotary encoder 86 for the motor for movement in the lateral direction, which is drivingly coupled to the motor 84, is connected via a counter 85 for measuring the current position in the lateral direction. A detector 87 for a home position in the lateral direction is also connected to the input/output device 66.

To the input/output device 67, the aforementioned motor 45 for adjusting the printing pressure between the intaglio cylinder and the impression cylinder is connected via a driver 88 for the motor for adjusting the printing pressure between the intaglio cylinder and the impression cylinder, and a potentiometer 91 for the motor for adjusting the printing pressure between the intaglio cylinder and the impression cylinder, which is drivingly coupled to the motor 45, is connected via an A/D converter 90.

To the input/output device 68, a rotary encoder 94 for the drive motor of the printing press is connected via an A/D converter 92 and an F/V converter 93.

To the interface 69, there are connected a control device 100-1 for the first ink fountain roller to a control device 100-M for the Mth ink fountain roller, and a control device 120-(1-1) for the first ink fountain key of the first ink supply unit to a control device 120-(M-N) for the Nth ink fountain key of the Mth ink supply unit.

The ink fountain roller control devices 100-1 to 100-M comprise CPU 101, RAM 102, ROM 103, and besides, a memory M48 for storing the received rotational speed of the ink fountain roller, a memory M49 for storing the desired rotational speed of the ink fountain roller, an input/output device 104, and an interface 105, which are connected together by a BUS line 106, as shown in FIG. 16, as in FIG. 2.

To the input/output device 104, a motor 108 for driving the ink fountain roller is connected via a driver 107 for the motor for driving the ink fountain roller, and a rotary encoder 111 for the motor for driving the ink fountain roller, which is drivingly connected to the motor 108 for driving the ink fountain roller, is connected via an F/V converter 110 and an A/D converter 109. A detection signal from the rotary encoder 111 for the motor for driving the ink fountain roller is also inputted into the driver 107 for the motor for driving the ink fountain roller. The aforementioned emboss amount and ink supply amount control device 60 is connected to the interface 105.

The ink fountain key control devices 120-(1-1) to 120-(M-N) comprise CPU 121, RAM 122, ROM 123, and besides, a memory M50 for storing the received opening amount of the ink fountain key, a memory M51 for storing the desired opening amount of the ink fountain key, a memory M52 for storing the count value of the counter, a memory M53 for storing the current opening amount of the ink fountain key, an input/output device 124, and an interface 125, which are connected together by a BUS line 126, as shown in FIG. 17, as in FIG. 3.

To the input/output device 124, therefore, a motor 128 for driving the ink fountain key is connected via a driver 127 for the motor for driving the ink fountain key, and a rotary encoder 130 for the motor for driving the ink fountain key, which is drivingly connected to the motor 128 for driving the ink fountain key, is connected via a counter 129. A detection signal from the rotary encoder 130 for the motor for driving the ink fountain key is also inputted into the driver 127 for the motor for driving the ink fountain key. The aforementioned emboss amount and ink supply amount control device 60 is connected to the interface 125.

In the present embodiment, the aforementioned emboss amount and ink supply amount control device 60 (strictly, including the ink fountain roller control devices 100-1 to 100-M and the ink fountain key control devices 120-(1-1) to 120-(M-N)) can automatically adjust (correct) the opening amount of the ink fountain key 17d (17d-1 to 17d-n) and the printing pressure between the intaglio cylinder 14 and the impression cylinder 13 in accordance with the results of measurements by the face side distance measuring instrument 74 and the reverse side distance measuring instrument 75 which measure the emboss amount or the ink film thickness of the printed sheet W.

The control actions or motions of the emboss amount and ink supply amount control device 60 configured as above will be described in detail based on the motion flow charts of FIGS. 18(a) to 18(c), FIGS. 19(a) to 19(f), and FIGS. 20(a) to 20(d).

In Step P1, the memories M1 to M9, M11 to M30, M33 to M36, M39 to M47, and M54 to M59 are initialized. Then, in Step P2, it is determined whether the ink color ICm of the ink supply unit M and the image area rate IRmn in the range corresponding to each ink fountain key have been inputted. If the answer is Y (yes), in Step P3, the ink color ICm of the ink supply unit M and the image area rate IRmn in the range corresponding to each ink fountain key are inputted, and stored into the memories M1 and M2. If the answer is N (no), the program shifts to Step P4.

Then, in Step P4, it is determined whether an ink preset switch is ON. If the answer is Y, in Step P5, 1 is written into the count value M of the memory M3. If the answer is N, the program shifts to Step P31.

Then, in Step P6, 1 is written into the count value N of the memory M4. Then, in Step P7, the ink color ICm of the ink supply unit M is loaded from the memory Ml. Then, in Step P8, the table of conversion from the image area rate to the opening amount of the ink fountain key, corresponding to the ink color ICm, is loaded from the memory M5.

Then, in Step P9, the image area rate IRmn in the range corresponding to the Nth ink fountain key of the ink supply unit M is loaded from the memory M2. Then, in Step P10, the opening amount Kmn of the Nth ink fountain key of the ink supply unit M is obtained from the image area rate IRmn in the range corresponding to the Nth ink fountain key of the ink supply unit M with the use of the table of conversion from the image area rate to the opening amount of the ink fountain key, corresponding to the ink color ICm, and the obtained value is stored into the Nth address position for the ink supply unit M in the memory M6 for storing the opening amount Kmn of each ink fountain key.

Then, in Step P11, 1 is added to the count value N of the memory M4 for overwriting. Then, in Step P12, the total number Nmax of the ink fountain keys of each ink supply unit is loaded from the memory M7. Then, in Step P13, it is determined whether the count value N is larger than the total number Nmax of the ink fountain keys of each ink supply unit.

Then, if the answer is Y in Step P13, Step P14 is executed to add 1 to the count value M of the memory M3 for overwriting. If the answer is N, the program returns to Step P7. Then, in Step P15, the total number Mmax of the ink supply units is loaded from the memory M25. Then, in Step P16, it is determined whether the count value M is larger than the total number Mmax of the ink supply units.

Then, if the answer is Y in Step P16, Step P17 is executed to write 1 into the count value M of the memory M3. If the answer is N, the program returns to Step P6. Then, in Step P18, 1 is written into the count value N of the memory M4. Then, in Step P19, the opening amount Kmn of the Nth ink fountain key of the ink supply unit M is loaded from the memory M6.

Then, in Step P20, the opening amount Kmn of the ink fountain key is transmitted to the control device for the Nth ink fountain key of the ink supply unit M. Then, if, in Step P21, a receipt confirmation signal has been transmitted from the control device for the Nth ink fountain key of the ink supply unit M, Step P22 is executed to add 1 to the count value N of the memory M4 for overwriting.

Then, in Step P23, the total number Nmax of the ink fountain keys of each ink supply unit is loaded from the memory M7. Then, in Step P24, it is determined whether the count value N is greater than the total number Nmax of the ink fountain keys of each ink supply unit. If the answer is Y, in Step P25, the ink color ICm of the ink supply unit M is loaded from the memory Ml. If the answer is N, the program returns to Step P19.

Then, in Step P26, the reference rotational speed ratio IFRRFm of the ink fountain roller corresponding to the ink color ICm is loaded from the memory M8. Then, in Step P27, the reference rotational speed ratio IFRRFm of the ink fountain roller corresponding to the ink color ICm is written into the address for the ink supply unit M in the memory M9 for storing the rotational speed ratio IFRRm of the ink fountain roller.

Then, in Step P28, 1 is added to the count value M of the memory M3 for overwriting. Then, in Step P29, the total number Mmax of the ink supply units is loaded from the memory M25. Then, in Step P30, it is determined whether the count value M is larger than the total number Mmax of the ink supply units. If the answer is Y, the program shifts to Step P31. If the answer is N, the program returns to Step P18.

In accordance with the above steps, presetting of the control means for the ink supply amount of the inking device in conformity with the inputted image area rate is completed.

Then, in Step P31, it is determined whether a selection switch for adjusting the printing pressure between the intaglio cylinder and the impression cylinder is ON. If the answer is Y, it is determined in Step P32 whether a pressure adjustment completion switch is ON. If the answer is N in Step P31, on the other hand, the program shifts to Step P41 to be described later.

Then, if the answer is Y in Step P32, the program shifts to Step P41 to be described later. If the answer is N, it is determined in Step P33 whether an up-button is ON. If the answer is Y in this step, Step P34 is executed to output a normal rotation command to the driver 88 for the motor for adjusting the printing pressure between the intaglio cylinder and the impression cylinder. If the answer is N in Step P33, the program shifts to Step P37 to be described later.

Then, if the up-button is OFF in Step P35, outputting of the normal rotation command to the driver 88 for the motor for adjusting the printing pressure between the intaglio cylinder and the impression cylinder is stopped in Step P36. Then, in Step P37, it is determined whether a down-button is ON.

If the answer is Y in Step P37, Step P38 is executed to output a reverse rotation command to the driver 88 for the motor for adjusting the printing pressure between the intaglio cylinder and the impression cylinder. If the answer is N, the program returns to Step P32. Then, if the down-button is OFF in Step P39, outputting of the reverse rotation command to the driver 88 for the motor for adjusting the printing pressure between the intaglio cylinder and the impression cylinder is stopped in Step P40. Then, the program returns to Step P32.

In accordance with the above-described steps, manual adjustment of the printing pressure by the operator is completed.

Then, in Step P41, it is determined whether a sheet thickness measuring switch is ON. If the answer is Y, in Step P42, a normal rotation command is outputted to the driver 77 for the motor for movement in the circumferential direction. Then, in Step P43, the value of the counter 79 for measuring the current position in the circumferential direction of the distance measuring instrument is loaded, and stored into the memory M11.

Then, in Step P44, the current position in the circumferential direction of the distance measuring instrument is computed from the loaded value of the counter for measuring the current position in the circumferential direction of the distance measuring instrument, and stored into the memory M12. Then, in Step P45, the position in the circumferential direction of the sheet thickness measuring position to be measured by the distance measuring instrument is loaded from the memory M13.

Then, in Step P46, it is determined whether the current position in the circumferential direction of the distance measuring instrument is equal to the position in the circumferential direction of the sheet thickness measuring position to be measured by the distance measuring instrument. If the answer is Y, outputting of the normal rotation command to the driver 77 for the motor for movement in the circumferential direction is stopped in Step P47. If the answer is N, the program returns to Step P43.

Then, in Step P48, a normal rotation command is outputted to the driver 83 for the motor for movement in the lateral direction. Then, in Step P49, the value of the counter 85 for measuring the current position in the lateral direction of the distance measuring instrument is loaded, and stored into the memory M14. Then, in Step P50, the current position in the lateral direction of the distance measuring instrument is computed from the loaded value of the counter for measuring the current position in the lateral direction of the distance measuring instrument, and stored into the memory M15.

Then, in Step P51, the position in the lateral direction of the sheet thickness measuring position to be measured by the distance measuring instrument is loaded from the memory M16. Then, in Step P52, it is determined whether the current position in the lateral direction of the distance measuring instrument is equal to the position in the lateral direction of the sheet thickness measuring position to be measured by the distance measuring instrument. If the answer is Y, in Step P53, a measurement command signal is outputted to the distance measuring instrument. If the answer is N, the program returns to Step P49.

Then, in Step P54, the output FD of the face side distance measuring instrument 74 is loaded, and stored into the memory M17. Then, in Step P55, the output RD of the reverse side distance measuring instrument 75 is loaded, and stored into the memory M18. Then, in Step P56, outputting of the normal rotation command to the driver 83 for the motor for movement in the lateral direction is stopped.

Then, in Step P57, a reverse rotation command is outputted to the driver 83 for the motor for movement in the lateral direction. Then, if the output of the detector 87 for the home position in the lateral direction of the distance measuring instrument is ON in Step P58, outputting of the reverse rotation command to the driver 83 for the motor for movement in the lateral direction is stopped in Step P59.

Then, in Step P60, a reverse rotation command is outputted to the driver 77 for the motor for movement in the circumferential direction. Then, if the output of the detector 81 for the home position in the circumferential direction of the distance measuring instrument is ON in Step P61, outputting of the reverse rotation command to the driver 77 for the motor for movement in the circumferential direction is stopped in Step P62.

Then, in Step P63, the distance FDP from the face side distance measuring instrument to the sheet is computed from the output FD of the face side distance measuring instrument 74, and stored into the memory M19. Then, in Step P64, the distance RDP from the reverse side distance measuring instrument to the sheet is computed from the output RD of the reverse side distance measuring instrument 75, and stored into the memory M20.

Then, in Step P65, the distance FRD between the face side distance measuring instrument and the reverse side distance measuring instrument is loaded from the memory M21. Then, in Step P66, the distance FDP from the face side distance measuring instrument to the sheet and the distance RDP from the reverse side distance measuring instrument to the sheet are subtracted from the distance FRD between the face side distance measuring instrument and the reverse side distance measuring instrument to compute the sheet thickness PT, which is stored into the memory M22. Then, the program shifts to Step P167 to be described later.

In accordance with the above steps, the thickness of the sheet W, which is the object to be measured, is measured. The sheet thickness measuring position is set at a part of the sheet W, where nothing is printed, in other words, a part where neither the emboss nor the ink film is present.

If the answer is N in the aforementioned Step P41, on the other hand, it is determined in Step P67 whether a color patch measuring switch is ON. If the answer is Y, in Step P68, a normal rotation command is outputted to the driver 77 for the motor for movement in the circumferential direction. If the answer is N, the program shifts to Step P167 to be described later.

Then, in Step P69, the value of the counter 79 for measuring the current position in the circumferential direction of the distance measuring instrument is loaded, and stored into the memory M11. Then, in Step P70, the current position in the circumferential direction of the distance measuring instrument is computed from the loaded value of the counter for measuring the current position in the circumferential direction of the distance measuring instrument, and stored into the memory M12. Then, in Step P71, the position in the circumferential direction of the color patch line to be measured by the distance measuring instrument is loaded from the memory M23.

Then, in Step P72, it is determined whether the current position in the circumferential direction of the distance measuring instrument is equal to the position in the circumferential direction of the color patch line to be measured by the distance measuring instrument. If the answer is Y, outputting of the normal rotation command to the driver 77 for the motor for movement in the circumferential direction is stopped in Step P73. If the answer is N, the program returns to Step P69.

Then, in Step P74, 1 is written into the count value N of the memory M4. Then, in Step P75, 1 is written into the count value M of the memory M3. Then, in Step P76, a normal rotation command is outputted to the driver 83 for the motor for movement in the lateral direction. Then, in Step P77, the value of the counter 85 for measuring the current position in the lateral direction of the distance measuring instrument is loaded, and stored into the memory M14.

Then, in Step P78, the current position in the lateral direction of the distance measuring instrument is computed from the loaded value of the counter for measuring the current position in the lateral direction of the distance measuring instrument, and stored into the memory M15. Then, in Step P79, the position in the lateral direction of the color patch line in the ink supply unit M in the range of the Nth ink fountain key to be measured by the distance measuring instrument is loaded from the memory M24.

Then, in Step P80, it is determined whether the current position in the lateral direction of the distance measuring instrument is equal to the position in the lateral direction of the color patch line in the ink supply unit M in the range of the Nth ink fountain key to be measured by the distance measuring instrument. If the answer is Y, in Step P81, a measurement command signal is outputted to the distance measuring instrument. If the answer is N, the program returns to Step P77.

Then, in Step P82, the output FDmn of the face side distance measuring instrument 74 is loaded, and stored into the Nth address position for the ink supply unit M in the memory M17. Then, in Step P83, the output RDmn of the reverse side distance measuring instrument 75 is loaded, and stored into the Nth address position for the ink supply unit M in the memory M18.

Then, in Step P84, 1 is added to the count value M of the memory M3 for overwriting. Then, in Step P85, the total number Mmax of the ink supply units is loaded from the memory M25. Then, in Step P86, it is determined whether the count value M is larger than the total number Mmax of the ink supply units. If the answer is Y, in Step P87, 1 is added to the count value N of the memory M4 for overwriting. If the answer is N, the program returns to Step P77.

Then, in Step P88, the total number Nmax of the ink fountain keys of each ink supply unit is loaded from the memory M7. Then, in Step P89, it is determined whether the count value N is larger than the total number Nmax of the ink fountain keys of each ink supply unit. If the answer is Y, outputting of the normal rotation command to the driver 83 for the motor for movement in the lateral direction is stopped in Step P90. If the answer is N, the program returns to Step P75.

Then, in Step P91, a reverse rotation command is outputted to the driver 83 for the motor for movement in the lateral direction. Then, if the output of the detector 87 for the home position in the lateral direction of the distance measuring instrument is ON in Step P92, outputting of the reverse rotation command to the driver 83 for the motor for movement in the lateral direction is stopped in Step P93.

Then, in Step P94, a reverse rotation command is outputted to the driver 77 for the motor for movement in the circumferential direction. Then, if the output of the detector 81 for the home position in the circumferential direction of the distance measuring instrument is ON in Step P95, outputting of the reverse rotation command to the driver 77 for the motor for movement in the circumferential direction is stopped in Step P96.

In accordance with the above steps, the distances from the face side distance measuring instrument 74 and the reverse side distance measuring instrument 75 to the color patch line L printed with ink supplied from each ink supply unit are measured.

Then, in Step P97, 1 is written into the count value M of the memory M3, where after, in Step P98, 1 is written into the count value N of the memory M4. Then, the output FDmn of the face side distance measuring instrument 74 stored in the Nth address position for the ink supply unit M in the memory M17 is loaded in Step P99. Then, in Step P100, the distance FDCmn from the face side distance measuring instrument to the color patch portion is computed from the output FDmn of the face side distance measuring instrument 74 stored in the Nth address position for the ink supply unit M in the memory M17, and the computed distance is stored into the memory M26.

Then, the output RDmn of the reverse side distance measuring instrument 75 stored in the Nth address position for the ink supply unit M in the memory M18 is loaded in Step P101. Then, in Step P102, the distance RDCmn from the reverse side distance measuring instrument to the color patch portion is computed from the output RDmn of the reverse side distance measuring instrument 75 stored in the Nth address position for the ink supply unit M in the memory M18, and the computed distance is stored into the memory M27.

Then, in Step P103, the distance RDP from the reverse side distance measuring instrument to the sheet is loaded from the memory M20. Then, in Step P104, the distance RDP from the reverse side distance measuring instrument to the sheet is subtracted from the distance RDCmn from the reverse side distance measuring instrument to the color patch portion to compute the emboss amount EQmn, which is stored into the Nth address position for the ink supply unit M in the memory M28.

Then, in Step P105, the reference emboss amount EQFm of the ink supply unit M is loaded from the address position for the ink supply unit M in the memory M29 for storing the reference emboss amount EQF. Then, in Step P106, the reference emboss amount EQFm of the ink supply unit M is subtracted from the Nth emboss amount EQmn of the ink supply unit M to compute the emboss error amount EQDmn of the color patch line corresponding to the Nth ink fountain key of the ink supply unit M, and the computed value is stored into the Nth address position for the ink supply unit M in the memory M30.

Then, in Step P107, the distance FRD between the face side distance measuring instrument and the reverse side distance measuring instrument is loaded from the memory M21. Then, in Step P108, the distance FDCmn from the face side distance measuring instrument to the color patch portion and the distance RDCmn from the reverse side distance measuring instrument to the color patch portion are subtracted from the distance FRD between the face side distance measuring instrument and the reverse side distance measuring instrument to compute the thickness CPTmn of the color patch portion, which is stored into the memory M33.

Then, in Step P109, the sheet thickness PT is loaded from the memory M22. Then, in Step P110, the sheet thickness PT is subtracted from the thickness CPTmn of the color patch portion to compute the ink film thickness IFTmn, which is stored into the Nth address position for the ink supply unit M in the memory M34.

Then, in Step P111, the reference ink film thickness IFTFm of the ink supply unit M is loaded from the address position for the ink supply unit M in the memory M35 for storing the reference ink film thickness IFTF. Then, in Step P112, the reference ink film thickness IFTFm of the ink supply unit M is subtracted from the Nth ink film thickness IFTmn of the ink supply unit M to compute the ink film thickness error amount IFTDmn of the color patch line corresponding to the Nth ink fountain key of the ink supply unit M, and the computed value is stored into the Nth address position for the ink supply unit M in the memory M36.

Then, in Step P113, the ink color ICm of the ink supply unit M is loaded from the memory Ml. Then, in Step P114, the table of conversion from the ink film thickness error amount to the correction ratio of the opening amount of the ink fountain key, corresponding to the ink color ICm, is loaded from the memory M54.

Then, in Step P115, the correction ratio of the opening amount of the ink fountain key is obtained from the ink film thickness error amount IFTDmn with the use of the table of conversion from the ink film thickness error amount to the correction ratio of the opening amount of the ink fountain key, corresponding to the ink color ICm, and the obtained value is stored into the Nth address position for the ink supply unit M in the memory M55. Then, in Step P116, 1 is added to the count value N of the memory M4 for overwriting.

Then, in Step P117, the total number Nmax of the ink fountain keys of each ink supply unit is loaded from the memory M7. Then, in Step P118, it is determined whether the count value N is larger than the total number Nmax of the ink fountain keys of each ink supply unit. If the answer is Y, in Step P119, 1 is added to the count value M of the memory M3 for overwriting. If the answer is N, on the other hand, the program returns to Step P99.

Then, in Step P120, the total number Mmax of the ink supply units is loaded from the memory M25. Then, in Step P121, it is determined whether the count value M is larger than the total number Mmax of the ink supply units. If the answer is Y, in Step P122, 1 is written into the count value M of the memory M3. If the answer is N, the program returns to Step P98.

In accordance with the above steps, the emboss error amount of each color patch line L which has been measured is obtained, and the correction ratio of the opening amount of each ink fountain key of each inking device is obtained from the ink film thickness of each color patch line L which has been measured.

Then, in Step P123, zero is written into the memory M56 for storing the total value of the emboss error amounts EQDmn of each ink supply unit. Then, in Step P124, zero is written into the memory M39 for storing the total value of the correction amounts of the printing pressure between the intaglio cylinder and the impression cylinder. Then, in Step P125, 1 is written into the count value N of the memory M4.

Then, in Step P126, the total value of the emboss error amounts EQDmn of the ink supply unit M is loaded from the memory M56. Then, in Step P127, the emboss error amount EQDmn of the color patch line corresponding to the Nth ink fountain key of the ink supply unit M is loaded from the Nth address position for the ink supply unit M in the memory M30 for storing the emboss error amount EQDmn.

Then, in Step P128, the emboss error amount EQDmn of the color patch line corresponding to the Nth ink fountain key of the ink supply unit M is added to the total value of the emboss error amounts EQDmn of the ink supply unit M, and the address position for the ink supply unit M in the memory M56 for storing the total value of the emboss error amounts EQDmn of each ink supply unit M is overwritten with a value obtained by addition. Then, in Step P129, the opening amount Kmn of the Nth ink fountain key of the ink supply unit M is loaded from the memory M6.

Then, in Step P130, the correction ratio of the opening amount of the Nth ink fountain key of the ink supply unit M is loaded from the memory M55. Then, in Step P131, the opening amount Kmn of the Nth ink fountain key of the ink supply unit M is multiplied by the correction ratio of the opening amount of the Nth ink fountain key of the ink supply unit M, and the resulting product is stored into the Nth address position for the ink supply unit M in the memory M6 for storing the opening amount Kmn of the ink fountain key.

Then, in Step P132, the opening amount Kmn of the ink fountain key is transmitted to the control device 120-(M-N) for the opening amount of the Nth ink fountain key of the ink supply unit M. Then, if a receipt confirmation signal is transmitted in Step P133 from the control device 120-(M-N) for the opening amount of the Nth ink fountain key of the ink supply unit M, Step P134 is executed to add 1 to the count value N of the memory M4 for overwriting.

Then, in Step P135, the total number Nmax of the ink fountain keys of each ink supply unit is loaded from the memory M7. Then, in Step P136, it is determined whether the count value N is larger than the total number Nmax of the ink fountain keys of each ink supply unit. If the answer is Y, in Step P137, the total value of the emboss error amounts EQDmn of the ink supply unit M is loaded from the memory M56. If the answer is N, on the other hand, the program returns to Step P126.

Then, in Step P138, the total value of the emboss error amounts EQDmn of the ink supply unit M is divided by the total number Nmax of the ink fountain keys of each ink supply unit to compute the average value of the emboss error amounts EQDmn of the ink supply unit M, and the resulting quotient is stored into the address position for the ink supply unit M in the memory M57. Then, in Step P139, the table of conversion from the average value of the emboss error amounts to the correction amount of the printing pressure between the intaglio cylinder and the impression cylinder is loaded from the memory M58.

Then, in Step P140, the correction amount of the printing pressure between the intaglio cylinder and the impression cylinder in the ink supply unit M is obtained from the average value of the emboss error amounts EQDmn of the ink supply unit M with the use of the table of conversion from the average value of the emboss error amounts to the correction amount of the printing pressure between the intaglio cylinder and the impression cylinder, and is stored into the address position for the ink supply unit M in the memory M59. Then, in Step P141, the total value of the correction amounts of the printing pressure between the intaglio cylinder and the impression cylinder is loaded from the memory M39.

Then, in Step P142, the correction amount of the printing pressure between the intaglio cylinder and the impression cylinder in the ink supply unit M is loaded from the memory M59. Then, in Step P143, the correction amount of the printing pressure between the intaglio cylinder and the impression cylinder in the ink supply unit M is added to the total value of the correction amounts of the printing pressure between the intaglio cylinder and the impression cylinder, and the memory M39 for storing the total value of the correction amounts of the printing pressure between the intaglio cylinder and the impression cylinder is overwritten with the obtained value.

Then, in Step P144, 1 is added to the count value M of the memory M3 for overwriting. Then, in Step P145, the total number Mmax of the ink supply units is loaded from the memory M25. Then, in Step P146, it is determined whether the count value M is larger than the total number Mmax of the ink supply units. If the answer is Y, in Step P147, the total value of the correction amounts of the printing pressure between the intaglio cylinder and the impression cylinder is loaded from the memory M39. If the answer is N, the program returns to Step P125.

Then, in Step P148, the total number Mmax of the ink supply units is loaded from the memory M25. Then, in Step P149, the total value of the correction amounts of the printing pressure between the intaglio cylinder and the impression cylinder is divided by the total number Mmax of the ink supply units to compute the average value of the correction amounts of the printing pressure between the intaglio cylinder and the impression cylinder, and the obtained value is stored into the memory M40.

In the above steps, the opening amount of each ink fountain key of each inking device is corrected in accordance with the ink film thickness of each color patch line L measured, and the average value of the correction amounts of the printing pressure between the intaglio cylinder and the impression cylinder is obtained from the emboss amount of each color patch line measured.

Then, in Step P150, the output of the A/D converter connected to the potentiometer 91 for the motor for adjusting the printing pressure between the intaglio cylinder and the impression cylinder is loaded, and stored into the memory M41. Then, in Step P151, the current printing pressure between the intaglio cylinder and the impression cylinder is computed from the output of the A/D converter 90 connected to the potentiometer 91 for the motor for adjusting the printing pressure between the intaglio cylinder and the impression cylinder, and the computed value is stored into the memory M42. Then, in Step P152, the average value of the correction amounts of the printing pressure between the intaglio cylinder and the impression cylinder is loaded from the memory M40.

Then, in Step P153, it is determined whether the average value of the correction amounts of the printing pressure between the intaglio cylinder and the impression cylinder is unequal to zero. If the answer is Y, in Step P154, it is determined whether the average value of the correction amounts of the printing pressure between the intaglio cylinder and the impression cylinder is larger than zero. If the answer is N in Step P153, the program returns to Step P2.

If the answer is Y in the above Step P154, Step P155 is executed to add the average value of the correction amounts of the printing pressure between the intaglio cylinder and the impression cylinder to the current printing pressure between the intaglio cylinder and the impression cylinder to compute the desired printing pressure between the intaglio cylinder and the impression cylinder, and store the desired printing pressure into the memory M43. Then, in Step P156, the desired output of the A/D converter connected to the potentiometer for the motor for adjusting the printing pressure between the intaglio cylinder and the impression cylinder is computed from the desired printing pressure between the intaglio cylinder and the impression cylinder, and stored into the memory M44.

Then, in Step P157, a normal rotation command is outputted to the driver 88 for the motor for adjusting the printing pressure between the intaglio cylinder and the impression cylinder. Then, in Step P158, the output of the A/D converter 90 connected to the potentiometer 91 for the motor for adjusting the printing pressure between the intaglio cylinder and the impression cylinder is loaded, and stored into the memory M41.

Then, in Step P159, it is determined whether the loaded output of the A/D converter connected to the potentiometer for the motor for adjusting the printing pressure between the intaglio cylinder and the impression cylinder is equal to the desired output of the A/D converter connected to the potentiometer for the motor for adjusting the printing pressure between the intaglio cylinder and the impression cylinder. If the answer is Y, the outputting of the normal rotation command to the driver 88 for the motor for adjusting the printing pressure between the intaglio cylinder and the impression cylinder is stopped in Step P160. Then, the program returns to Step P2. If the answer is N, the program returns to Step P158.

If the answer is N in the aforementioned Step P154, on the other hand, Step P161 is executed to add the average value of the correction amounts of the printing pressure between the intaglio cylinder and the impression cylinder to the current printing pressure between the intaglio cylinder and the impression cylinder to compute the desired printing pressure between the intaglio cylinder and the impression cylinder, and store the desired printing pressure into the memory M43. Then, in Step P162, the desired output of the A/D converter connected to the potentiometer for the motor for adjusting the printing pressure between the intaglio cylinder and the impression cylinder is computed from the desired printing pressure between the intaglio cylinder and the impression cylinder, and stored into the memory M44.

Then, in Step P163, a reverse rotation command is outputted to the driver 88 for the motor for adjusting the printing pressure between the intaglio cylinder and the impression cylinder. Then, in Step P164, the output of the A/D converter 90 connected to the potentiometer 91 for the motor for adjusting the printing pressure between the intaglio cylinder and the impression cylinder is loaded, and stored into the memory M41.

Then, in Step P165, it is determined whether the loaded output of the A/D converter connected to the potentiometer for the motor for adjusting the printing pressure between the intaglio cylinder and the impression cylinder is equal to the desired output of the A/D converter connected to the potentiometer for the motor for adjusting the printing pressure between the intaglio cylinder and the impression cylinder. If the answer is Y, the outputting of the reverse rotation command to the driver 88 for the motor for adjusting the printing pressure between the intaglio cylinder and the impression cylinder is stopped in Step P166. Then, the program returns to Step P2. If the answer is N, the program returns to Step P164.

In accordance with the above steps, the printing pressure is corrected in conformity with the obtained average value of the correction amounts of the printing pressure between the intaglio cylinder and the impression cylinder.

In Step P167 shifted from the aforementioned Step P66 or Step P67, the output of the A/D converter 92 connected to the rotary encoder 94 for the drive motor of the printing press is loaded, and stored into the memory M45. Then, in Step P168, the current rotational speed R of the printing press is computed from the A/D converter connected to the rotary encoder for the drive motor of the printing press, and the computed value is stored into the memory M46.

Then, in Step P169, 1 is written into the count value M of the memory M3. Then, in Step P170, the rotational speed ratio IFRRm of the ink fountain roller of the ink supply unit M is loaded from the memory M9. Then, in Step P171, the current rotational speed R of the printing press is loaded from the memory M46.

Then, in Step P172, the current rotational speed R of the printing press is multiplied by the rotational speed ratio IFRRm of the ink fountain roller of the ink supply unit M to compute the rotational speed IFRm of the ink fountain roller of the ink supply unit M, and the computed value is stored into the memory M47. Then, in Step P173, the rotational speed IFRm of the ink fountain roller is transmitted to the control device for the ink fountain roller of the ink supply unit.

Then, upon transmission of a receipt confirmation signal from the control device for the ink fountain roller of the ink supply unit M in Step P174, 1 is added to the count value M of the memory M3 in Step P175 for overwriting.

Then, in Step P176, the total number Mmax of the ink supply units is loaded from the memory M25. Then, in Step P177, it is determined whether the count value M is greater than the total number Mmax of the ink supply units. If the answer is Y, the program returns to Step P2. If the answer is N, the program returns to Step P170. Then, this procedure is repeated.

The control device 120-(1-1) for the first ink fountain key of the first ink supply unit to the control device 120-(M-N) for the Nth ink fountain key of the Mth ink supply unit act in accordance with the motion or action flow shown in FIG. 21, similar to FIG. 7.

If, in Step P1, the opening amount Kmn of the ink fountain key is transmitted from the emboss amount and ink supply amount control device 60, Step P2 is executed to receive the opening amount Kmn of the ink fountain key and store the received opening amount Kmn of the ink fountain key into the memory M50 for storing the received opening amount Kmn of the ink fountain key. Then, in Step P3, a receipt confirmation signal is transmitted to the emboss amount and ink supply amount control device 60.

Then, in Step P4, the received opening amount Kmn of the ink fountain key is written into the memory M51 for storing the desired opening amount (position) of the ink fountain key. Then, in Step P5, the count value of the counter 129 is loaded and stored into the memory M52. Then, in Step P6, the current opening amount (position) of the ink fountain key is computed from the count value of the counter 129, and stored into the memory M53.

Then, in Step P7, it is determined whether the desired position of the ink fountain key is equal to the current position of the ink fountain key. If the answer is Y, the program returns to Step P1. If the answer is N, it is determined in Step P8 whether the desired position of the ink fountain key is greater than the current position of the ink fountain key.

If the answer is Y in Step P8, Step P9 is executed to output a normal rotation command to the driver 127 for the motor for driving the ink fountain key. If the answer is N in Step P8, Step P10 is executed to output a reverse rotation command to the driver 127 for the motor for driving the ink fountain key.

Then, in Step P11, the count value of the counter 129 is loaded, and stored into the memory M52. Then, in Step P12, the current position of the ink fountain key is computed from the count value of the counter 129, and stored into the memory M53.

Then, in Step P13, it is determined whether the current position of the ink fountain key is equal to the desired position of the ink fountain key. If the answer is Y, in Step P14, a stop command is outputted to the driver 127 for the motor for driving the ink fountain key. Then, the program returns to Step P1. If the answer is N, the program returns to Step P11. Then, this procedure is repeated.

The control device 100-1 for the first ink fountain roller to the control device 100-M for the Mth ink fountain roller act in accordance with the motion flow shown in FIG. 22, similar to FIG. 8.

If, in Step P1, the rotational speed IFRm of the ink fountain roller is transmitted from the emboss amount and ink supply amount control device 60, Step P2 is executed to receive the rotational speed IFRm of the ink fountain roller and store the received rotational speed IFRm of the ink fountain roller into the memory M48 for storing the received rotational speed IFRm of the ink fountain roller. Then, in Step P3, a receipt confirmation signal is transmitted to the emboss amount and ink supply amount control device 60.

Then, in Step P4, the received rotational speed IFRm of the ink fountain roller is written and stored into the memory M49 for storing the desired rotational speed of the ink fountain roller. Then, in Step P5, the desired rotational speed of the ink fountain roller is loaded from the memory M49.

Then, in Step P6, a rotational speed command on the desired rotational speed of the ink fountain roller is outputted to the driver 107 for the motor for driving the ink fountain roller. Then, the program returns to Step P1. Afterwards, this procedure is repeated.

According to the present embodiment described above, in the Orloff (type) intaglio printing press, the ink film thickness and emboss amount of the printed sheet W are measured using the face side distance measuring instrument 74 and the reverse side distance measuring instrument 75. In accordance with the measured emboss amount, the aforementioned motor 45 is drivingly controlled to adjust the printing pressure between the intaglio cylinder 14 and the impression cylinder 13 automatically. Similarly, in accordance with the measured ink film thickness, the aforementioned motor 128 is drivingly controlled, whereby the opening amount (i.e., ink supply amount) of the ink fountain key 17d (17d-1 to 17d-n) in each ink supply unit is automatically adjusted.

Thus, printing troubles due to misadjustment of the ink supply amount or the printing pressure owing to the operator's manual operation can be avoided. Consequently, burden on the operator can be lessened, and the emboss amount and the ink film thickness can be controlled with high accuracy to decrease defective printing products (wasted sheets).

In the present embodiment, it is acceptable to measure only the ink film thickness of the printed sheet W, and automatically adjust only the opening amount (i.e., ink supply amount) of the ink fountain key 17d (17d-1 to 17d-n) in accordance with the measured ink film thickness.

### Embodiment 3

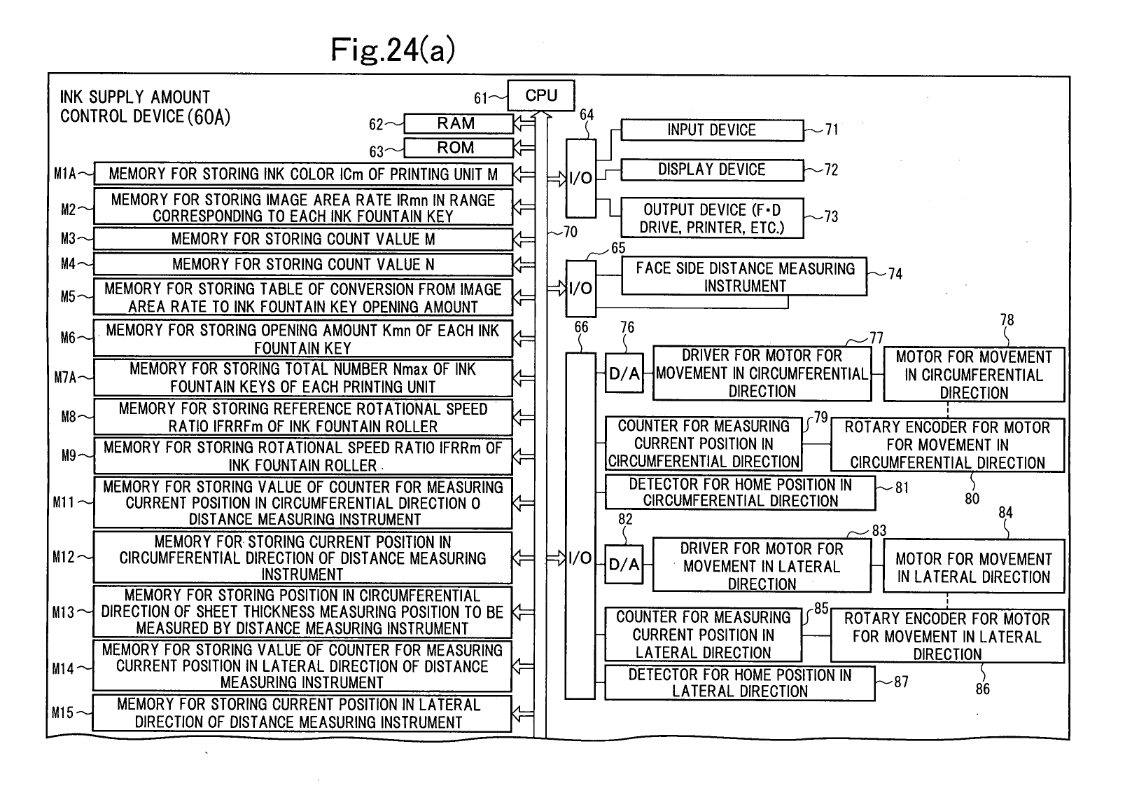

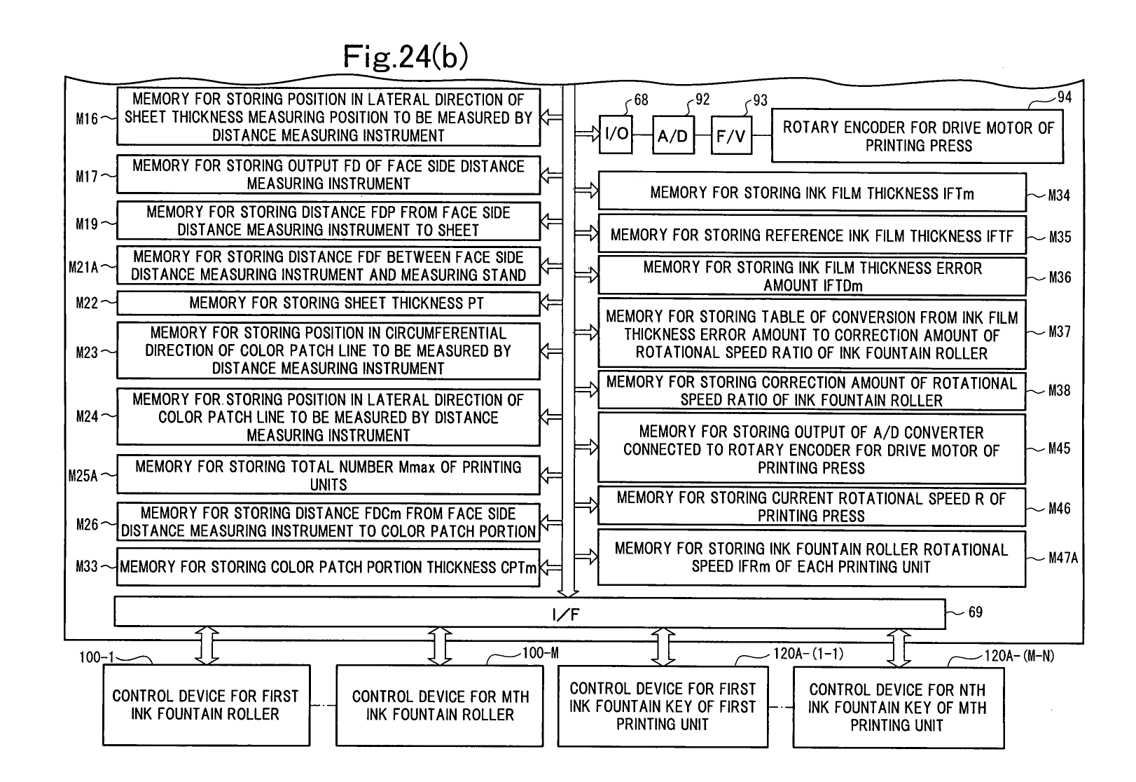

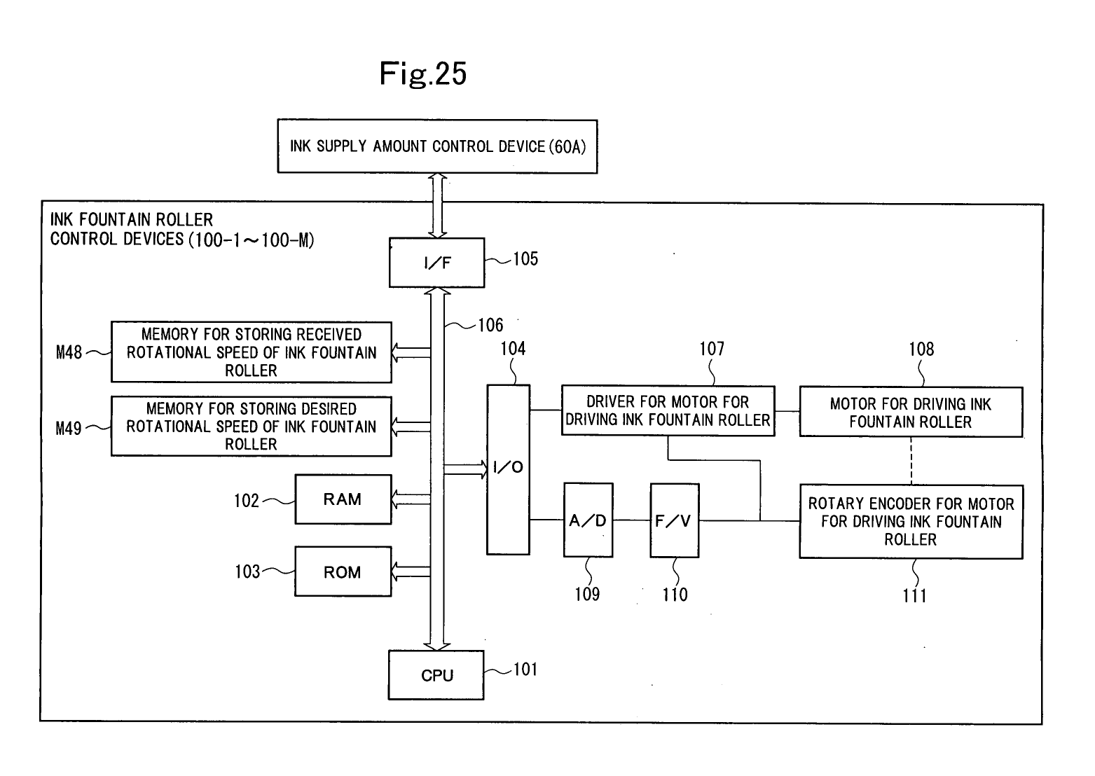

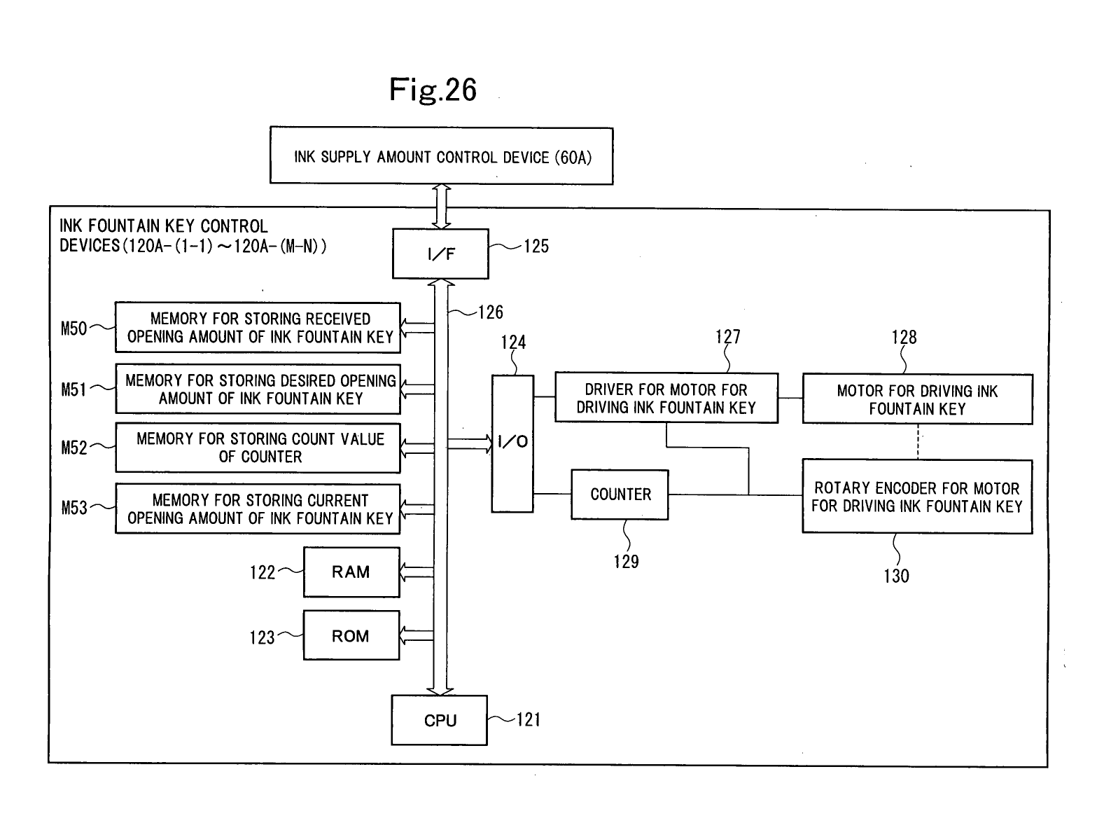

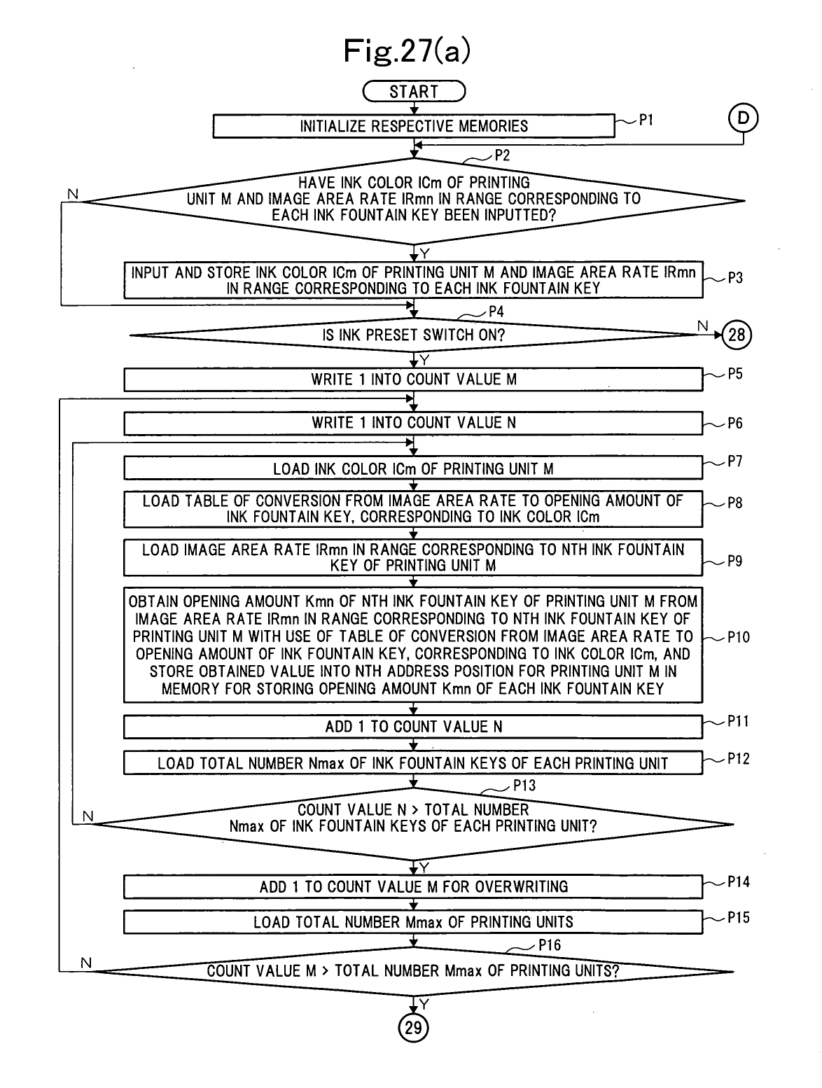

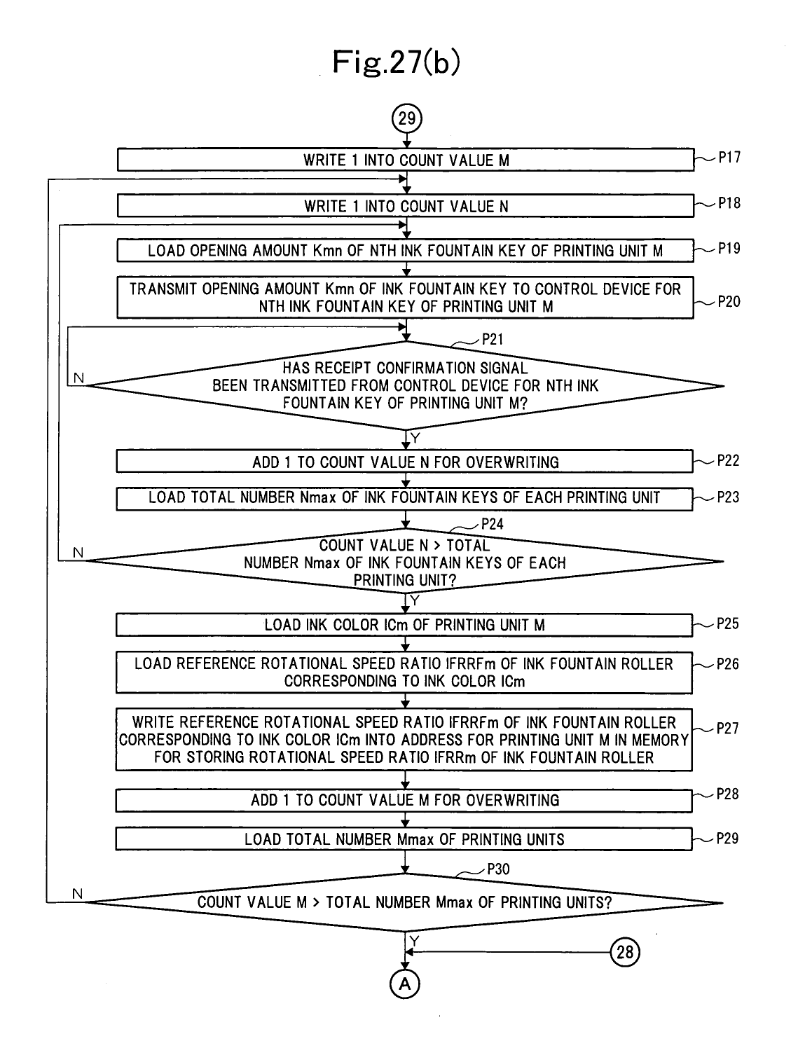

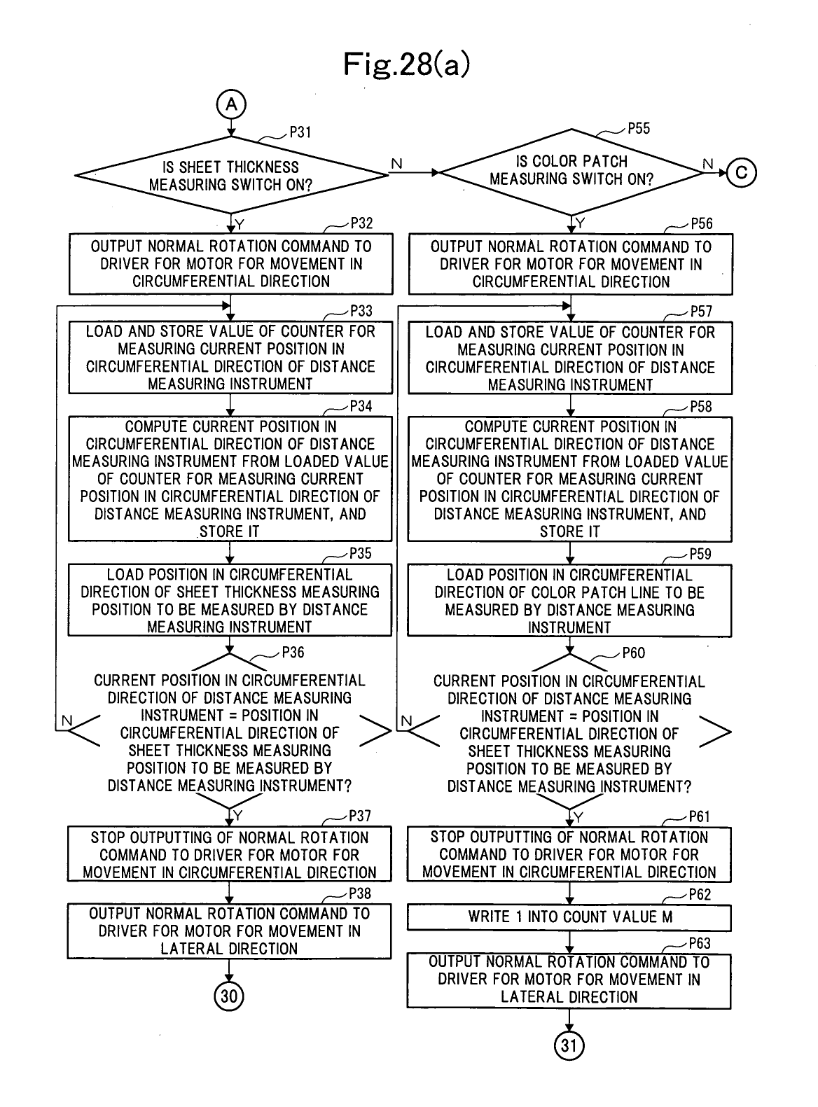

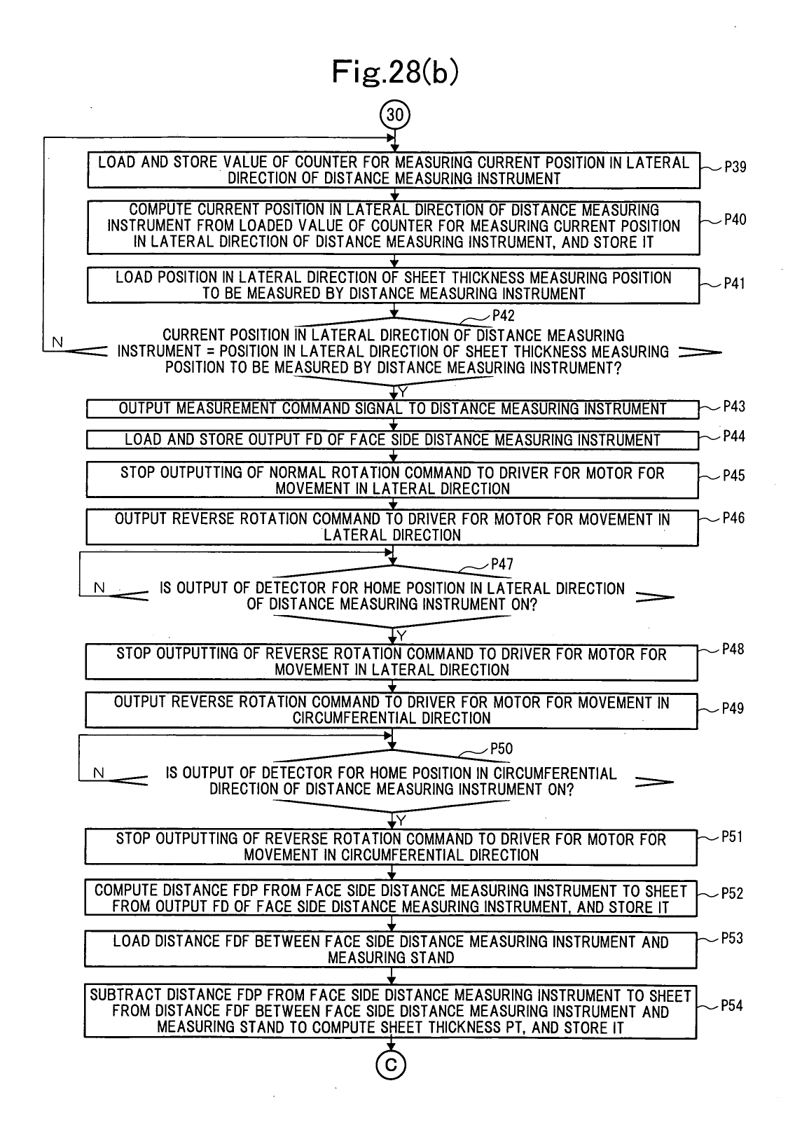

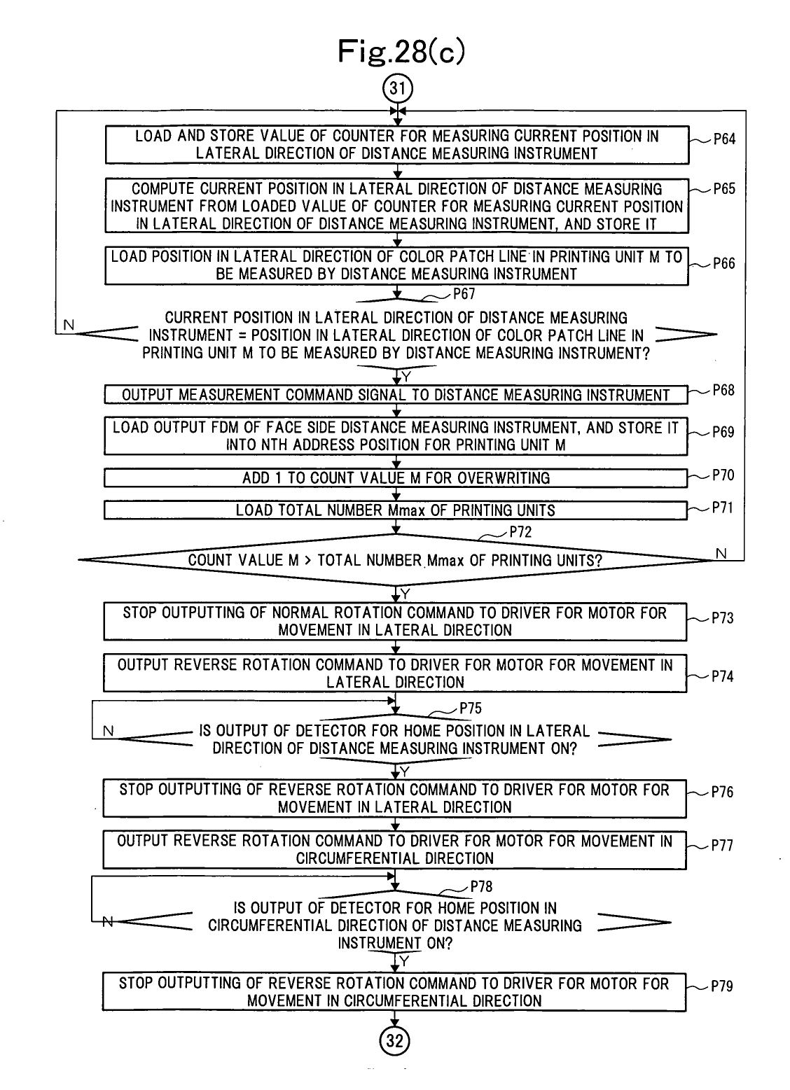

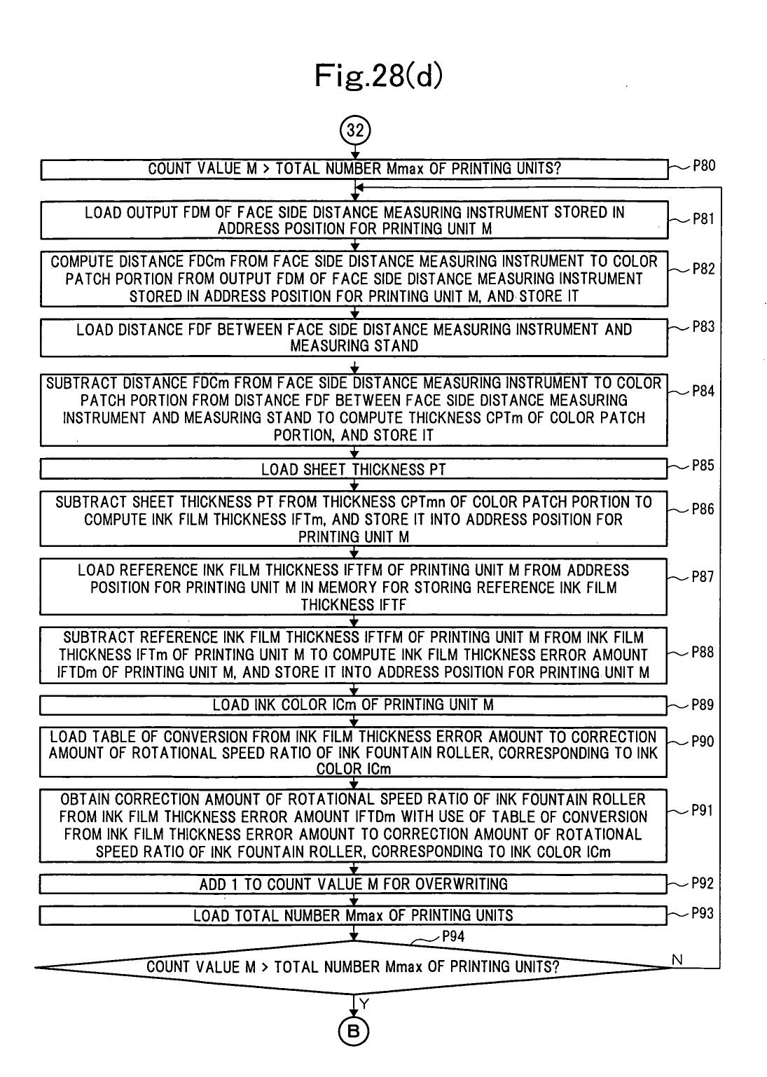

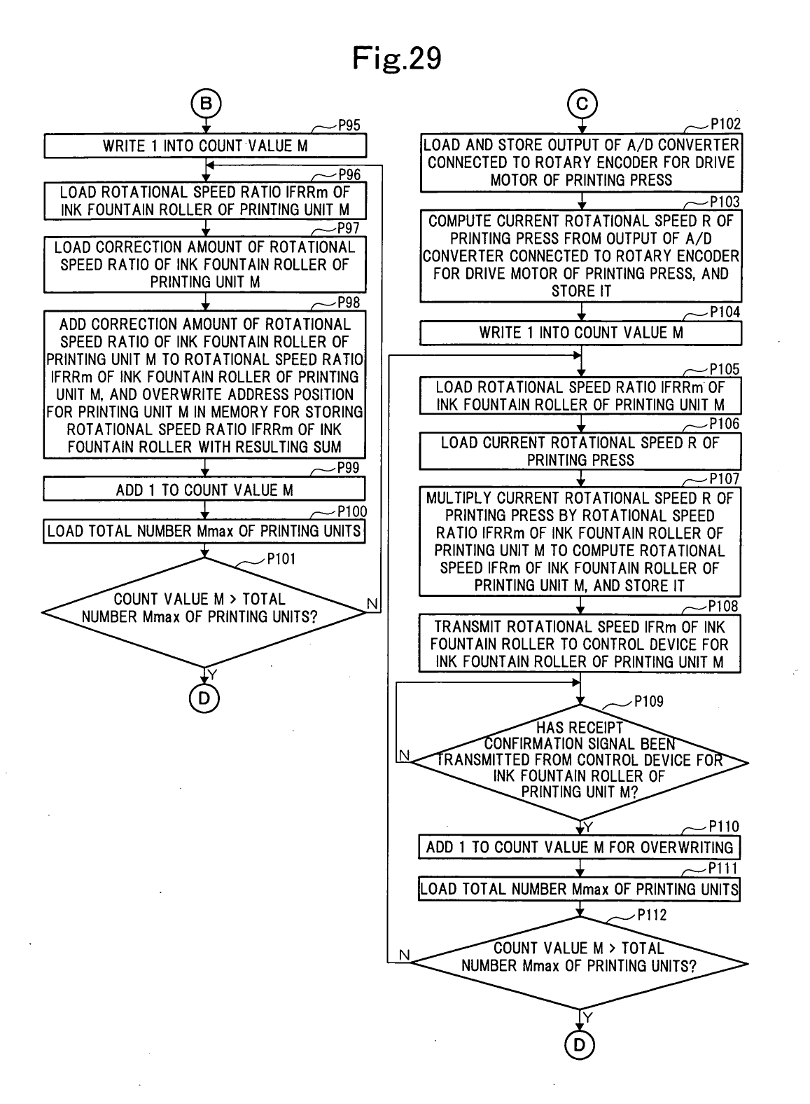

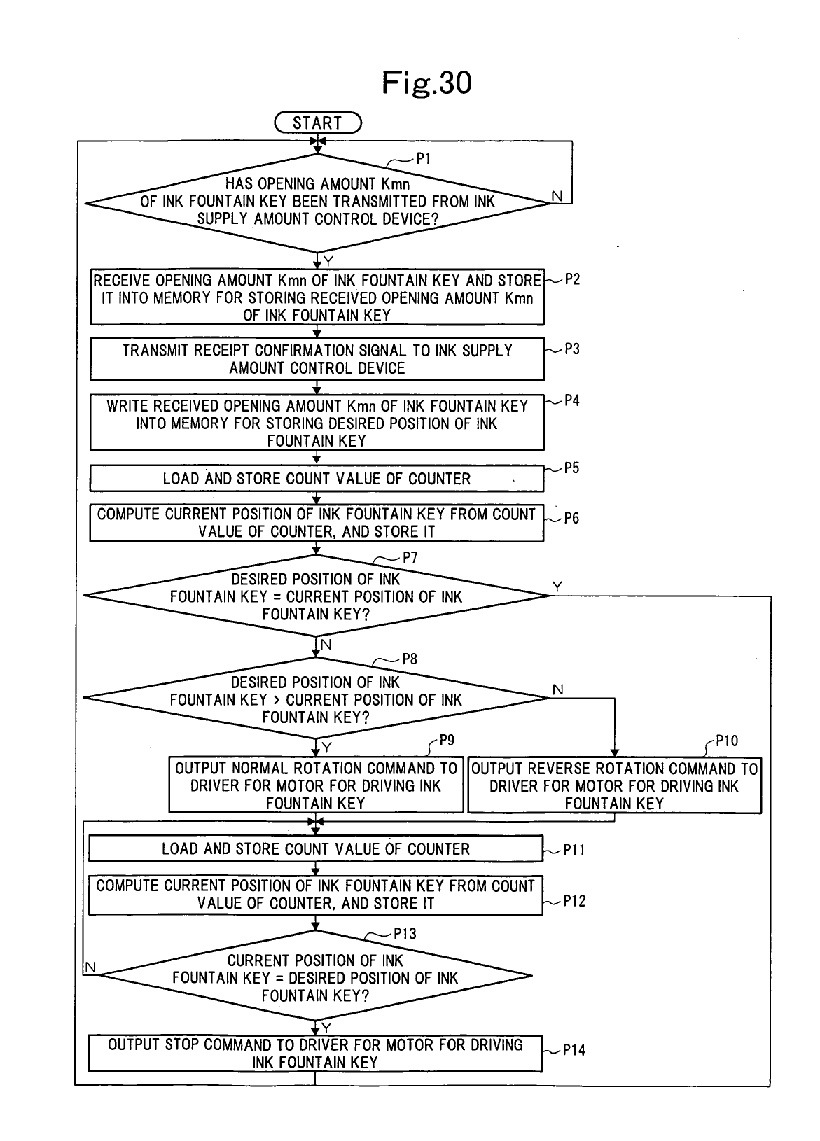

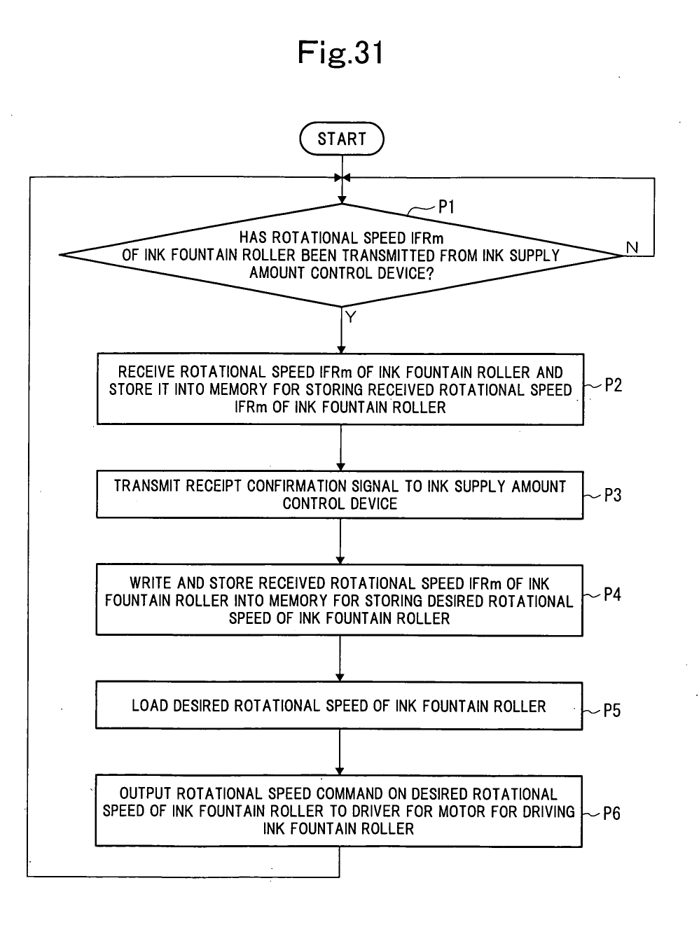

FIGS. 24(a) and 24(b) are control block diagrams of an ink supply amount control device showing Embodiment 3 of the present invention. FIG. 25 is a control block diagram of an ink fountain roller control device. FIG. 26 is a control block diagram of an ink fountain key control device. FIGS. 27(a) and 27(b) are motion flow charts of the ink supply amount control device. FIGS. 28 (a) to 28(d) are motion flow charts of the ink supply amount control device. FIG. 29 is a motion flow chart of the ink supply amount control device. FIG. 30 is a motion flow chart of the ink fountain key control device. FIG. 31 is a motion flow chart of the ink fountain roller control device. FIG. 26 is a schematic configurational drawing of a relief printing press.

This is an embodiment in which the present invention is applied to a relief printing press instead of the Orloff (type) intaglio printing press in Embodiment 1.

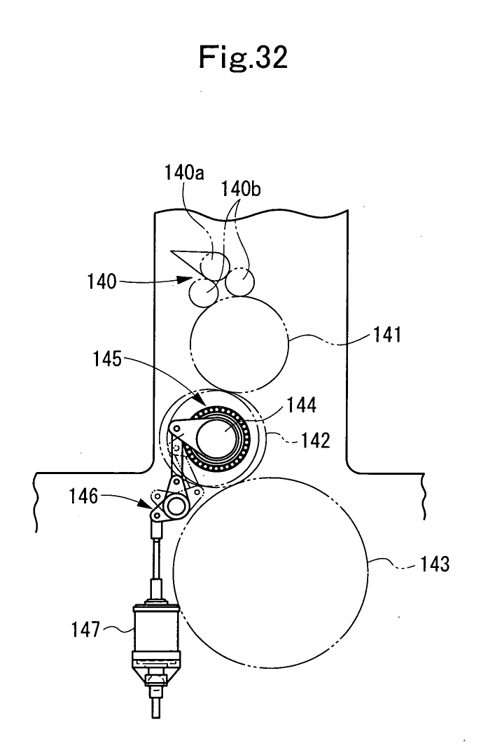

In a relief printing press, as shown in FIG. 32, a sheet fed, for example, from a feeding device outside the drawing is passed on to a gripper of an impression cylinder 143, and gripped by the gripper for transport. Simultaneously, ink from an inking device 140 is transferred and supplied onto the plate surface of a plate cylinder (relief printing cylinder) 141. From there, the ink is transferred to the sheet on the impression cylinder 143 via a blanket cylinder 142. Reference numeral 140a in the drawing refers to an ink fountain roller, and reference numeral 140b refers to an ink form roller.

In the present embodiment, as in the case of Embodiment 1, the ink fountain roller 140a is driven by a motor (ink supply amount adjusting means) 108 (see FIG. 25) for driving the ink fountain roller separately from a drive motor of the printing press, and an ink fountain key (not shown) is driven by a motor (ink supply amount adjusting means) 128 (see FIG. 26) for driving the ink fountain key. The amount of ink supply from the inking device 140 can be automatically adjusted by the control of the rotational speed of the ink fountain roller 140a by the motor 108 for driving the ink fountain roller.

Both end shafts 144 of the blanket cylinder 142 are supported by each eccentric bearing 145, and the eccentric bearing 145 is driven by an actuator 147 via a link mechanism 146. This configuration enables the blanket cylinder 142 to be thrown on and thrown off the plate cylinder (relief printing cylinder) 141 and the impression cylinder 143, and also permits the adjustment of the nip pressure and printing pressure between these cylinders.

In the present embodiment, the ink film thickness in the printing image of the printed sheet is measured using the aforementioned printing product inspection device (see FIGS. 12(a), 12(b)), and the ink supply amount from the aforementioned inking device 140 can be automatically adjusted by an ink supply amount control device 60A (strictly, including ink fountain roller control devices 100-1 to 100-M and ink fountain key control devices 120A-(1-1) to 120A-(M-N)) in accordance with the measured ink film thickness. In the present embodiment, the ink film thickness is measured using only the face side distance measuring instrument 74 of the aforementioned printing product inspection device (see FIGS. 12 (a), 12(b)), but may be measured using a dedicated printing product inspection device having the measuring instrument only on the face side.

At the time of measuring the ink film thickness, the color patch lines L as shown in FIG. 14 are used for measurement.

The above-mentioned ink supply amount control device 60A comprises CPU 61, RAM 62, ROM 63, input/output devices 64 to 66 and 68, and an interface 69 connected together by a BUS line 70, as shown in FIGS. 24 (a) and 24 (b). To the BUS line 70, the following memories are connected: A memory M1A for storing the ink color ICm of a printing unit M, a memory M2 for storing an image area rate IRmn in a range corresponding to each ink fountain key, a memory M3 for storing a count value M, a memory M4 for storing a count value N, a memory M5 for storing a table of conversion from the image area rate to an ink fountain key opening amount, a memory M6 for storing the opening amount Kmn of each ink fountain key, and a memory M7A for storing the total number Nmax of the ink fountain keys of each printing unit.

To the BUS line 70, the following memories are further connected: A memory M8 for storing the reference rotational speed ratio IFRRFm of the ink fountain roller, a memory M9 for storing the rotational speed ratio IFRRm of the ink fountain roller, a memory M11 for storing the value of a counter for measuring the current position in the circumferential direction of the distance measuring instrument, a memory M12 for storing the current position in the circumferential direction of the distance measuring instrument, a memory M13 for storing the position in the circumferential direction of a sheet thickness measuring position to be measured by the distance measuring instrument, a memory M14 for storing the value of a counter for measuring the current position in the lateral direction of the distance measuring instrument, a memory M15 for storing the current position in the lateral direction of the distance measuring instrument, a memory M16 for storing the position in the lateral direction of the sheet thickness measuring position to be measured by the distance measuring instrument, and a memory M17 for storing the output FD of the face side distance measuring instrument.

To the BUS line 70, the following memories are further connected: A memory M19 for storing the distance FDP from the face side distance measuring instrument to the sheet, a memory M21A for storing the distance FDE between the face side distance measuring instrument and the measuring stand, a memory M22 for storing the sheet thickness PT, a memory M23 for storing the position in the circumferential direction of the color patch line to be measured by the distance measuring instrument, a memory M24 for storing the position in the lateral direction of the color patch line to be measured by the distance measuring instrument, a memory M25A for storing the total number Mmax of the printing units, and a memory M26 for storing the distance FDCm from the face side distance measuring instrument to the color patch portion.

To the BUS line 70, the following memories are further connected: A memory M33 for storing a color patch portion thickness CPTm, a memory M34 for storing the ink film thickness IFTm, a memory M35 for storing a reference ink film thickness IFTF, a memory M36 for storing an ink film thickness error amount IFTDm, a memory M37 for storing a table of conversion from an ink film thickness error amount to the correction amount of the rotational speed ratio of the ink fountain roller, a memory M38 for storing the correction amount of the rotational speed ratio of the ink fountain roller, a memory M45 for storing the output of an A/D converter connected to a rotary encoder for the drive motor of the printing press, a memory M46 for storing the current rotational speed R of the printing press, and a memory M47A for storing the ink fountain roller rotational speed IFRm of each printing unit.

To the input/output device 64, the following are connected: An input device 71 such as a keyboard, a display device 72 such as CRT or a display, and an output device 73 such as a printer or a floppy disk (registered trademark) drive. The aforementioned face side distance measuring instrument 74 is connected to the input/output device 65.

To the input/output device 66, the aforementioned motor 78 for movement in the circumferential direction is connected via a D/A converter 76 and a driver 77 for the motor for movement in the circumferential direction, and a rotary encoder 80 for the motor for movement in the circumferential direction, which is drivingly coupled to the motor 78, is connected via a counter 79 for measuring the current position in the circumferential direction. A detector 81 for a home position in the circumferential direction is also connected to the input/output device 66.

To the input/output device 66, the aforementioned motor 84 for movement in the lateral direction is connected via a D/A converter 82 and a driver 83 for the motor for movement in the lateral direction, and a rotary encoder 86 for the motor for movement in the lateral direction, which is drivingly coupled to the motor 84, is connected via a counter 85 for measuring the current position in the lateral direction. A detector 87 for a home position in the lateral direction is also connected to the input/output device 66.

To the input/output device 68, a rotary encoder 94 for the drive motor of the printing press is connected via an A/D converter 92 and an F/V converter 93.

To the interface 69, there are connected a control device 100-1 for the first ink fountain roller to a control device 100-M for the Mth ink fountain roller, and a control device 120A-(1-1) for the first ink fountain key of the first printing unit to a control device 120A-(M-N) for the Nth ink fountain key of the Mth printing unit.

The ink fountain roller control devices 100-1 to 100-M comprise CPU 101, RAM 102, ROM 103, and besides, a memory M48 for storing the received rotational speed of the ink fountain roller, a memory M49 for storing the desired rotational speed of the ink fountain roller, an input/output device 104, and an interface 105, which are connected together by a BUS line 106, as shown in FIG. 25, similar to FIG. 2.

To the input/output device 104, the motor 108 for driving the ink fountain roller is connected via a driver 107 for the motor for driving the ink fountain roller, and a rotary encoder 111 for the motor for driving the ink fountain roller, which is drivingly connected to the motor 108 for driving the ink fountain roller, is connected via an F/V converter 110 and an A/D converter 109. A detection signal from the rotary encoder 111 for the motor for driving the ink fountain roller is inputted into the driver 107 for the motor for driving the ink fountain roller. The aforementioned ink supply amount control device 60A is connected to the interface 105.

The ink fountain key control devices 120A-(1-1) to 120A-(M-N) comprise CPU 121, RAM 122, ROM 123, and besides, a memory M50 for storing the received opening amount of the ink fountain key, a memory M51 for storing the desired opening amount of the ink fountain key, a memory M52 for storing the count value of the counter, a memory M53 for storing the current opening amount of the ink fountain key, an input/output device 124, and an interface 125, which are connected together by a BUS line 126, as shown in FIG. 26, similar to FIG. 3.

To the input/output device 124, therefore, the motor 128 for driving the ink fountain key is connected via a driver 127 for the motor for driving the ink fountain key, and a rotary encoder 130 for the motor for driving the ink fountain key, which is drivingly connected to the motor 128 for driving the ink fountain key, is connected via a counter 129. A detection signal from the rotary encoder 130 for the motor for driving the ink fountain key is also inputted into the driver 127 for the motor for driving the ink fountain key. The aforementioned ink supply amount control device 60A is connected to the interface 125.

The control actions or motions of the ink supply amount control device 60A will be described in detail based on the motion flow charts of FIGS. 27(a) and 27(b), FIGS. 28(a) to 28(d), and FIG. 29.

In Step P1, the memories M1A, M2 to M6, M7A, M8 to M9, M11 to M17, M19, M21A, M22 to M24, M25A, M26, M33 to M38, M45 to M46, and M47A are initialized. Then, in Step P2, it is determined whether the ink color ICm of the printing unit M and the image area rate IRmn in the range corresponding to each ink fountain key have been inputted. If the answer is Y (yes), in Step P3, the ink color ICm of the printing unit M and the image area rate IRmn in the range corresponding to each ink fountain key are inputted, and stored into the memories M1A and M2. If the answer is N (no), the program shifts to Step P4.

Then, in Step P4, it is determined whether an ink preset switch is ON. If the answer is Y, in Step P5, 1 is written into the count value M of the memory M3. If the answer is N, the program shifts to Step P31.

Then, in Step P6, 1 is written into the count value N of the memory M4. Then, in Step P7, the ink color ICm of the printing unit M is loaded from the memory M1A. Then, in Step P8, the table of conversion from the image area rate to the opening amount of the ink fountain key, corresponding to the ink color ICm, is loaded from the memory M5.

Then, in Step P9, the image area rate IRmn in the range corresponding to the Nth ink fountain key of the printing unit M is loaded from the memory M2. Then, in Step P10, the opening amount Kmn of the Nth ink fountain key of the printing unit M is obtained from the image area rate IRmn in the range corresponding to the Nth ink fountain key of the printing unit M with the use of the table of conversion from the image area rate corresponding to the ink color ICm to the opening amount of the ink fountain key, and the obtained value is stored into the Nth address position for the printing unit M in the memory M6 for storing the opening amount Kmn of each ink fountain key.

Then, in Step P11, 1 is added to the count value N of the memory M4 for overwriting. Then, in Step P12, the total number Nmax of the ink fountain keys of each printing unit is loaded from the memory M7A. Then, in Step P13, it is determined whether the count value N is larger than the total number Nmax of the ink fountain keys of each printing unit.

Then, if the answer is Y in Step P13, Step P14 is executed to add 1 to the count value M of the memory M3 for overwriting. If the answer is N, the program returns to Step P7. Then, in Step P15, the total number Mmax of the printing units is loaded from the memory M25A. Then, in Step P16, it is determined whether the count value M is larger than the total number Mmax of the printing units.

Then, if the answer is Y in Step P16, Step P17 is executed to write 1 into the count value M of the memory M3. If the answer is N, the program returns to Step P6. Then, in Step P18, 1 is written into the count value N of the memory M4. Then, in Step P19, the opening amount Kmn of the Nth ink fountain key of the printing unit M is loaded from the memory M6.

Then, in Step P20, the opening amount Kmn of the ink fountain key is transmitted to the control device for the Nth ink fountain key of the printing unit M. Then, if, in Step P21, a receipt confirmation signal has been transmitted from the control device for the Nth ink fountain key of the printing unit M, Step P22 is executed to add 1 to the count value N of the memory M4 for overwriting.

Then, in Step P23, the total number Nmax of the ink fountain keys of each printing unit is loaded from the memory M7A. Then, in Step P24, it is determined whether the count value N is greater than the total number Nmax of the ink fountain keys of each printing unit. If the answer is Y, in Step P25, the ink color ICm of the printing unit M is loaded from the memory M1A. If the answer is N, the program returns to Step P19.

Then, in Step P26, the reference rotational speed ratio IFRRFm of the ink fountain roller corresponding to the ink color ICm is loaded from the memory M8. Then, in Step P27, the reference rotational speed ratio IFRRFm of the ink fountain roller corresponding to the ink color ICm is written into the address for the printing unit M in the memory M9 for storing the rotational speed ratio IFRRm of the ink fountain roller.

Then, in Step P28, 1 is added to the count value M of the memory M3 for overwriting. Then, in Step P29, the total number Mmax of the printing units is loaded from the memory M25A. Then, in Step P30, it is determined whether the count value M is larger than the total number Mmax of the printing units. If the answer is Y, the program shifts to Step P31. If the answer is N, the program returns to Step P18.

In accordance with the above steps, presetting of the control means for the ink supply amount of the inking device in conformity with the inputted image area rate is completed.

Then, in Step P31, it is determined whether a sheet thickness measuring switch is ON. If the answer is Y, in Step P32, a normal rotation command is outputted to the driver 77 for the motor for movement in the circumferential direction. Then, in Step P33, the value of the counter 79 for measuring the current position in the circumferential direction of the distance measuring instrument is loaded, and stored into the memory M11.

Then, instep P34, the current position in the circumferential direction of the distance measuring instrument is computed from the loaded value of the counter for measuring the current position in the circumferential direction of the distance measuring instrument, and stored into the memory M12. Then, in Step P35, the position in the circumferential direction of the sheet thickness measuring position to be measured by the distance measuring instrument is loaded from the memory M13.

Then, in Step P36, it is determined whether the current position in the circumferential direction of the distance measuring instrument is equal to the position in the circumferential direction of the sheet thickness measuring position to be measured by the distance measuring instrument. If the answer is Y, outputting of the normal rotation command to the driver 77 for the motor for movement in the circumferential direction is stopped in Step P37. If the answer is N, the program returns to Step P33.

Then, in Step P38, a normal rotation command is outputted to the driver 83 for the motor for movement in the lateral direction. Then, in Step P39, the value of the counter 85 for measuring the current position in the lateral direction of the distance measuring instrument is loaded, and stored into the memory M14. Then, in Step P40, the current position in the lateral direction of the distance measuring instrument is computed from the loaded value of the counter for measuring the current position in the lateral direction of the distance measuring instrument, and stored into the memory M15.

Then, in Step P41, the position in the lateral direction of the sheet thickness measuring position to be measured by the distance measuring instrument is loaded from the memory M16. Then, in Step P42, it is determined whether the current position in the lateral direction of the distance measuring instrument is equal to the position in the lateral direction of the sheet thickness measuring position to be measured by the distance measuring instrument. If the answer is Y, in Step P43, a measurement command signal is outputted to the distance measuring instrument. If the answer is N, the program returns to Step P39.

Then, in Step P44, the output FD of the face side distance measuring instrument 74 is loaded, and stored into the memory M17. Then, in Step P45, outputting of the normal rotation command to the driver 83 for the motor for movement in the lateral direction is stopped.

Then, in Step P46, a reverse rotation command is outputted to the driver 83 for the motor for movement in the lateral direction. Then, if the output of the detector 87 for the home position in the lateral direction of the distance measuring instrument is ON in Step P47, outputting of the reverse rotation command to the driver 83 for the motor for movement in the lateral direction is stopped in Step P48.

Then, in Step P49, a reverse rotation command is outputted to the driver 77 for the motor for movement in the circumferential direction. Then, if the output of the detector 81 for the home position in the circumferential direction of the distance measuring instrument is ON in Step P50, outputting of the reverse rotation command to the driver 77 for the motor for movement in the circumferential direction is stopped in Step P51.

Then, in Step P52, the distance FDP from the face side distance measuring instrument to the sheet is computed from the output FD of the face side distance measuring instrument 74, and stored into the memory M19. Then, in Step P53, the distance FDF between the face side distance measuring instrument and the measuring stand is loaded from the memory M21A. Then, in Step P54, the distance FDP from the face side distance measuring instrument to the sheet is subtracted from the distance FDF between the face side distance measuring instrument and the measuring stand to compute the sheet thickness PT, which is stored into the memory M22. Then, the program shifts to Step P102 to be described later.

In accordance with the above steps, the thickness of the sheet W, which is the object to be measured, is measured. The sheet thickness measuring position is set at a part of the sheet W, where nothing is printed, in other words, a part where the ink film is not present.

If the answer is N in the aforementioned Step P31, on the other hand, it is determined in Step P55 whether a color patch measuring switch is ON. If the answer is Y, in Step P56, a normal rotation command is outputted to the driver 77 for the motor for movement in the circumferential direction. If the answer is N, the program shifts to Step P102 to be described later.

Then, in Step P57, the value of the counter 79 for measuring the current position in the circumferential direction of the distance measuring instrument is loaded, and stored into the memory M11. Then, in Step P58, the current position in the circumferential direction of the distance measuring instrument is computed from the loaded value of the counter for measuring the current position in the circumferential direction of the distance measuring instrument, and stored into the memory M12. Then, in Step P59, the position in the circumferential direction of the color patch line to be measured by the distance measuring instrument is loaded from the memory M23.

Then, in Step P60, it is determined whether the current position in the circumferential direction of the distance measuring instrument is equal to the position in the circumferential direction of the color patch line to be measured by the distance measuring instrument. If the answer is Y, outputting of the normal rotation command to the driver 77 for the motor for movement in the circumferential direction is stopped in Step P61. If the answer is N, the program returns to Step P57.

Then, in Step P62, 1 is written into the count value M of the memory M3. Then, in Step P63, a normal rotation command is outputted to the driver 83 for the motor for movement in the lateral direction. Then, in Step P64, the value of the counter 85 for measuring the current position in the lateral direction of the distance measuring instrument is loaded, and stored into the memory M14.

Then, in Step P65, the current position in the lateral direction of the distance measuring instrument is computed from the loaded value of the counter for measuring the current position in the lateral direction of the distance measuring instrument, and stored into the memory M15. Then, in Step P66, the position in the lateral direction of the color patch line in the printing unit M to be measured by the distance measuring instrument is loaded from the memory M24.

Then, in Step P67, it is determined whether the current position in the lateral direction of the distance measuring instrument is equal to the position in the lateral direction of the color patch line in the printing unit M to be measured by the distance measuring instrument. If the answer is Y, in Step P68, a measurement command signal is outputted to the distance measuring instrument. If the answer is N, the program returns to Step P64.

Then, in Step P69, the output FDm of the face side distance measuring instrument 74 is loaded, and stored into the Nth address position for the printing unit M in the memory M17. Then, in Step P70, 1 is added to the count value M of the memory M3 for overwriting.

Then, in Step P71, the total number Mmax of the printing units is loaded from the memory M25A. Then, in Step P72, it is determined whether the count value M is larger than the total number Mmax of the printing units. If the answer is Y, outputting of the normal rotation command to the driver 83 for the motor for movement in the lateral direction is stopped in Step P73. If the answer is N, the program returns to Step P64.

Then, in Step P74, a reverse rotation command is outputted to the driver 83 for the motor for movement in the lateral direction. Then, if the output of the detector 87 for the home position in the lateral direction of the distance measuring instrument is ON in Step P75, outputting of the reverse rotation command to the driver 83 for the motor for movement in the lateral direction is stopped in Step P76.

Then, in Step P77, a reverse rotation command is outputted to the driver 77 for the motor for movement in the circumferential direction. Then, if the output of the detector 81 for the home position in the circumferential direction of the distance measuring instrument is ON in Step P78, outputting of the reverse rotation command to the driver 77 for the motor for movement in the circumferential direction is stopped in Step P79.

In accordance with the above steps, the distance from the face side distance measuring instrument 74 to the color patch line L printed with ink supplied from each printing unit is measured.

Then, in Step P80, 1 is written into the count value N of the memory M3. Then, the output FDm of the face side distance measuring instrument 74 stored in the address position for the printing unit M in the memory M17 is loaded in Step P81. Then, in Step P82, the distance FDCm from the face side distance measuring instrument to the color patch portion is computed from the output FDm of the face side distance measuring instrument 74 stored in the address position for the printing unit M in the memory M17, and the computed distance is stored into the memory M26.

Then, in Step P83, the distance FDF between the face side distance measuring instrument and the measuring stand is loaded from the memory M21A. Then, in Step P84, the distance FDCm from the face side distance measuring instrument to the color patch portion is subtracted from the distance FDF between the face side distance measuring instrument and the measuring stand to compute the thickness CPTm of the color patch portion, which is stored into the memory M33.

Then, in Step P85, the sheet thickness PT is loaded from the memory M22. Then, in Step P86, the sheet thickness PT is subtracted from the thickness CPTm of the color patch portion to compute the ink film thickness IFTm, which is stored into the address position for the printing unit M in the memory M34.

Then, in Step P87, the reference ink film thickness IFTFm of the printing unit M is loaded from the address position for the printing unit M in the memory M35 for storing the reference ink film thickness IFTF. Then, in Step P88, the reference ink film thickness IFTFm of the printing unit M is subtracted from the ink film thickness IFTm of the printing unit M to compute the ink film thickness error amount IFTDm of the printing unit M, and the computed value is stored into the address position for the printing unit M in the memory M36.

Then, in Step P89, the ink color ICm of the printing unit M is loaded from the memory M1A. Then, in Step P90, the table of conversion from the ink film thickness error amount to the correction amount of the rotational speed ratio of the ink fountain roller, corresponding to the ink color ICm, is loaded from the memory M37.

Then, in Step P91, the correction amount of the rotational speed ratio of the ink fountain roller is obtained from the ink film thickness error amount IFTDm with the use of the table of conversion from the ink film thickness error amount to the correction amount of the rotational speed ratio of the ink fountain roller, corresponding to the ink color ICm, and the obtained value is stored into the address position for the printing unit M in the memory M38. Then, in Step P92, 1 is added to the count value M of the memory M3 for overwriting.

Then, in Step P93, the total number Mmax of the printing units is loaded from the memory M25A. Then, in Step P94, it is determined whether the count value M is larger than the total number Mmax of the printing units. If the answer is Y, in Step P95, 1 is written into the count value M of the memory M3. If the answer is N, the program returns to Step P81.

In accordance with the above steps, the correction amount of the rotational speed ratio of the ink fountain roller of each inking device is obtained from the ink film thickness of each color patch line L which has been measured.

Then, in Step P96, the rotational speed ratio IFRRm of the ink fountain roller of the printing unit M is loaded from the memory M9. Then, in Step P97, the correction amount of the rotational speed ratio of the ink fountain roller of the printing unit M is loaded from the memory M38.

Then, in Step P98, the correction amount of the rotational speed ratio of the ink fountain roller of the printing unit M is added to the rotational speed ratio IFRRm of the ink fountain roller of the printing unit M, and the address position for the printing unit M in the memory M9 for storing the rotational speed ratio IFRRm of the ink fountain roller is overwritten with the resulting sum. Then, in Step P99, 1 is added to the count value M of the memory M3 for overwriting.

Then, in Step P100, the total number Mmax of the printing units is loaded from the memory M25A. Then, it is determined in Step P101 whether the count value M is larger than the total number Mmax of the printing units. If the answer is Y, the program returns to Step P2. If the answer is N, the program returns to Step P96.

In accordance with the above steps, the rotational speed ratio of the ink fountain roller corrected with the obtained correction amount is obtained.

In Step P102 shifted from the aforementioned Step P54 or Step P55, the output of the A/D converter 92 connected to the rotary encoder 94 for the drive motor of the printing press is loaded, and stored into the memory M45. Then, in Step P103, the current rotational speed R of the printing press is computed from the A/D converter connected to the rotary encoder for the drive motor of the printing press, and the computed value is stored into the memory M46.

Then, in Step P104, 1 is written into the count value M of the memory M3. Then, in Step P105, the rotational speed ratio IFRRm of the ink fountain roller of the printing unit M is loaded from the memory M9. Then, in Step P106, the current rotational speed R of the printing press is loaded from the memory M46.

Then, in Step P107, the current rotational speed R of the printing press is multiplied by the rotational speed ratio IFRRm of the ink fountain roller of the printing unit M to compute the rotational speed IFRm of the ink fountain roller of the printing unit M, and the computed value is stored into the memory M47A. Then, in Step P108, the rotational speed IFRm of the ink fountain roller is transmitted to the control device for the ink fountain roller of the printing unit M.

Then, upon transmission of a receipt confirmation signal from the control device for the ink fountain roller of the printing unit M in Step P109, 1 is added to the count value M of the memory M3 in Step P110 for overwriting.

Then, in Step P111, the total number Mmax of the printing units is loaded from the memory M25A. Then, in Step P112, it is determined whether the count value M is greater than the total number Mmax of the printing units. If the answer is Y, the program returns to Step P2. If the answer is N, the program returns to Step P105. Then, this procedure is repeated.

In accordance with the above steps, the ink fountain roller is rotated at the corrected rotational speed ratio of the ink fountain roller.

The control device 120A-(1-1) for the first ink fountain key of the first printing unit to the control device 120A-(M-N) for the Nth ink fountain key of the Mth printing unit act in accordance with the motion or action flow shown in FIG. 29.

That is, if, in Step P1, the opening amount Kmn of the ink fountain key is transmitted from the ink supply amount control device 60A, Step P2 is executed to receive the opening amount Kmn of the ink fountain key and store the received opening amount Kmn of the ink fountain key into the memory M50 for storing the received opening amount Kmn of the ink fountain key. Then, in Step P3, a receipt confirmation signal is transmitted to the ink supply amount control device 60A.

Then, in Step P4, the received opening amount Kmn of the ink fountain key is written into the memory M51 for storing the desired opening amount (position) of the ink fountain key. Then, in Step P5, the count value of the counter 129 is loaded and stored into the memory M52. Then, in Step P6, the current opening amount (position) of the ink fountain key is computed from the count value of the counter 129, and stored into the memory M53.

Then, in Step P7, it is determined whether the desired position of the ink fountain key is equal to the current position of the ink fountain key. If the answer is Y, the program returns to Step P1. If the answer is N, it is determined in Step P8 whether the desired position of the ink fountain key is greater than the current position of the ink fountain key.

If the answer is Y in Step P8, Step P9 is executed to output a normal rotation command to the driver 127 for the motor for driving the ink fountain key. If the answer is N in Step P8, Step P10 is executed to output a reverse rotation command to the driver 127 for the motor for driving the ink fountain key.

Then, in Step P11, the count value of the counter 129 is loaded, and stored into the memory M52. Then, in Step P12, the current position of the ink fountain key is computed from the count value of the counter 129, and stored into the memory M53.

Then, in Step P13, it is determined whether the current position of the ink fountain key is equal to the desired position of the ink fountain key. If the answer is Y, in Step P14, a stop command is outputted to the driver 127 for the motor for driving the ink fountain key. Then, the program returns to Step P1. If the answer is N, the program returns to Step P11. Then, this procedure is repeated.

The control device 100-1 for the first ink fountain roller to the control device 100-M for the Mth ink fountain roller act in accordance with the motion flow shown in FIG. 31.

If, in Step P1, the rotational speed IFRm of the ink fountain roller is transmitted from the ink supply amount control device 60A, Step P2 is executed to receive the rotational speed IFRm of the ink fountain roller and store the received rotational speed IFRm of the ink fountain roller into the memory M48 for storing the received rotational speed IFRm of the ink fountain roller. Then, in Step P3, a receipt confirmation signal is transmitted to the ink supply amount control device 60A.

Then, in Step P4, the received rotational speed IFRm of the ink fountain roller is written and stored into the memory M49 for storing the desired rotational speed of the ink fountain roller. Then, in Step P5, the desired rotational speed of the ink fountain roller is loaded from the memory M49.

Then, in Step P6, a rotational speed command on the desired rotational speed of the ink fountain roller is outputted to the driver 107 for the motor for driving the ink fountain roller. Then, the program returns to Step P1. Afterwards, this procedure is repeated.

According to the present embodiment described above, in the relief printing press, the ink film thickness of the printed sheet W is measured using the face side distance measuring instrument 74. In accordance with the measured ink film thickness, the aforementioned motor 108 is drivingly controlled, whereby the rotational speed (i.e., ink supply amount) of the ink fountain roller 140a in each printing unit is automatically adjusted.

Thus, printing troubles due to misadjustment of the ink supply amount owing to the operator's manual operation can be avoided. Consequently, burden on the operator can be lessened, and the ink film thickness can be controlled with high accuracy to decrease defective printing products (wasted sheets).

### Embodiment 4

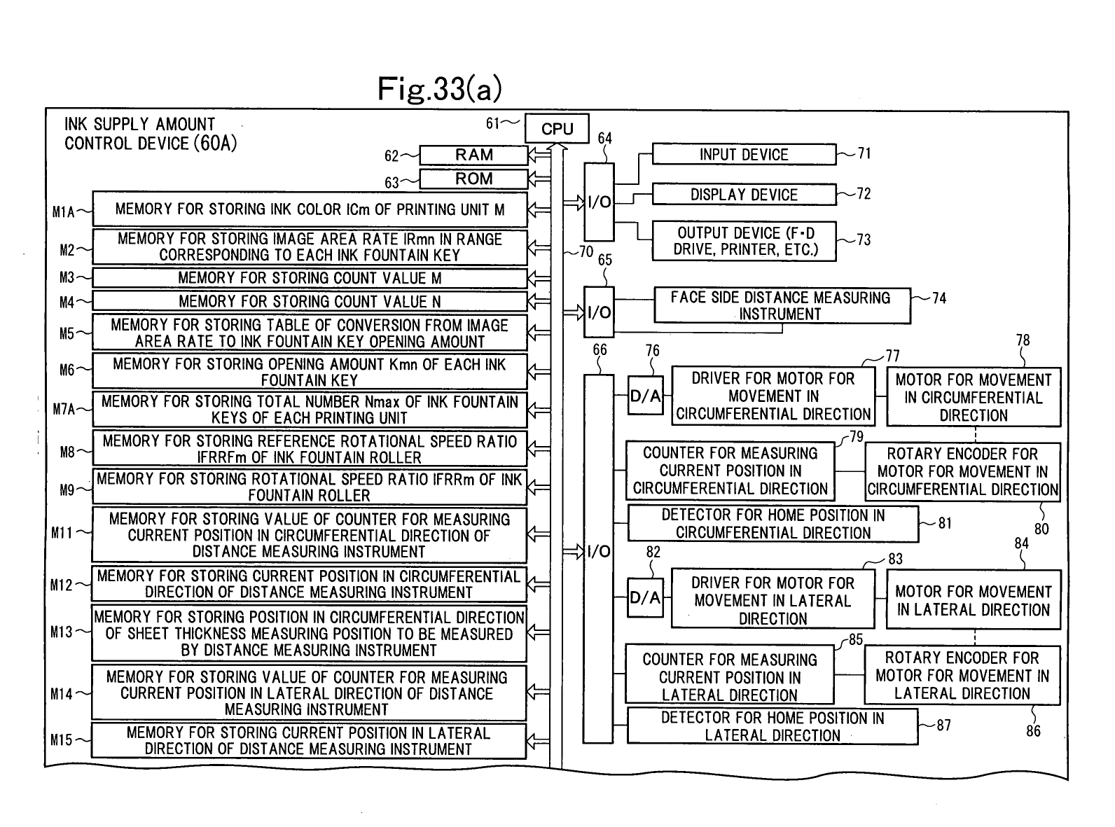

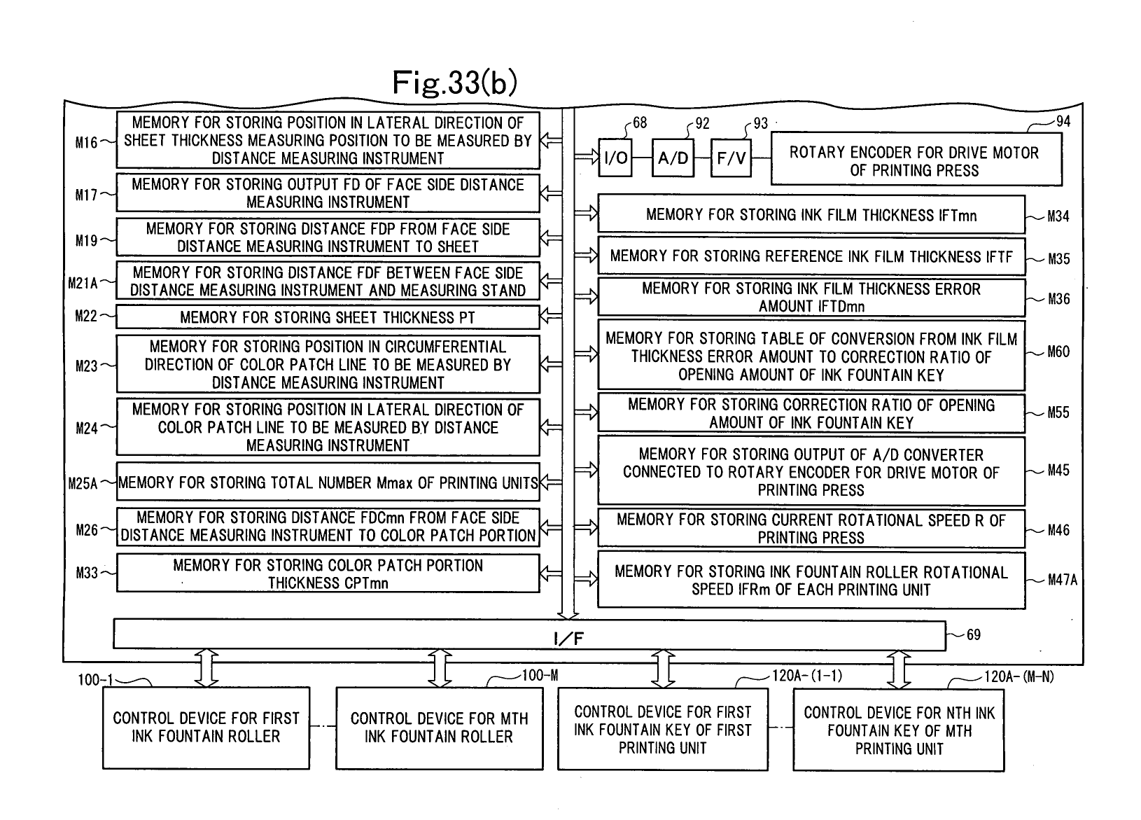

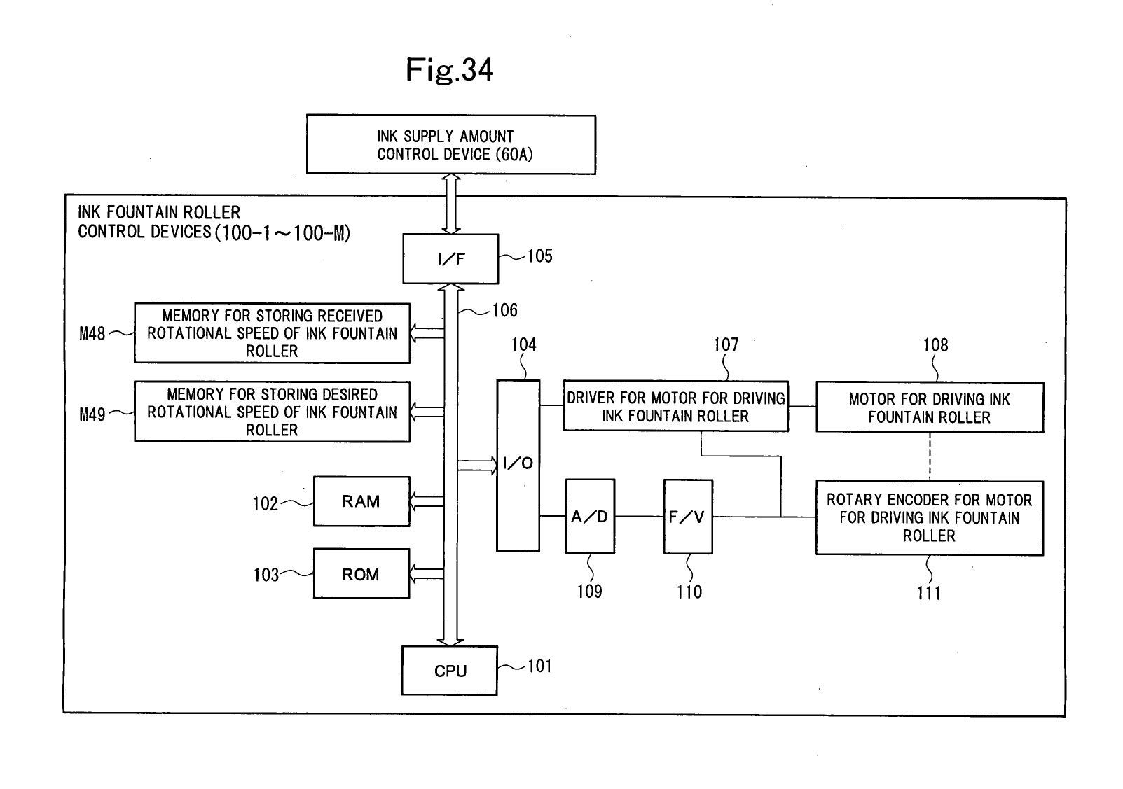

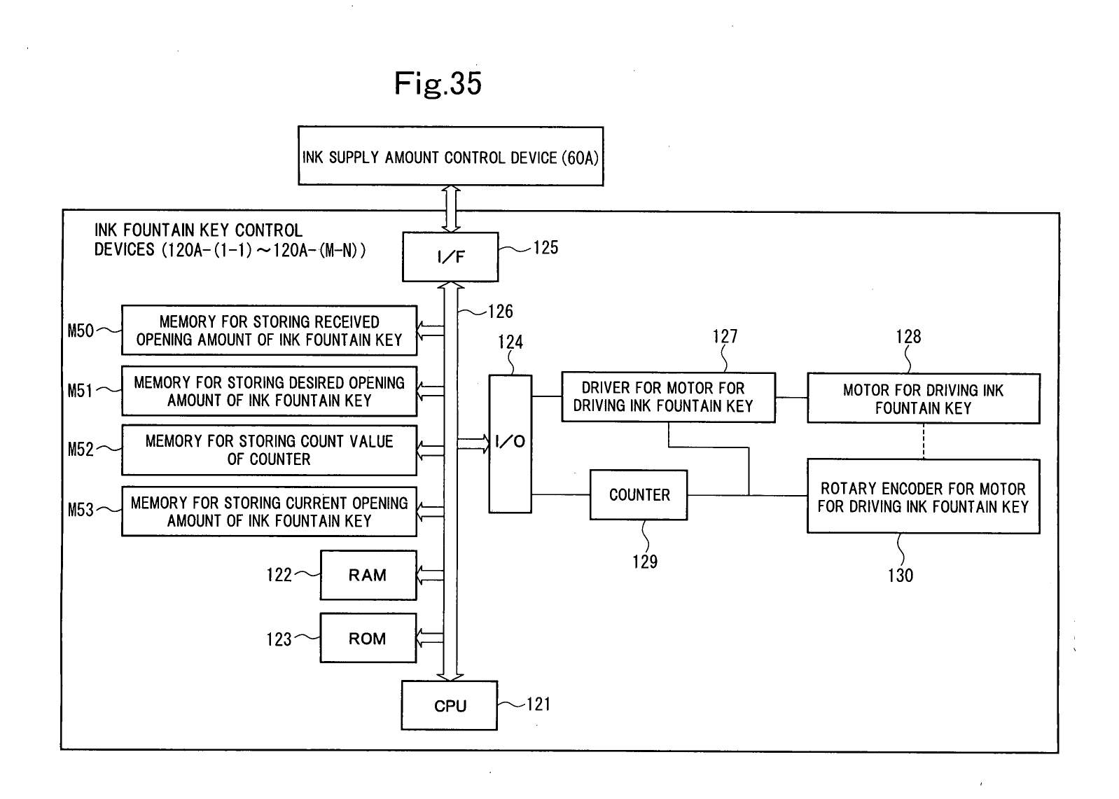

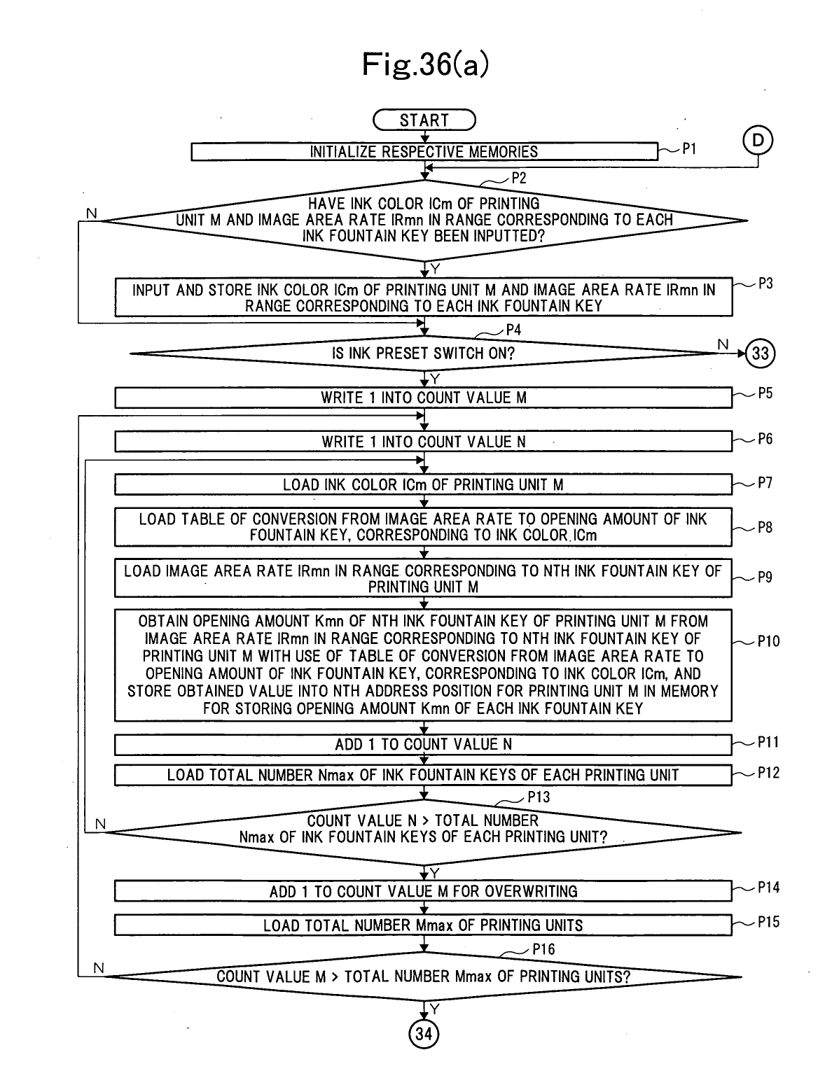

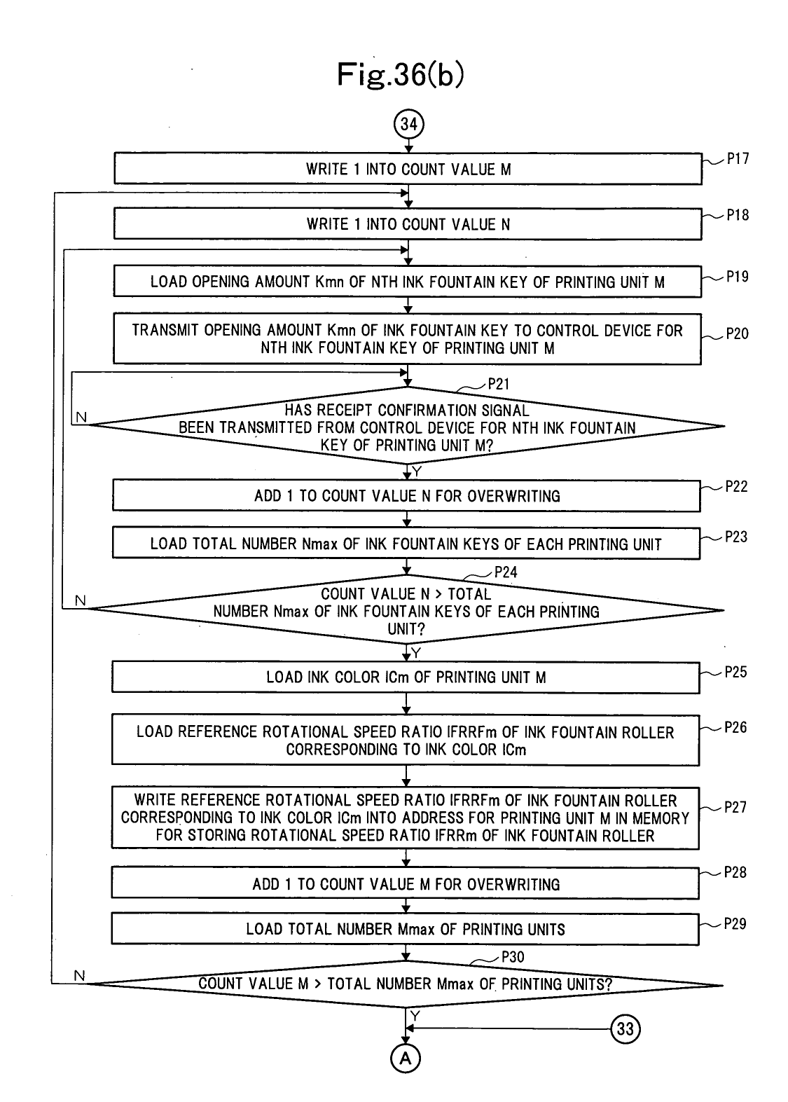

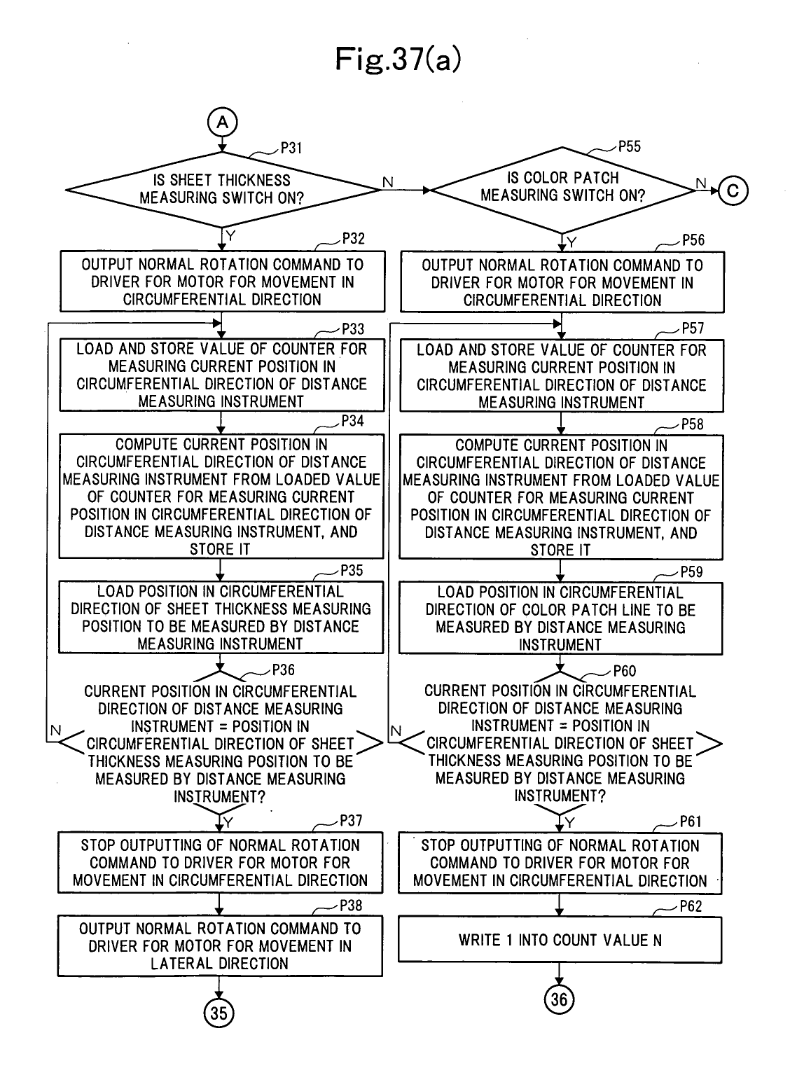

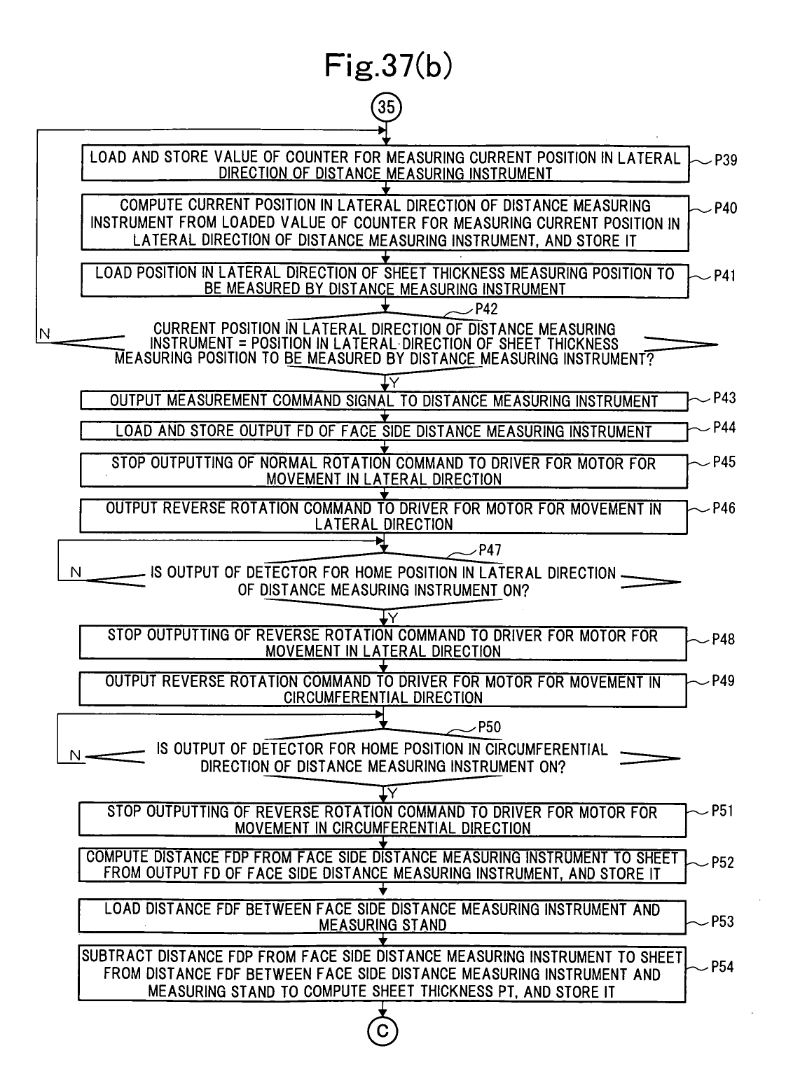

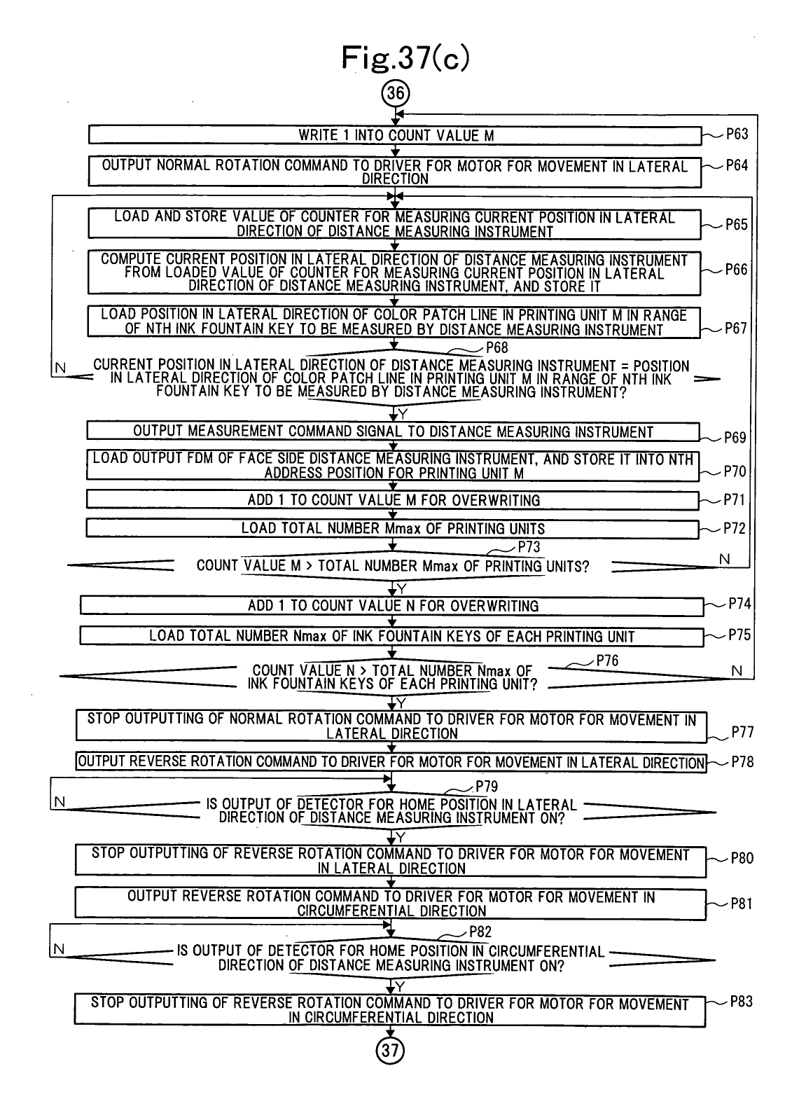

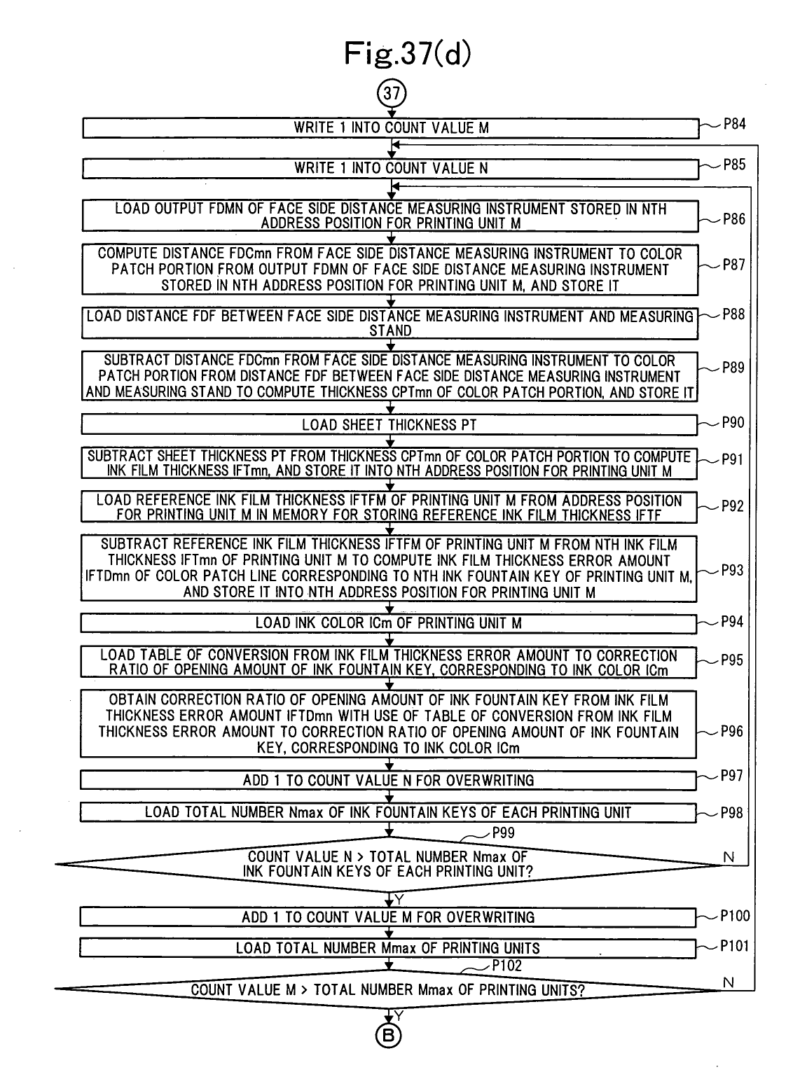

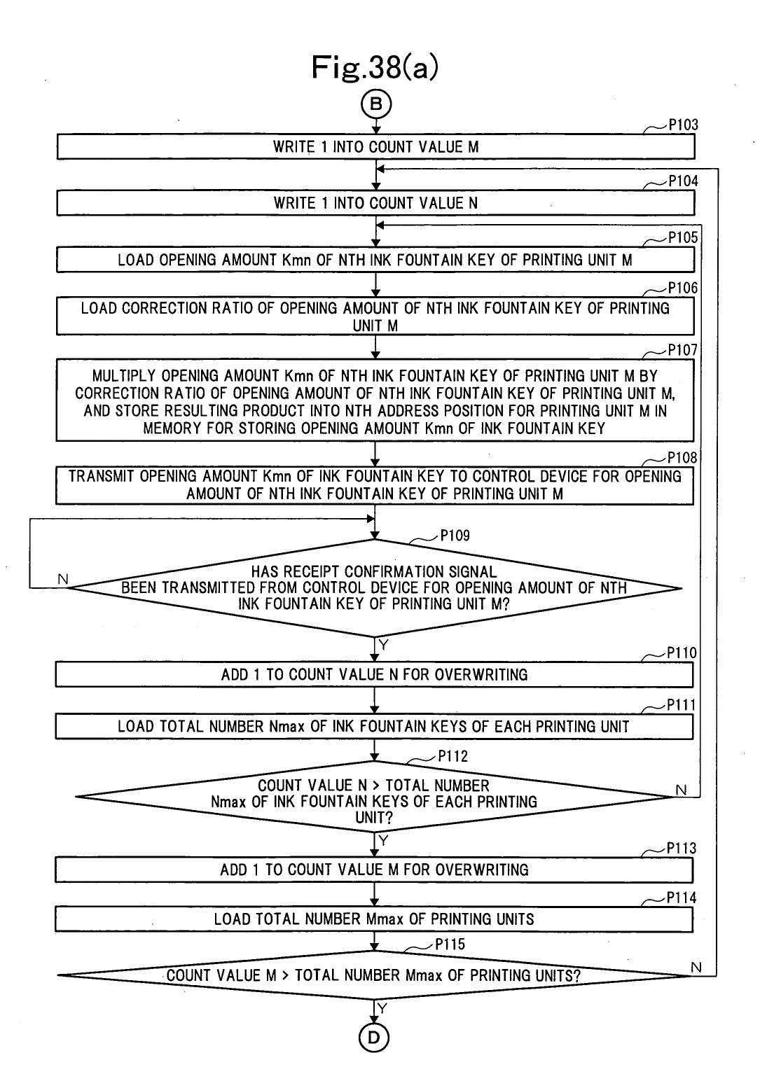

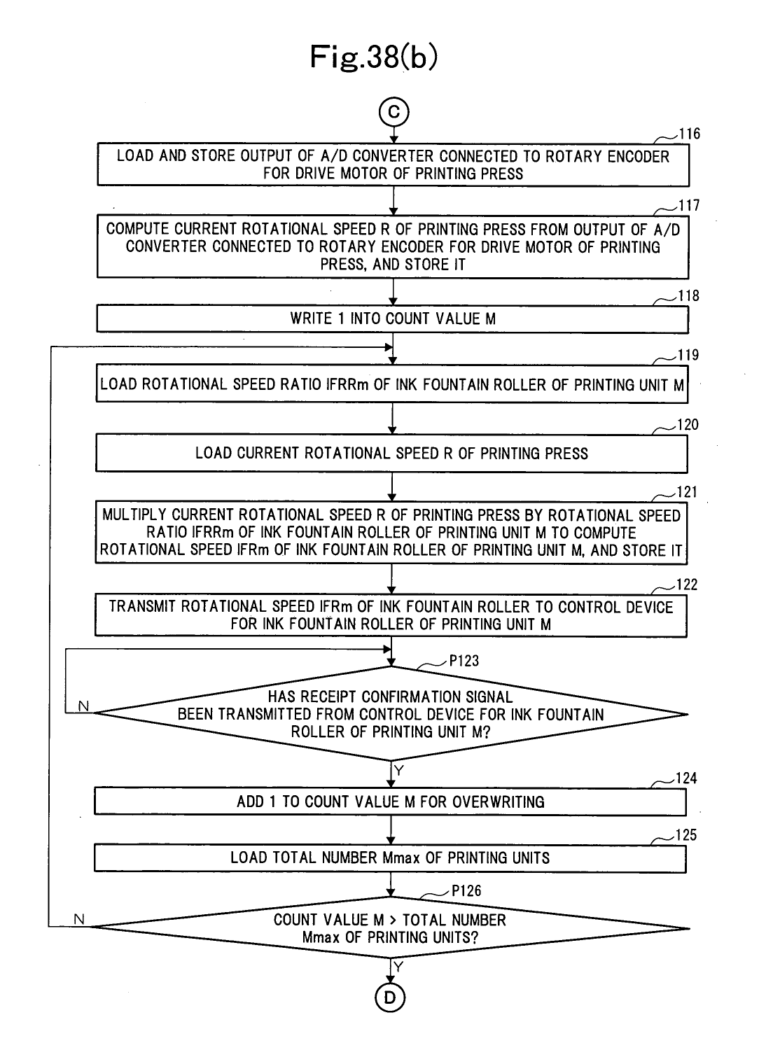

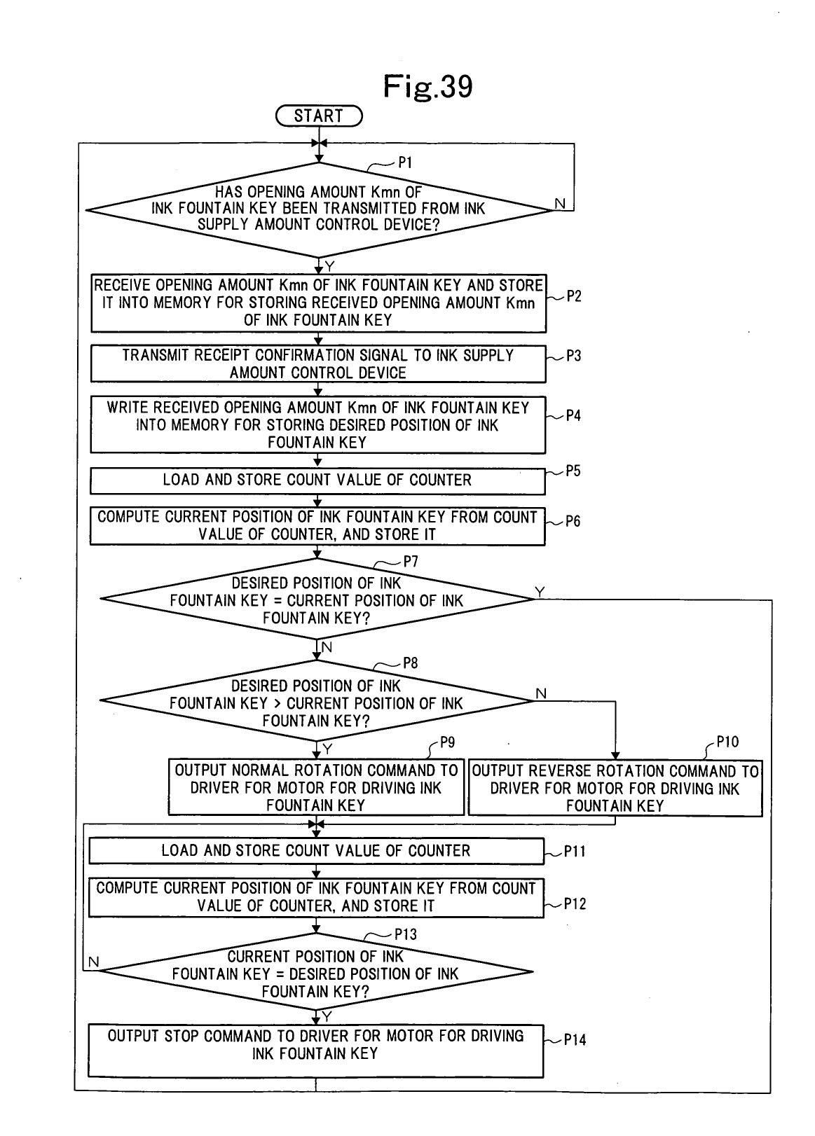

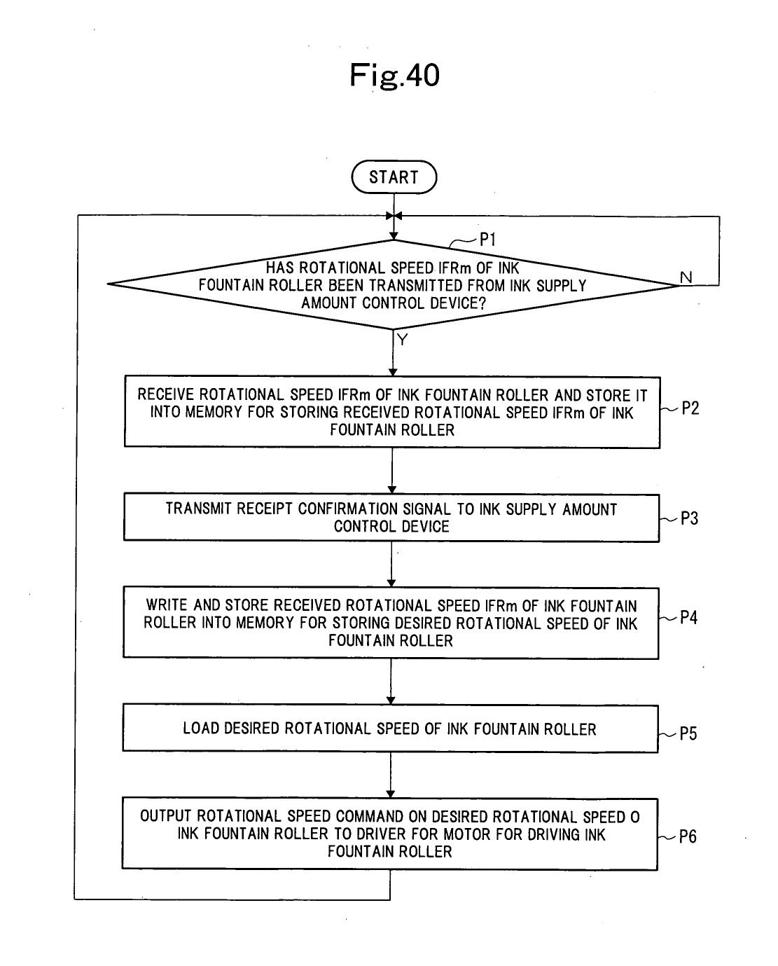

FIGS. 33(a) and 33(b) are control block diagrams of an ink supply amount control device showing Embodiment 4 of the present invention. FIG. 34 is a control block diagram of an ink fountain roller control device. FIG. 35 is a control block diagram of an ink fountain key control device. FIGS. 36(a) and 36(b) are motion flow charts of the ink supply amount control device. FIGS. 37(a) to 37(d) are motion flow charts of the ink supply amount control device. FIG. 38(a) and 38(b) is a motion flow chart of the ink supply amount control device. FIG. 39 is a motion flow chart of the ink fountain key control device. FIG. 40 is a motion flow chart of the ink fountain roller control device.

The present embodiment is an embodiment configured like Embodiment 3 in the following manner: In an inking device 140 of each printing unit in a relief printing press, an ink fountain roller 140a is driven by a motor (ink supply amount adjusting means) 108 (see FIG. 34) for driving the ink fountain roller separately from a drive motor of the printing press, and an ink fountain key (not shown) is driven by a motor (ink supply amount adjusting means) 128 (see FIG. 35) for driving the ink fountain key. The amount of ink supply from the inking device 140 can be automatically adjusted by the control of the opening amount of the ink fountain key by the motor 128 for driving the ink fountain key. Other features excepting those on control to be described later are the same as in Embodiment 3, and duplicate explanations will be omitted by reference to FIG. 31.

At the time of measuring the ink film thickness, the color patch lines L as shown in FIG. 23 are used for measurement.

The above-mentioned ink supply amount control device 60A comprises CPU 61, RAM 62, ROM 63, input/output devices 64 to 66 and 68, and an interface 69 connected together by a BUS line 70, as shown in FIGS. 33(a) and 33(b). To the BUS line 70, the following memories are connected: A memory M1A for storing the ink color ICm of a printing unit M, a memory M2 for storing an image area rate IRmn in a range corresponding to each ink fountain key, a memory M3 for storing a count value M, a memory M4 for storing a count value N, a memory M5 for storing a table of conversion from the image area rate to an ink fountain key opening amount, a memory M6 for storing the opening amount Kmn of each ink fountain key, and a memory M7A for storing the total number Nmax of the ink fountain keys of each printing unit.

To the BUS line 70, the following memories are further connected: A memory M8 for storing the reference rotational speed ratio IFRRFm of the ink fountain roller, a memory M9 for storing the rotational speed ratio IFRRm of the ink fountain roller, a memory M11 for storing the value of a counter for measuring the current position in the circumferential direction of the distance measuring instrument, a memory M12 for storing the current position in the circumferential direction of the distance measuring instrument, a memory M13 for storing the position in the circumferential direction of a sheet thickness measuring position to be measured by the distance measuring instrument, a memory M14 for storing the value of a counter for measuring the current position in the lateral direction of the distance measuring instrument, a memory M15 for storing the current position in the lateral direction of the distance measuring instrument, a memory M16 for storing the position in the lateral direction of the sheet thickness measuring position to be measured by the distance measuring instrument, and a memory M17 for storing the output FD of the face side distance measuring instrument.

To the BUS line 70, the following memories are further connected: A memory M19 for storing the distance FDP from the face side distance measuring instrument to the sheet, a memory M21A for storing the distance FDF between the face side distance measuring instrument and the measuring stand, a memory M22 for storing the sheet thickness PT, a memory M23 for storing the position in the circumferential direction of the color patch line to be measured by the distance measuring instrument, a memory M24 for storing the position in the lateral direction of the color patch line to be measured by the distance measuring instrument, a memory M25A for storing the total number Mmax of the printing units, and a memory M26 for storing the distance FDCmn from the face side distance measuring instrument to the color patch portion.

To the BUS line 70, the following memories are further connected: A memory M33 for storing a color patch portion thickness CPTmn, a memory M34 for storing the ink film thickness IFTmn, a memory M35 for storing a reference ink film thickness IFTF, a memory M36 for storing an ink film thickness error amount IFTDmn, a memory M60 for storing a table of conversion from an ink film thickness error amount to the correction ratio of the opening amount of the ink fountain key, a memory M55 for storing the correction ratio of the opening amount of the ink fountain key, a memory M45 for storing the output of an A/D converter connected to a rotary encoder for the drive motor of the printing press, a memory M46 for storing the current rotational speed R of the printing press, and a memory M47A for storing the ink fountain roller rotational speed IFRm of each printing unit.

To the input/output device 64, the following are connected: An input device 71 such as a keyboard, a display device 72 such as CRT or a display, and an output device 73 such as a printer or a floppy disk (registered trademark) drive. The aforementioned face side distance measuring instrument 74 is connected to the input/output device 65.

To the input/output device 66, the aforementioned motor 78 for movement in the circumferential direction is connected via a D/A converter 76 and a driver 77 for the motor for movement in the circumferential direction, and a rotary encoder 80 for the motor for movement in the circumferential direction, which is drivingly coupled to the motor 78, is connected via a counter 79 for measuring the current position in the circumferential direction. A detector 81 for a home position in the circumferential direction is also connected to the input/output device 66.

To the input/output device 66, the aforementioned motor 84 for movement in the lateral direction is connected via a D/A converter 82 and a driver 83 for the motor for movement in the lateral direction, and a rotary encoder 86 for the motor for movement in the lateral direction, which is drivingly coupled to the motor 84, is connected via a counter 85 for measuring the current position in the lateral direction. A detector 87 for a home position in the lateral direction is also connected to the input/output device 66.

To the input/output device 68, a rotary encoder 94 for the drive motor of the printing press is connected via an A/D converter 92 and an F/V converter 93.

To the interface 69, there are connected a control device 100-1 for the first ink fountain roller to a control device 100-M for the Mth ink fountain roller, and a control device 120A-(1-1) for the first ink fountain key of the first printing unit to a control device 120A-(M-N) for the Nth ink fountain key of the Mth printing unit.

The ink fountain roller control devices 100-1 to 100-M comprise CPU 101, RAM 102, ROM 103, and besides, a memory M48 for storing the received rotational speed of the ink fountain roller, a memory M49 for storing the desired rotational speed of the ink fountain roller, an input/output device 104, and an interface 105, which are connected together by a BUS line 106, as shown in FIG. 34, similar to FIG. 25.

To the input/output device 104, the motor 108 for driving the ink fountain roller is connected via a driver 107 for the motor for driving the ink fountain roller, and a rotary encoder 111 for the motor for driving the ink fountain roller, which is drivingly connected to the motor 108 for driving the ink fountain roller, is connected via an F/V converter 110 and an A/D converter 109. A detection signal from the rotary encoder 111 for the motor for driving the ink fountain roller is inputted into the driver 107 for the motor for driving the ink fountain roller. The aforementioned ink supply amount control device 60A is connected to the interface 105.

The ink fountain key control devices 120A-(1-1) to 120A-(M-N) comprise CPU 121, RAM 122, ROM 123, and besides, a memory M50 for storing the received opening amount of the ink fountain key, a memory M51 for storing the desired opening amount of the ink fountain key, a memory M52 for storing the count value of the counter, a memory M53 for storing the current opening amount of the ink fountain key, an input/output device 124, and an interface 125, which are connected together by a BUS line 126, as shown in FIG. 34, similar to FIG. 26.

To the input/output device 124, therefore, the motor 128 for driving the ink fountain key is connected via a driver 127 for the motor for driving the ink fountain key, and a rotary encoder 130 for the motor for driving the ink fountain key, which is drivingly connected to the motor 128 for driving the ink fountain key, is connected via a counter 129. A detection signal from the rotary encoder 130 for the motor for driving the ink fountain key is inputted into the driver 127 for the motor for driving the ink fountain key. The aforementioned ink supply amount control device 60A is connected to the interface 125.

The control actions or motions of the ink supply amount control device 60A will be described in detail based on the motion flow charts of FIGS. 36(a) and 36(b), FIGS. 37(a) to 37(d), and FIG. 38(a) and 38(b).

In Step P1, the memories M1A, M2 to M6, M7A, M8 to M9, M11 to M17, M19, M21A, M22 to M24, M25A, M26, M33 to M36, M45 to M46, M47A, M55, and M60 are initialized. Then, in Step P2, it is determined whether the ink color ICm of the printing unit M and the image area rate IRmn in the range corresponding to each ink fountain key have been inputted. If the answer is Y (yes), in Step P3, the ink color ICm of the printing unit M and the image area rate IRmn in the range corresponding to each ink fountain key are inputted, and stored into the memories M1A and M2. If the answer is N (no), the program shifts to Step P4.

Then, in Step P4, it is determined whether an ink preset switch is ON. If the answer is Y, in Step P5, 1 is written into the count value M of the memory M3. If the answer is N, the program shifts to Step P31.

Then, in Step P6, 1 is written into the count value N of the memory M4. Then, in Step P7, the ink color ICm of the printing unit M is loaded from the memory M1A. Then, in Step P8, the table of conversion from the image area rate to the opening amount of the ink fountain key, corresponding to the ink color ICm, is loaded from the memory M5.

Then, in Step P9, the image area rate IRmn in the range corresponding to the Nth ink fountain key of the printing unit M is loaded from the memory M2. Then, in Step P10, the opening amount Kmn of the Nth ink fountain key of the printing unit M is obtained from the image area rate IRmn in the range corresponding to the Nth ink fountain key of the printing unit M with the use of the table of conversion from the image area rate to the opening amount of the ink fountain key, corresponding to the ink color ICm, and the obtained value is stored into the Nth address position for the printing unit M in the memory M6 for storing the opening amount Kmn of each ink fountain key.

Then, in Step P11, 1 is added to the count value N of the memory M4 for overwriting. Then, in Step P12, the total number Nmax of the ink fountain keys of each printing unit is loaded from the memory M7A. Then, in Step P13, it is determined whether the count value N is larger than the total number Nmax of the ink fountain keys of each printing unit.

Then, if the answer is Y in Step P13, Step P14 is executed to add 1 to the count value M of the memory M3 for overwriting. If the answer is N, the program returns to Step P7. Then, in Step P15, the total number Mmax of the printing units is loaded from the memory M25A. Then, in Step P16, it is determined whether the count value M is larger than the total number Mmax of the printing units.

Then, if the answer is Y in Step P16, Step P17 is executed to write 1 into the count value M of the memory M3. If the answer is N, the program returns to Step P6. Then, in Step P18, 1 is written into the count value N of the memory M4A. Then, in Step P19, the opening amount Kmn of the Nth ink fountain key of the printing unit M is loaded from the memory M6.

Then, in Step P20, the opening amount Kmn of the ink fountain key is transmitted to the control device for the Nth ink fountain key of the printing unit M. Then, if, in Step P21, a receipt confirmation signal has been transmitted from the control device for the Nth ink fountain key of the printing unit M, Step P22 is executed to add 1 to the count value N of the memory M4 for overwriting.

Then, in Step P23, the total number Nmax of the ink fountain keys of each printing unit is loaded from the memory M7. Then, in Step P24, it is determined whether the count value N is greater than the total number Nmax of the ink fountain keys of each printing unit. If the answer is Y, in Step P25, the ink color ICm of the printing unit M is loaded from the memory M1A. If the answer is N, the program returns to Step P19.

Then, in Step P26, the reference rotational speed ratio IFRRFm of the ink fountain roller corresponding to the ink color ICm is loaded from the memory M8. Then, in Step P27, the reference rotational speed ratio IFRRFm of the ink fountain roller corresponding to the ink color ICm is written into the address for the printing unit M in the memory M9 for storing the rotational speed ratio IFRRm of the ink fountain roller.

Then, in Step P28, 1 is added to the count value M of the memory M3 for overwriting. Then, in Step P29, the total number Mmax of the printing units is loaded from the memory M25A. Then, in Step P30, it is determined whether the count value M is larger than the total number Mmax of the printing units. If the answer is Y, the program shifts to Step P31. If the answer is N, the program returns to Step P18.

In accordance with the above steps, presetting of the control means for the ink supply amount of the inking device in conformity with the inputted image area rate is completed.

Then, in Step P31, it is determined whether a sheet thickness measuring switch is ON. If the answer is Y, in Step P32, a normal rotation command is outputted to the driver 77 for the motor for movement in the circumferential direction. Then, in Step P33, the value of the counter 79 for measuring the current position in the circumferential direction of the distance measuring instrument is loaded, and stored into the memory M11.

Then, in Step P34, the current position in the circumferential direction of the distance measuring instrument is computed from the loaded value of the counter for measuring the current position in the circumferential direction of the distance measuring instrument, and stored into the memory M12. Then, in Step P35, the position in the circumferential direction of the sheet thickness measuring position to be measured by the distance measuring instrument is loaded from the memory M13.

Then, in Step P36, it is determined whether the current position in the circumferential direction of the distance measuring instrument is equal to the position in the circumferential direction of the sheet thickness measuring position to be measured by the distance measuring instrument. If the answer is Y, outputting of the normal rotation command to the driver 77 for the motor for movement in the circumferential direction is stopped in Step P37. If the answer is N, the program returns to Step P33.

Then, in Step P38, a normal rotation command is outputted to the driver 83 for the motor for movement in the lateral direction. Then, in Step P39, the value of the counter 85 for measuring the current position in the lateral direction of the distance measuring instrument is loaded, and stored into the memory M14. Then, in Step P40, the current position in the lateral direction of the distance measuring instrument is computed from the loaded value of the counter for measuring the current position in the lateral direction of the distance measuring instrument, and stored into the memory M15.

Then, in Step P41, the position in the lateral direction of the sheet thickness measuring position to be measured by the distance measuring instrument is loaded from the memory M16. Then, in Step P42, it is determined whether the current position in the lateral direction of the distance measuring instrument is equal to the position in the lateral direction of the sheet thickness measuring position to be measured by the distance measuring instrument. If the answer is Y, in Step P43, a measurement command signal is outputted to the distance measuring instrument. If the answer is N, the program returns to Step P39.

Then, in Step P44, the output FD of the face side distance measuring instrument 74 is loaded, and stored into the memory M17. Then, in Step P45, outputting of the normal rotation command to the driver 83 for the motor for movement in the lateral direction is stopped.

Then, in Step P46, a reverse rotation command is outputted to the driver 83 for the motor for movement in the lateral direction. Then, if the output of the detector 87 for the home position in the lateral direction of the distance measuring instrument is ON in Step P47, outputting of the reverse rotation command to the driver 83 for the motor for movement in the lateral direction is stopped in Step P48.

Then, in Step P49, a reverse rotation command is outputted to the driver 77 for the motor for movement in the circumferential direction. Then,if the output of the detector 81 for the home position in the circumferential direction of the distance measuring instrument is ON in Step P50, outputting of the reverse rotation command to the driver 77 for the motor for movement in the circumferential direction is stopped in Step P51.

Then, in Step P52, the distance FDP from the face side distance measuring instrument to the sheet is computed from the output FD of the face side distance measuring instrument 74, and stored into the memory M19. Then, in Step P53, the distance FDF between the face side distance measuring instrument and the measuring stand is loaded from the memory M21A. Then, in Step P54, the distance FDP from the face side distance measuring instrument to the sheet is subtracted from the distance FDF between the face side distance measuring instrument and the measuring stand to compute the sheet thickness PT, which is stored into the memory M22. Then, the program shifts to Step P116 to be described later.

In accordance with the above steps, the thickness of the sheet W, which is the object to be measured, is measured. The sheet thickness measuring position is set at a part of the sheet W, where nothing is printed, in other words, a part where the ink film is not present.

If the answer is N in the aforementioned Step P31, on the other hand, it is determined in Step P55 whether a color patch measuring switch is ON. If the answer is Y, in Step P56, a normal rotation command is outputted to the driver 77 for the motor for movement in the circumferential direction. If the answer is N, the program shifts to Step P116 to be described later.

Then, in Step P57, the value of the counter 79 for measuring the current position in the circumferential direction of the distance measuring instrument is loaded, and stored into the memory M11. Then, in Step P58, the current position in the circumferential direction of the distance measuring instrument is computed from the loaded value of the counter for measuring the current position in the circumferential direction of the distance measuring instrument, and stored into the memory M12. Then, in Step P59, the position in the circumferential direction of the color patch line to be measured by the distance measuring instrument is loaded from the memory M23.

Then, in Step P60, it is determined whether the current position in the circumferential direction of the distance measuring instrument is equal to the position in the circumferential direction of the color patch line to be measured by the distance measuring instrument. If the answer is Y, outputting of the normal rotation command to the driver 77 for the motor for movement in the circumferential direction is stopped in Step P61. If the answer is N, the program returns to Step P57.

Then, in Step P62, 1 is written into the count value N of the memory M4, and then 1 is written into the count value M of the memory M3 in Step P63. Then, in Step P64, a normal rotation command is outputted to the driver 83 for the motor for movement in the lateral direction. Then, in Step P65, the value of the counter 85 for measuring the current position in the lateral direction of the distance measuring instrument is loaded, and stored into the memory M14.

Then, in Step P66, the current position in the lateral direction of the distance measuring instrument is computed from the loaded value of the counter for measuring the current position in the lateral direction of the distance measuring instrument, and stored into the memory M15. Then, in Step P67, the position in the lateral direction of the color patch line in the printing unit M in the range of the Nth ink fountain key to be measured by the distance measuring instrument is loaded from the memory M24.

Then, in Step P68, it is determined whether the current position in the lateral direction of the distance measuring instrument is equal to the position in the lateral direction of the color patch line in the printing unit M in the range of the Nth ink fountain key to be measured by the distance measuring instrument. If the answer is Y, in Step P69, a measurement command signal is outputted to the distance measuring instrument. If the answer is N, the program returns to Step P65.

Then, in Step P70, the output FDmn of the face side distance measuring instrument 74 is loaded, and stored into the Nth address position for the printing unit M in the memory M17. Then, in Step P71, 1 is added to the count value M of the memory M3 for overwriting.

Then, in Step P72, the total number Mmax of the printing units is loaded from the memory M25A. Then, in Step P73, it is determined whether the count value M is larger than the total number Mmax of the printing units. If the answer is Y, in Step P74, 1 is added to the count value N of the memory M4 for overwriting. If the answer is N, the program returns to Step P65.

Then, in Step P75, the total number Nmax of the ink fountain keys of each printing unit is loaded from the memory M7A. Then, in Step P76, it is determined whether the count value N is larger than the total number Nmax of the ink fountain keys of each printing unit. If the answer is Y, in Step P77, outputting of the normal rotation command to the driver 83 for the motor for movement in the lateral direction is stopped. If the answer is N, the program returns to Step P63.

Then, in Step P78, a reverse rotation command is outputted to the driver 83 for the motor for movement in the lateral direction. Then, if the output of the detector 87 for the home position in the lateral direction of the distance measuring instrument is ON in Step P79, outputting of the reverse rotation command to the driver 83 for the motor for movement in the lateral direction is stopped in Step P80.

Then, in Step P81, a reverse rotation command is outputted to the driver 77 for the motor for movement in the circumferential direction. Then,if the output of the detector 81 for the home position in the circumferential direction of the distance measuring instrument is ON in Step P82, outputting of the reverse rotation command to the driver 77 for the motor for movement in the circumferential direction is stopped in Step P83.

In accordance with the above steps, the distance from the face side distance measuring instrument 74 to the color patch line L printed with ink supplied from each printing unit is measured.

Then, in Step P84, 1 is written into the count value M of the memory M3, and then, in Step P85, 1 is written into the count value N of the memory M4. Then, the output FDmn of the face side distance measuring instrument 74 stored in the Nth address position for the printing unit M in the memory M17 is loaded in Step P86. Then, in Step P87, the distance FDCmn from the face side distance measuring instrument to the color patch portion is computed from the output FDmn of the face side distance measuring instrument 74 stored in the Nth address position for the printing unit M in the memory M17, and the computed distance is stored into the memory M26.

Then, in Step P88, the distance FDF between the face side distance measuring instrument and the measuring stand is loaded from the memory M21A. Then, in Step P89, the distance FDCmn from the face side distance measuring instrument to the color patch portion is subtracted from the distance FDF between the face side distance measuring instrument and the measuring stand to compute the thickness CPTmn of the color patch portion, which is stored into the memory M33.

Then, in Step P90, the sheet thickness PT is loaded from the memory M22. Then, in Step P91, the sheet thickness PT is subtracted from the thickness CPTmn of the color patch portion to compute the ink film thickness IFTmn, which is stored into the Nth address position for the printing unit M in the memory M34.

Then, in Step P92, the reference ink film thickness IFTFm of the printing unit M is loaded from the address position for the printing unit M in the memory M35 for storing the reference ink film thickness IFTF. Then, in Step P93, the reference ink film thickness IFTFm of the printing unit M is subtracted from the Nth ink film thickness IFTmn of the printing unit M to compute the ink film thickness error amount IFTDmn of the color patch line corresponding to the Nth ink fountain key of the printing unit M, and the computed value is stored into the Nth address position for the printing unit M in the memory M36.

Then, in Step P94, the ink color ICm of the printing unit M is loaded from the memory M1A. Then, in Step P95, the table of conversion from the ink film thickness error amount to the correction ratio of the opening amount of the ink fountain key, corresponding to the ink color ICm, is loaded from the memory M60.

Then, in Step P96, the correction ratio of the opening amount of the ink fountain key is obtained from the ink film thickness error amount IFTDmn with the use of the table of conversion from the ink film thickness error amount to the correction ratio of the opening amount of the ink fountain key, corresponding to the ink color ICm, and the obtained value is stored into the Nth address position for the printing unit M in the memory M55. Then, in Step P97, 1 is added to the count value N of the memory M4 for overwriting.

Then, in Step P98, the total number Nmax of the ink fountain keys of each printing unit is loaded from the memory M7A. Then, in Step P99, it is determined whether the count value N is larger than the total number Nmax the ink fountain keys of each printing unit. If the answer is Y, in Step P100, 1 is added to the count value M of the memory M3 for overwriting. If the answer is N, the program returns to Step P86.

Then, in Step P101, the total number Mmax of the printing units is loaded from the memory M25A. Then, in Step P102, it is determined whether the count value M is larger than the total number Mmax of the printing units. If the answer is Y, in Step P103, 1 is written into the count value M of the memory M3. If the answer is N, the program returns to Step P85.

In accordance with the above steps, the correction ratio of the opening amount of each ink fountain key of each inking device is obtained from the ink film thickness of each color patch line L which has been measured.

Then, in Step P104, 1 is written into the count value N of the memory M4. Then, in Step P105, the opening amount Kmn of the Nth ink fountain key of the printing unit M is loaded from the memory M6. Then, the correction ratio of the opening amount of the Nth ink fountain key of the printing unit M is loaded from the memory M55 in Step P106.

Then, in Step P107, the opening amount Kmn of the Nth ink fountain key of the printing unit M is multiplied by the correction ratio of the opening amount of the Nth ink fountain key of the printing unit M, and the resulting product is stored into the Nth address position for the printing unit M in the memory M6 for storing the opening amount Kmn of the ink fountain key. Then, in Step P108, the opening amount Kmn of the ink fountain key is transmitted to the control device for the opening amount of the Nth ink fountain key of the printing unit M.

Then, if, in Step P109, a receipt confirmation signal has been transmitted from the control device for the opening amount of the Nth ink fountain key of the printing unit M, Step P110 is executed to add 1 to the count value N of the memory M4 for overwriting.

Then, in Step P111, the total number Nmax of the ink fountain keys of each printing unit is loaded from the memory M7A. Then, in Step P112, it is determined whether the count value N is greater than the total number Nmax of the ink fountain keys of each printing unit. If the answer is Y, in Step P113, 1 is added to the count value M of the memory M3 for overwriting. If the answer is N, the program returns to Step P105.

Then, in Step P114, the total number Mmax of the printing units is loaded from the memory M25A. Then, in Step P115, it is determined whether the count value M is greater than the total number Mmax of the printing units. If the answer is Y, the program returns to Step P2. If the answer is N, the program returns to Step P104.

In accordance with the above steps, the opening amount of each ink fountain key of each inking device is corrected in conformity with the ink film thickness of each color patch line L measured.

In Step P116 shifted from the aforementioned Step P54 or Step P55, the output of the A/D converter 92 connected to the rotary encoder 94 for the drive motor of the printing press is loaded, and stored into the memory M45. Then, in Step P117, the current rotational speed R of the printing press is computed from the A/D converter connected to the rotary encoder for the drive motor of the printing press, and the computed value is stored into the memory M46.

Then, in Step P118, 1 is written into the count value M of the memory M3. Then, in Step P119, the rotational speed ratio IFRRm of the ink fountain roller of the printing unit M is loaded from the memory M9. Then, in Step P120, the current rotational speed R of the printing press is loaded from the memory M46.

Then, in Step P121, the current rotational speed R of the printing press is multiplied by the rotational speed ratio IFRRm of the ink fountain roller of the printing unit M to compute the rotational speed IFRm of the ink fountain roller of the printing unit M, and the computed value is stored into the memory M47A. Then, in Step P122, the rotational speed IFRm of the ink fountain roller is transmitted to the control device for the ink fountain roller of the printing unit M.

Then, upon transmission of a receipt confirmation signal from the control device for the ink fountain roller of the printing unit M in Step P123, 1 is added to the count value M of the memory M3 in Step P124 for overwriting.

Then, in Step P125, the total number Mmax of the printing units is loaded from the memory M25A. Then, in Step P126, it is determined whether the count value M is greater than the total number Mmax of the printing units. If the answer is Y, the program returns to Step P2. If the answer is N, the program returns to Step P119. Then, this procedure is repeated.

The control device 120A-(1-1) for the first ink fountain key of the first printing unit to the control device 120A-(M-N) for the Nth ink fountain key of the Mth printing unit act in accordance with the motion or action flow shown in FIG. 39, similar to Embodiment 3.

That is, if, in Step P1, the opening amount Kmn of the ink fountain key is transmitted from the ink supply amount control device 60A, Step P2 is executed to receive the opening amount Kmn of the ink fountain key and store the received opening amount Kmn of the ink fountain key into the memory M50 for storing the received opening amount Kmn of the ink fountain key. Then, in Step P3, a receipt confirmation signal is transmitted to the ink supply amount control device 60A.

Then, in Step P4, the received opening amount Kmn of the ink fountain key is written into the memory M51 for storing the desired opening amount (position) of the ink fountain key. Then, in Step P5, the count value of the counter 129 is loaded and stored into the memory M52. Then, in Step P6, the current opening amount (position) of the ink fountain key is computed from the count value of the counter 129, and stored into the memory M53.

Then, in Step P7, it is determined whether the desired position of the ink fountain key is equal to the current position of the ink fountain key. If the answer is Y, the program returns to Step P1. If the answer is N, it is determined in Step P8 whether the desired position of the ink fountain key is greater than the current position of the ink fountain key.

If the answer is Y in Step P8, Step P9 is executed to output a normal rotation command to the driver 127 for the motor for driving the ink fountain key. If the answer is N in Step P8, Step P10 is executed to output a reverse rotation command to the driver 127 for the motor for driving the ink fountain key.

Then, in Step P11, the count value of the counter 129 is loaded, and stored into the memory M52. Then, in Step P12, the current position of the ink fountain key is computed from the count value of the counter 129, and stored into the memory M53.

Then, in Step P13, it is determined whether the current position of the ink fountain key is equal to the desired position of the ink fountain key. If the answer is Y, in Step P14, a stop command is outputted to the driver 127 for the motor for driving the ink fountain key. Then, the program returns to Step P1. If the answer is N, the program returns to Step P11. Then, this procedure is repeated.

The control device 100-1 for the first ink fountain roller to the control device 100-M for the Mth ink fountain roller act in accordance with the motion flow shown in FIG. 40.

If, in Step P1, the rotational speed IFRm of the ink fountain roller is transmitted from the ink supply amount control device 60A, Step P2 is executed to receive the rotational speed IFRm of the ink fountain roller and store the received rotational speed IFRm of the ink fountain roller into the memory M48 for storing the received rotational speed IFRm of the ink fountain roller. Then, in Step P3, a receipt confirmation signal is transmitted to the ink supply amount control device 60A.

Then, in Step P4, the received rotational speed IFRm of the ink fountain roller is written and stored into the memory M49 for storing the desired rotational speed of the ink fountain roller. Then, in Step P5, the desired rotational speed of the ink fountain roller is loaded from the memory M49.

Then, in Step P6, a rotational speed command on the desired rotational speed of the ink fountain roller is outputted to the driver 107 for the motor for driving the ink fountain roller. Then, the program returns to Step P1. Afterwards, this procedure is repeated.

According to the present embodiment described above, in the relief printing press, the ink film thickness of the printed sheet W is measured using the face side distance measuring instrument 74. In accordance with the measured ink film thickness, the aforementioned motor 128 is drivingly controlled, whereby the opening amount (i.e., ink supply amount) of the ink fountain key in the printing unit is automatically adjusted.

Thus, printing troubles due to misadjustment of the ink supply amount owing to the operator's manual operation can be avoided. Consequently, burden on the operator can be lessened, and the ink film thickness can be controlled with high accuracy to decrease defective printing products (wasted sheets).

It goes without saying that the present invention is not limited to the above embodiments, and various changes and modifications may be made without departing from the gist of the present invention. For example, the invention can be applied to various printing presses different in cylinder arrangement. Such variations are not to be regarded as a departure from the spirit and scope of the invention, and all such modifications as would be obvious to one skilled in the art are intended to be included within the scope of the following claims.

What is claimed is:

1. A printing quality control method for a printing press including,
an ink storage portion for storing ink, and
ink supply amount adjusting means for adjusting an amount of ink supplied from the ink storage portion,
the printing quality control method, comprising:
providing ink film thickness measuring means for measuring an ink film thickness of a printing product of printing by the printing press;
measuring the ink film thickness of the printing product of printing by the printing press; and
controlling the ink supply amount adjusting means based on the ink film thickness measured.

2. A printing quality control apparatus for a printing press including,
an ink storage portion for storing ink, and
ink supply amount adjusting means for adjusting an amount of ink supplied from the ink storage portion,
the printing quality control apparatus, comprising:
ink film thickness measuring means for measuring an ink film thickness of a printing product of printing by the printing press; and
control means for controlling the ink supply amount adjusting means based on the ink film thickness measured by the ink film thickness measuring means.

3. A printing press, comprising,
an ink storage portion for storing ink, and
ink supply amount adjusting means for adjusting an amount of ink supplied from the ink storage portion,
ink film thickness measuring means for measuring an ink film thickness of a printing product of printing by the printing press; and
control means for controlling the ink supply amount adjusting means based on the ink film thickness measured by the ink film thickness measuring means.
